(19) United States
(12) Patent Application Publication
(10) Pub. No.: US 2021/0340058 A1
(43) Pub. Date: Nov. 4, 2021

(54) Protected Substrate and Method for Protecting a Substrate

(71) Applicant: Vitro Flat Glass LLC, Cheswick, PA (US)

(72) Inventor: Farzad Fareed, Gibsonia, PA (US)

(21) Appl. No.: 17/241,905

(22) Filed: Apr. 27, 2021

Related U.S. Application Data
(60) Provisional application No. 63/018,596, filed on May 1, 2020.

(51) Int. Cl. C03C 17/32; C03C 17/36

(52) U.S. Cl. CPC C03C 17/322; C03C 17/326; C03C 2218/328; C03C 2218/355; C03C 17/366

(57) ABSTRACT

A protected substrate includes a planar substrate having a surface and a burn-off temporary protective layer positioned over at least a portion of the surface. The burn-off temporary protective layer includes a polyurethane layer, an epoxide layer, or a combination thereof. The burn-off temporary protective layer is removable by a heat treatment process that does not substantially damage the surface. Various other protected substrates and methods for protecting a substrate are also disclosed.

### CROSS REFERENCE TO RELATED APPLICATIONS

This application claims the benefit of U.S. Provisional Patent Application No. 63/018,596, filed May 1, 2020, which is hereby incorporated by reference in its entirety.

### BACKGROUND OF THE INVENTION

### Field of the Invention

The present invention is directed to protected substrates and to methods for protecting a substrate.

### Description of Related Art

Large substrates, such as large glass sheets, often become damaged during shipment from the manufacturing plant to the customer site. This results in a substrate unsuitable for installation, causing chargebacks to the manufacturer and delay to the construction project. One way to protect large substrates from damage is to overlap, or hold together using tape, two smaller protective sheets positioned over the large substrates.

This approach includes certain drawbacks. For example, a small capillary tube can be formed at the seam of the two smaller protective sheets over which the tape is applied. The small capillary tube attracts water that induces corrosion at the site of the seam, which results in damage requiring chargebacks and project delays. Therefore, a protected substrate that prevents damage to a large substrate during shipment, including corrosion damage induced at the seam of overlaying protective sheets, is desired.

### SUMMARY OF THE INVENTION

The present invention is directed to a protected substrate including: a planar substrate including a surface; and a burn-off temporary protective layer positioned over at least a portion of the surface, where the burn-off temporary protective layer comprises a polyurethane layer, an epoxide layer, or a combination thereof. The burn-off temporary protective layer may be removable by a heat treatment process that does not substantially damage the surface.

The present invention is also directed to a method for protecting a substrate, including: providing a planar substrate including a surface and applying a material to form a burn-off temporary protective layer over at least a first portion of the surface, where the burn-off temporary protective layer comprises a polyurethane layer, an epoxide layer, or a combination thereof. The burn-off temporary protective layer may be removable by a heat treatment process that does not substantially damage the surface.

The present invention is also directed to a method of removing a burn-off temporary protective layer from a coated substrate including: providing a coated substrate including a surface over a portion of which a burn-off temporary protective layer is applied, where the burn-off temporary protective layer comprises a polyurethane layer, an epoxide layer, or a combination thereof; and removing the burn-off temporary protective layer from the surface by burning the burn-off temporary protective layer to form an unprotected substrate. The burn-off temporary protective layer may be removable by a heat treatment process that does not substantially damage the surface.

The present invention is also directed to a protected substrate, including: a planar substrate including a surface; a temporary protective layer positioned over at least a portion of the surface; a first temporary protective sheet positioned over at least a first portion of the surface; and a second temporary protective sheet positioned over at least a second portion the surface, where an overlapping portion of the second temporary protective sheet overlaps an overlapping portion of the first temporary protective sheet at an overlap; where a gap is defined by the overlap between the second temporary protective sheet and a portion of the surface, where a portion of the temporary protective layer is positioned between the second temporary protective sheet and the portion of the surface.

The present invention is also directed to a protected substrate including: a planar substrate including a surface; a first temporary protective sheet positioned over a first portion of the surface; a second temporary protective sheet positioned over a second portion of the surface, where a third portion of the surface is not covered by the first temporary protective sheet and where the third portion of the surface is not covered by the second temporary protective sheet; and a temporary protective layer over at least the third portion of the surface, where the temporary protective layer is positioned directly beneath the first and/or second protective sheet and is positioned between the substrate and the first and/or second temporary protective sheet.

The present invention is also directed to a method for protecting a substrate including: providing a planar substrate including a surface; applying a material to form a temporary protective layer over at least a first portion of the surface; adhering a first temporary protective sheet over a second portion of the surface, where a portion of the first temporary protective sheet overlaps a first portion of the temporary protective layer; and adhering a second temporary protective sheet over a second portion of the temporary protective layer and over a third portion of the surface, where an overlap is formed between the first temporary protective sheet and the second temporary protective sheet, and where a gap is defined by the overlap between the second temporary protective sheet and the surface.

The present invention is also directed to a method of removing a temporary protective layer from a coated substrate including: providing a protected substrate including: a planar substrate including a surface; a temporary protective layer positioned over at least a portion of the surface; a first temporary protective sheet positioned over at least a first portion of the surface; and a second temporary protective sheet positioned over at least a second portion the surface, where an overlapping portion of the second temporary protective sheet overlaps an overlapping portion of the first temporary protective sheet at an overlap; where a gap is defined by the overlap between the second temporary protective sheet and a portion of the surface, where a portion of the temporary protective layer is positioned between the second temporary protective sheet and the portion of the surface; removing the first temporary protective sheet and/or the temporary protective sheet by peeling; and removing the temporary protective layer from the surface by burning, vaporizing, removing using a solvent, or peeling the temporary protective layer to form an unprotected substrate.

### BRIEF DESCRIPTION OF THE DRAWINGS

FIG. 1 shows a protected substrate according to a first non-limiting embodiment;

FIG. 2 shows a protected substrate according to a second non-limiting embodiment;

FIG. 3 shows a protected substrate according to a third non-limiting embodiment;

FIG. 4 shows a protected substrate according to a fourth non-limiting embodiment;

FIG. 5 shows a protected substrate according to a fifth non-limiting embodiment;

FIG. 6 shows a protected substrate according to a sixth non-limiting embodiment;

FIG. 7 shows a protected substrate according to a seventh non-limiting embodiment;

FIG. 8 shows a protected substrate according to an eighth non-limiting embodiment;

FIG. 9 shows a protected substrate according to a ninth non-limiting embodiment;

FIG. 10 shows a protected substrate according to a tenth non-limiting embodiment; and

FIG. 11 shows a protected substrate according to an eleventh non-limiting embodiment.

### DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

For purposes of the following detailed description, it is to be understood that the invention may assume various alternative variations and step sequences, except where expressly specified to the contrary. Moreover, other than in any operating examples, or where otherwise indicated, all numbers used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

With respect to layers of material described herein, the term “over” means farther from the substrate on which the material is positioned. For example, a second layer positioned “over” a first layer means that the second layer is positioned farther from the substrate than is the first layer. The second layer may be in direct contact with the first layer. Alternatively, one or more other layers may be positioned between the first layer and the second layer.

The terms “polymer” or “polymeric” include oligomers, homopolymers, copolymers, and terpolymers, e.g., polymers formed from two or more types of monomers or polymers. As used herein, the term “resin” is used interchangeably with the term “polymer”.

The term “includes” is synonymous with “comprises”.

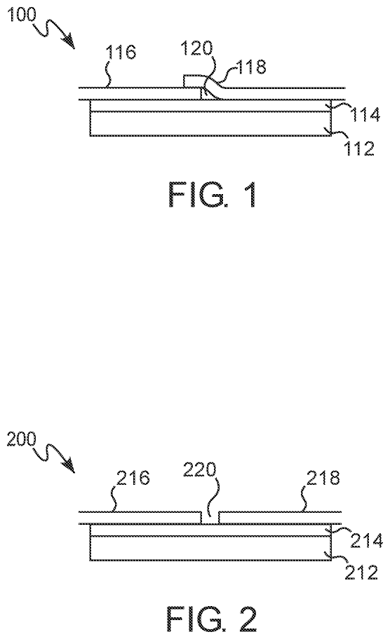

Referring to FIGS. 1-11, the present invention is directed to protected substrates and methods for protecting a substrate as described herein.

Referring to FIG. 1, a protected substrate 100 includes a substrate 112. The substrate 112 may be made of any suitable material, and may be a substrate manufactured at a manufacturing facility and shipped to a customer site, such that the substrate 112 is susceptible to damage during shipping. In some non-limiting examples, the substrate 112 may include glass. For example, the substrate 112 can comprise soda-lime glass, borosilicate glass, or leaded glass. In one non-limiting exemplary embodiment, the glass may include soda-lime glass. The glass can be clear glass. By “clear glass” is meant non-tinted or non-colored glass. Alternatively, the glass can be tinted or otherwise colored glass. The glass can be annealed or heat-treated glass. As used herein, the term “heat-treated” means tempered or at least partially tempered. The glass can be any type such as conventional float glass, and can be of any composition having any optical properties (e.g., any value of visible radiation transmittance, ultraviolet radiation transmittance, infrared radiation transmittance, and/or total solar energy transmittance). By “float glass” is meant glass formed by a conventional float process in which molten glass is deposited onto a molten metal bath and controllably cooled to form a float glass ribbon. In other non-limiting examples, the substrate 112 may include metal or wood. For example, the substrate 112 can comprise steel, copper, aluminum, or a combination thereof. The metal substrate may be a sheet or a bar. The substrate may be made of any material capable of being damaged (e.g., scratched, corroded, etc.) during shipping.

The substrate may be a coated substrate, having a functional coating layer over the bare substrate, such as coated glass. As used herein, the term “functional coating” refers to a coating which imparts a functional benefit to the surface beyond decoration of the surface. Non-limiting examples include coatings that impart an optical property, structural property, electrical property, hygienic property, thermal property, and/or physio-chemical property to the surface. Non-limiting examples of functional coatings include at least one of a low-e (low-emissivity) coating, a hydrophilic coating, a hydrophobic coating, an oleophilic coating, a low friction coating, an anti-microbial coating, an anti-fingerprint coating, an anti-fog coating, a self-cleaning coating, an easy-clean coating, a transparent conductive coating, and combinations thereof.

The functional coating layer may comprise a metallic layer comprising a metallic material, such as gold, copper, silver, aluminum, palladium, or a combination thereof. The functional coating layer may be applied to the substrate using magnetron sputtering vapor deposition (“MSVD”), such as a MSVD coated glass. Non-limiting examples of suitable functional coatings and coated substrates are disclosed in US 2017/0341977; US 2018/0118614; US 2019/0204480; U.S. Pat. Nos. 7,335,421; 8,865,325; 9,932,267; and 10,479,724; all of which are incorporated herein by reference in their entirety.

In some non-limiting embodiments, the substrate 112 may be a large substrate, such that multiple protective sheets are required to protect the entire surface of the substrate 112 during shipping. In some examples, the large substrates may have a length exceeding 100″, such as at least 130″, at least 160″, at least 190″, at least 220″, at least 250″. In some examples, the large substrates may have a width exceeding 100″, such as at least 130″, at least 160″, at least 190″, at least 220″, at least 250″. One non-limiting example of such a planar substrate includes a glass sheet.

In some non-limiting embodiments, the substrate 112 may be a planar substrate, such as a flat glass sheet. As used herein, a “planar substrate” refers to a flat substrate.

With continued reference to FIG. 1, the protected substrate 100 further includes a temporary protective layer 114 positioned over at least a portion of a surface of the substrate 112. The temporary protective layer 114 may be formed from a composition that, when applied to the surface of the substrate 112 and solidified, forms a layer thereover defined as the temporary protective layer 114. The temporary protective layer 114 may be positioned over at least a portion of a surface of the substrate 112, and in some non-limiting embodiments is positioned over at least the entire surface of the substrate 112. The temporary protective layer 114 may be applied over at least a portion of an edge of the substrate 112.

The temporary protective layer 114 may include a polyurethane layer, an epoxide layer, or a combination thereof. As used herein, a “polyurethane layer” is a layer that comprises urethane linkages and/or is made from components comprising a polyurethane. For example, the polyurethane layer may comprise urethane linkages. The temporary protective layer 114 may include an epoxide layer. As used herein, an “epoxide layer” is a layer that comprises an epoxide or that is obtained from components comprising an epoxide. For example, the epoxide layer may comprise epoxide groups.

The temporary protective layer 114 may include both a polyurethane layer and an epoxide layer. If both a polyurethane layer and an epoxide layer are present, the polyurethane layer and epoxide layer may be formed together such that the temporary protective layer 114 comprises one layer comprising both a polyurethane and an epoxide. Alternatively, if both a polyurethane layer and an epoxide layer are present, the polyurethane layer and epoxide layer may be formed as separate layers. For example, the polyurethane layer may be formed over the substrate and the epoxide layer may be formed over the polyurethane layer. As a further example, the epoxide layer may be formed over the substrate and the polyurethane layer may be formed over the epoxide layer.

The temporary protective layer 114 may be formed from a coating composition. The coating composition may comprise a polyurethane, an epoxide, or a combination thereof.

The coating composition may comprise a polyurethane. Examples of polyurethanes include aqueous polyurethanes, polyurethanes formed from a two component system, emulsions thereof, and combinations thereof. The polyurethane may comprise additional functional groups including ester linkages, ether linkages, and hydrophilic groups such as hydroxyl groups, carboxyl groups, carbonyl groups, amino groups, thiols, and the like. Hydrophilic functional groups may be incorporated into the polyurethane to aid in the formation of an emulsion. The polyurethane may be a polyurethane polymer. For example, the coating composition may comprise an oil-modified polyurethane polymer.

The polyurethane may be obtained by reacting one or more hydroxyl functional compounds with one or more isocyanate functional compounds. The hydroxyl functional compounds can include diols and/or polyols having 3 or more hydroxyl functional groups. As used herein, a “polyol” refers to any compound that includes 2 or more hydroxyl groups. The isocyanate functional compounds can include compounds having 2 or more isocyanate functional groups, such as 3 or more isocyanate functional groups. The isocyanate functional compounds can comprise unblocked isocyanates, blocked isocyanates, partially blocked isocyanates, or a combination thereof.

The polyurethane polymer may be formed from a mixture of reactants. The mixture of reactants used to form the polyurethane polymer may comprise an oil polyol. If an oil polyol is used in the mixture of reactants used to form the polyurethane polymer, the polyurethane polymer may be considered an oil-modified polyurethane polymer.

As used herein, an “oil polyol” refers to an oil that comprises 2 or more hydroxyl groups. The oil polyol used to form the polyurethane polymer may be a reaction product of a mixture of reactants comprising at least an unsaturated oil and/or fatty acid and at least one polyol.

For example, the mixture of reactants used to form the oil polyol may comprise an unsaturated oil and/or fatty acid. Non-limiting examples of unsaturated oils and/or fatty acids that may be used to form the oil polyol include palm oil, soybean oil, sunflower seed oil, peanut oil, cottonseed oil, rapeseed oil, coconut oil, palm kernel oil, olive oil, corn oil, grape seed oil, hazelnut oil, linseed oil, sesame oil, avocado oil, hemp seed oil, tung oil, canola oil, safflower oil, tall oil, sunflower oil, poppyseed oil, perilla oil, walnut oil, castor oil, sardine oil, ricinoleic acid, eleostearic acid, linolenic acid, linoleic acid, palmitoleic acid, arachidonic acid, and combinations thereof.

The unsaturated oil and/or fatty acid may have an iodine value of at least 70, or at least 80, or at least 90, or at least 100. The unsaturated and/or fatty acid oil may have an iodine value of up to 250, or up to 225, or up to 210, or up to 200. The unsaturated and/or fatty acid oil may have an iodine value in the range of from 70 to 250, or in the range of from 80 to 225, or in the range of from 90 to 210, or in the range of from 100 to 200. As used herein, “iodine value” is an analytical measurement of the degree of unsaturation of the oil or fat, and represents the number of grams of iodine taken up by 100 grams of the oil or fat and measured by titration.

The mixture of reactants used to form the oil polyol may include an unsaturated oil and/or fatty acid in an amount of at least 75 weight %, or at least 80 weight %, or at least 85 weight %, or at least 90 weight %, based on the total solids weight of the mixture of reactants used to form the oil polyol. The mixture of reactants used to from the oil polyol may include an unsaturated oil and/or fatty acid in an amount of up to 98 weight %, or up to 97 weight %, or up to 96 weight %, or up to 95 weight %, based on the total solids weight of the mixture of reactants used to form the oil polyol. The mixture of reactants used to form the oil polyol may include an unsaturated oil and/or fatty acid in an amount on the range of from 75 weight % to 98 weight %, or in the range of from 80 weight % to 97 weight %, or in the range of from 85 weight % to 96 weight %, or in the range of from 90 weight % to 95 weight %, based on the total solids weight of the mixture of reactants used to form the oil polyol.

The mixture of reactants used to form the oil polyol may comprise a polyol. The polyol used to form the oil polyol may be any polyol that may react with the unsaturated oil and/or fatty acid present in the mixture of reactants used to form the oil polyol. Non-limiting examples of polyols that may be used to form the oil polyol include: cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, ethylene glycol, and combinations thereof.

The polyol used to form the oil polyol may comprise at least one polyol. For example, the polyol used to from the oil polyol may comprise two or more different polyols, or three or more different polyols, or four or more different polyols. The additional polyols may be any of the polyols that may be used to form the oil polyol as previously discussed.

The mixture of reactants used to form the oil polyol may include the polyol in an amount of at least 1 weight %, or at least 2 weight %, or at least 3 weight %, or at least 5 weight %, based on the total solids weight of the mixture of reactants used to form the oil polyol. The mixture of reactants used to form the oil polyol may include the polyol in an amount of up to 25 weight %, or up to 20 weight %, or up to 15 weight %, or up to 10 weight %, based on the total solids weight of the mixture of reactants used to form the oil polyol. The mixture of reactants used to form the oil polyol may include the polyol in an amount in the range of from 1 weight % to 25 weight %, or in the range of from 2 weight % to 20 weight %, or in the range of from 3 weight % to 15 weight %, or in the range of from 5 weight % to 10 weight %, based on the total solids weight of the mixture of reactants used to form the oil polyol.

The mixture of reactants used to form the oil polyol may optionally comprise a catalyst. The catalyst may be any compound that lowers the activation energy of the reaction between the unsaturated oil and the polyol. The catalyst may comprise a transesterification type catalyst. Non-limiting examples of catalysts that may be used in the reaction mixture used to form the oil polyol include 1,5,7-triazabicyclo [4.4.0]dec-5-ene, zinc acetate, calcium naphthenate, zinc naphthenate, barium naphthenate, iron naphthenate lithium neodecanoate, and combinations thereof.

The mixture of reactants used to form the oil polyol may include the optional catalyst in an amount of at least greater than 0 weight %, or at least 0.01 weight %, based on the total solids weight of the mixture of reactants used to form the oil polyol. As used herein, “greater than 0” weight % means that said compound may be include in any amount that is greater than 0 weight % and up to the weight % of an upper bound (if specified). The mixture of reactants used to form the oil polyol may include the catalyst in an amount of up to 5 weight %, or up to 3 weight %, or up to 2 weight %, or up to 1 weight %, based on the total solids weight of the mixture of reactants used to form the oil polyol. The mixture of reactants used to form the oil polyol may include the catalyst in an amount in the range of from greater than 0 weight % to 5 weight %, or in the range of from greater than 0 weight % to 3 weight %, or in the range of from greater than 0 weight % to 2 weight %, or in the range of from greater than 0 weight % to 1 weight %, or in the range of from 0.01 weight % to 2 weight %, or in the range of from 0.01 weight % to 1 weight %, based on the total solids weight of the mixture of reactants used to form the oil polyol.

The reactants of the mixture of reactants used to form the oil polyol may be reacted simultaneously to form the oil polyol, or they can be reacted stepwise.

The oil polyol comprises at least 2 hydroxyl groups. For example, the oil polyol may comprise at least 2 hydroxyl groups, or at least 3 hydroxyl groups, or at least 4 hydroxyl groups, or at least 5 hydroxyl groups, or at least 10 hydroxyl groups, or at least 15 hydroxyl groups, or at least 20 hydroxyl groups.

In addition to hydroxyl groups, the oil polyol may include additional functional groups. Non-limiting examples of additional functional groups that may be present in the oil polyol include ester linkages, ether linkages, ethylenically unsaturated groups, carboxyl groups, carbonyl groups, amino groups, thiols, and the like.

For example, the oil polyol may comprise at least one ethylenically unsaturated group. As used herein, an “ethylenically unsaturated” group refers to a group that comprises a carbon-carbon double bond. The at least one ethylenically unsaturated group may be pendant from the oil polyol. The oil polyol may comprise at least one ethylenically unsaturated group, or at least two ethylenically unsaturated group, or at least three ethylenically unsaturated groups, or at least 5 ethylenically unsaturated groups.

In one non-limiting embodiment, the oil polyol comprises no additional functional groups in addition to the hydroxyl groups and ethylenically unsaturated group(s).

The oil polyol may have a hydroxyl value of at least 70 KOH/mg, or at least 80 KOH/mg, or at least 90 KOH/mg, or at least 100 KOH/mg. The oil polyol may have a hydroxyl value of up to 250 KOH/mg, or up to 200 KOH/mg, or up to 180 KOH/mg, or up to 150 KOH/mg. The oil polyol may have a hydroxyl value in the range of from 70 KOH/mg to 250 KOH/mg, or from 80 KOH/mg to 200 KOH/mg, or from 90 KOH/mg to 180 KOH/mg, or from 100 KOH/mg to 150 KOH/mg.

The mixture of reactants used to form the polyurethane polymer may include the oil polyol in an amount of at least 30 weight %, or at least 35 weight %, or at least 40 weight %, or at least 45 weight %, based on the total solids weight of the mixture of reactants used to form the polyurethane polymer. The mixture of reactants used to form the polyurethane polymer may include the oil polyol in an amount of up to 65 weight %, or up to 60 weight %, or up to 55 weight %, or up to 50 weight %, based on the total solids weight of the mixture of reactants used to form the polyurethane polymer. The mixture of reactants used to form the polyurethane polymer may include the oil polyol in an amount in the range of from 30 weight % to 65 weight %, or in the range of from 35 weight % to 60 weight %, or in the range of from 40 weight % to 55 weight %, or in the range of from 45 weight % to 50 weight %, based on the total solids weight of the mixture of reactants used to form the polyurethane polymer.

The mixture of reactants used to form the polyurethane polymer may include at least one polyol in addition and different to the oil polyol. The mixture of reactants used to form the polyurethane polymer may include at least one polyol, or at least two polyols, or at least three polyols, or at least four polyols, in addition to and different from the oil polyol. For example, the mixture of reactants used to form the polyurethane polymer may include a polyester polyol, a polyether polyol, an acid functional polyol, or a combination thereof, that is different from the oil polyol.

The mixture of reactants used to form the polyurethane polymer may include a polyester polyol. As used herein, a “polyester polyol” refers to any compound that comprises two or more hydroxyl groups and at least one ester linkage. Non-limiting examples of polyester polyols that may be used in the mixture of reactants used to form the polyurethane polymer include compounds comprising at least 2 hydroxyl groups and at least one ester linkage. The polyester polyol used to form the polyurethane polymer may be a reaction product of a mixture of reactants comprising at least a polyol and a polyacid. As used herein, a “polyacid” refers to any compound that includes 2 or more carboxylic acid groups.

For example, the mixture of reactants used to form the polyester polyol may comprise a polyol. The polyol used to form the polyester polyol may comprise any polyol that may be used to form a polyester. Non-limiting examples of polyols that may be used to form the polyester polyol include dimethyl carbonate, caprolactone, cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, and ethylene glycol, and combinations thereof.

The polyol used to form the polyester polyol may comprise at least one polyol. For example, the polyol used to form the polyester polyol may comprise two or more different polyols, or three or more different polyols, or four or more different polyols. The additional polyols may be any of the polyols that may be used to form the polyester polyol as previously discussed.

The mixture of reactants used to form the polyester polyol may include the polyol in an amount of at least 50 weight %, or at least 55 weight %, or at least 60 weight %, or at least 65 weight %, based on the total solids weight of the mixture of reactants used to form the polyester polyol. The mixture of reactants used to form the polyester polyol may include the polyol in an amount of up to 80 weight %, or up to 78 weight %, or up to 75 weight %, based on the total solids weight of the mixture of reactants used to form the polyester polyol. The mixture of reactants used to form the polyester polyol may include the polyol in an amount in the range of from 50 weight % to 80 weight %, or in the range of from 55 weight % to 80 weight %, or in the range of from 60 weight % to 78 weight %, or in the range of from 65 weight % to 75 weight %, based on the total solids weight of the mixture of reactants used to form the polyester polyol.

The mixture of reactants used to form the polyester polyol may comprise at least one polyacid. The polyacid used to form the polyester polyol may comprise any polyacid that may be used to form a polyester. Non-limiting examples of polyacids that may be used to form the polyester polyol include oxalic acid, malonic acid, succinic acid, glutaric acid, adipic acid, maleic acid, fumaric acid, isophthalic acid, phthalic acid, trimellitic acid, maleic anhydride, phthalic anhydride, trimellitic anhydride, and combinations thereof.

The mixture of reactants used to form the polyester polyol may include the polyacid in an amount of at least 20 weight %, or at least 23 weight %, or at least 25 weight %, based on the total solids weight of the mixture of reactants used to form the polyester polyol. The mixture of reactants used to form the polyester polyol may include the polyacid in an amount of up to 50 weight %, or up to 45 weight %, or up to 40 weight %, or up to 35 weight %, based on the total solids weight of the mixture of reactants used to form the polyester polyol. The mixture of reactants used to form the polyester polyol may include the polyacid in an amount in the range of from 20 weight % to 50 weight %, or in the range of from 20 weight % to 45 weight %, or in the range of from 23 weight % to 40 weight %, or in the range of from 25 weight % to 35 weight %, based on the total solids weight of the mixture of reactants used to form the polyester polyol.

The polyester polyol may be aliphatic, cycloaliphatic, or aromatic. In one non-limiting embodiment, the polyester polyol is aliphatic. The polyester polyol may comprise a carbon chain. For example, the polyester polyol may comprise at least a C₂ carbon chain, or at least a C₅ carbon chain, or at least a C₈ carbon chain, or at least a C₁₀ carbon chain. The polyester polyol may comprise up to a C₂₅ carbon chain, or up to C₂₀ carbon chain, or up to C₁₈ carbon chain, or up to C₁₄ carbon chain. The polyester polyol may comprise a C₂-C₂₅ carbon chain, or a C₅-C₂₀ carbon chain, or a C₈-C₁₈ carbon chain, or a C₁₀-C₁₄ carbon chain.

The polyester polyol comprises at least one ester linkage. For example, the polyester polyol may comprise at least one ester linkage, or at least two ester linkages, or at least three ester linkages, or at least four ester linkages, or at least 5 ester linkages.

The polyester polyol comprises at least 2 hydroxyl groups. For example, the polyester polyol may comprise at least two hydroxyl groups, or at least three hydroxyl groups, or at least four hydroxyl groups, or at least 5 hydroxyl groups, or at least 10 hydroxyl groups, or at least 15 hydroxyl groups, or at least 20 hydroxyl groups.

In addition to hydroxyl groups, the polyester polyol may include additional functional groups. Non-limiting examples of additional functional groups that may be present in the polyester polyol include ether linkages, ethylenically unsaturated groups, carboxyl groups, carbonyl groups, amino groups, thiols, and the like.

In one non-limiting embodiment, the polyester polyol comprises no additional functional groups in addition to the hydroxyl groups and ester linkage(s).

The polyester polyol may have a hydroxyl value of at least 70 KOH/mg, or at least 80 KOH/mg, or at least 90 KOH/mg, or at least 100 KOH/mg. The polyester polyol may have a hydroxyl value of up to 250 KOH/mg, or up to 200 KOH/mg, or up to 180 KOH/mg, or up to 150 KOH/mg. The polyester polyol may have a hydroxyl value in the range of from 70 KOH/mg to 250 KOH/mg, or in the range of from 80 KOH/mg to 200 KOH/mg, or in the range of from 90 KOH/mg to 180 KOH/mg, or in the range of from 100 KOH/mg to 150 KOH/mg.

The mixture of reactants used to form the polyurethane polymer may include a polyester polyol in an amount of at least greater than 0 weight %, or at least 1 weight %, or at least 3 weight %, or at least 5 weight %, based on the total solids weight of the mixture of reactants used to form the polyurethane polymer. The mixture of reactants used to form the polyurethane polymer may include a polyester polyol in an amount of up to 20 weight %, or up to 15 weight %, or up to 12 weight %, or up to 10 weight %, based on the total solids weight of the mixture of reactants used to form the polyurethane polymer. The mixture of reactants used to form the polyurethane polymer may include a polyester polyol in an amount in the range of from greater than 0 weight % to 20 weight %, or in the range of from 1 weight % to 15 weight %, or in the range of from 3 weight % to 12 weight %, or in the range of from 5 weight % to 10 weight %, based on the total solids weight of the mixture of reactants used to form the polyurethane polymer.

The mixture of reactants used to form the polyurethane polymer may include a polyether polyol. As used herein, a “polyether polyol” refers to any compound that comprises two or more hydroxyl groups and at least one ether linkage. The polyester polyol may be aliphatic, cycloaliphatic, or aromatic. In one non-limiting embodiment, the polyester polyol is aliphatic. The polyether polyol that may be used in the mixture of reactants used to form the polyurethane polymer includes compounds comprising at least 2 hydroxyl groups and at least one ether linkage. The polyether polyol may comprise an ethylene or propylene based polyether polyol. Non-limiting examples of polyether polyols include ethylene oxide, propylene oxide, tetrahydrofuran, neopentyl glycol, 1,6-hexanediol, 1,4-butane diol, 1,3-butylene glycol, 1,3-propane diol, dipropylene glycol, propylene glycol, diethylene glycol, ethylene glycol, and combinations thereof.

The polyether polyol comprises at least one ether linkage. For example, the polyether polyol may comprise at least two ether linkages, or at least three ether linkages, or at least four ether linkages, or at least 5 ether linkages.

The polyether polyol comprises at least two hydroxyl groups. For example, the polyether polyol may comprise at least two hydroxyl groups, or at least three hydroxyl groups, or at least four hydroxyl groups, or at least 5 hydroxyl groups, or at least 10 hydroxyl groups, or at least 15 hydroxyl groups, or at least 20 hydroxyl groups.

In addition to hydroxyl groups, the polyether polyol may include additional functional groups. Non-limiting examples of additional functional groups that may be present in the polyether polyol include ether linkages, ethylenically unsaturated groups, carboxyl groups, carbonyl groups, amino groups, thiols, and the like.

In one non-limiting embodiment, the polyether polyol may comprise no additional functional groups in addition to the hydroxyl groups and the ether linkage(s).

The polyether polyol may have a hydroxyl value of at least 70 KOH/mg, or at least 80 KOH/mg, or at least 90 KOH/mg, or at least 100 KOH/mg. The polyether polyol may have a hydroxyl value of up to 250 KOH/mg, or up to 200 KOH/mg, or up to 180 KOH/mg, or up to 150 KOH/mg. The polyether polyol may have a hydroxyl value in the range of from 70 KOH/mg to 250 KOH/mg, or in the range of from 80 KOH/mg to 200 KOH/mg, or in the range of from 90 KOH/mg to 180 KOH/mg, or in the range of from 100 KOH/mg to 150 KOH/mg.

The mixture of reactants used to form the polyurethane polymer may include a polyether polyol in an amount of at least greater than 0 weight %, or at least 0.1 weight %, or at least 0.5 weight %, or at least 1 weight %, based on the total solids weight of the mixture of reactants used to form the polyurethane polymer. The mixture of reactants used to form the polyurethane polymer may include a polyether polyol in an amount of up to 15 weight %, or up to 10 weight %, or up to 8 weight %, or up to 5 weight %, based on the total solids weight of the mixture of reactants used to form the polyurethane polymer. The mixture of reactants used to form the polyurethane polymer may include a polyether polyol in an amount in the range of from greater than 0 weight % to 15 weight %, or in the range of from 0.1 weight % to 10 weight %, or in the range of from 0.5 weight % to 8 weight %, or in the range of from 1 weight % to 5 weight %, based on the total solids weight of the mixture of reactants used to form the polyurethane polymer.

The mixture of reactants used to form the polyurethane polymer may include an acid functional polyol. As used herein, an “acid functional polyol” refers to any compound that comprises two or more hydroxyl groups and at least one ether linkage. The acid functional polyol may be aliphatic, cycloaliphatic, or aromatic. In one non-limiting embodiment, the acid functional polyol is aliphatic. The acid functional polyol that may be used in the mixture of reactants used to form the polyurethane polymer include compounds comprising at least 2 hydroxyl groups and at least one carboxyl group. Non-limiting examples of acid functional polyols include 2,2-bis(hydroxymethyl)propionic acid, 2,2-bis(hydroxymethyl)butanoic acid, 2,3-dihydroxypropanoic acid, 2,2-dihydroxypropanedioic acid, 2,3-dihydroxylbutanedioic acid, and combinations thereof.

The acid functional polyol comprises at least one carboxylic acid group. For example, the acid functional polyol may comprise at least one carboxylic acid group, or at least two carboxylic acid groups, or at least three carboxylic acid groups, or at least four carboxylic acid groups, or at least 5 carboxylic acid group. In one non-limiting embodiment, the acid functional polyol comprises one carboxylic acid group.

The acid functional polyol comprises at least two hydroxyl groups. For example, the acid functional polyol may comprise at least two hydroxyl groups, or at least three hydroxyl groups, or at least four hydroxyl groups, or at least 5 hydroxyl groups, or at least 10 hydroxyl groups, or at least 15 hydroxyl groups, or at least 20 hydroxyl groups.

In addition to hydroxyl groups, the acid functional polyol may include additional functional groups. Non-limiting examples of additional functional groups that may be present in the acid functional polyol include ether linkages, ethylenically unsaturated groups, carboxyl groups, carbonyl groups, amino groups, thiols, and the like.

In one non-limiting embodiments, the acid functional polyol may comprise no additional functional groups in addition to the hydroxyl groups and the carboxylic acid group(s).

The mixture of reactants used to form the polyurethane polymer may include an acid functional polyol in an amount of at least greater than 0 weight %, or at least 1 weight %, or at least 3 weight %, or at least 5 weight %, based on the total solids weight of the mixture of reactants used to form the polyurethane polymer. The mixture of reactants used to form the polyurethane polymer may include an acid functional polyol in an amount of up to 20 weight %, or up to 15 weight %, or up to 12 weight %, or up to 10 weight %, based on the total solids weight of the mixture of reactants used to form the polyurethane polymer. The mixture of reactants used to form the polyurethane polymer may include an acid functional polyol in an amount in the range of from greater than 0 weight % to 20 weight %, or in the range of from 1 weight % to 15 weight %, or in the range of from 3 weight % to 12 weight %, or in the range of from 5 weight % to 10 weight %, based on the total solids weight of the mixture of reactants used to form the polyurethane polymer.

The mixture of reactants used to form the polyurethane polymer may include a polyisocyanate. As used herein, a “polyisocyanate” refers to a compound that contains 2 or more isocyanate functional groups. The polyisocyanate may be aliphatic, cycloaliphatic, or aromatic. In one non-limiting example, the polyisocyanate may comprise an aliphatic polyisocyanate. In another non-limiting example, the polyisocyanate may comprise a cycloaliphatic polyisocyanate. In another non-limiting example, the polyisocyanate may comprise an aromatic polyisocyanate. Non-limiting examples of polyisocyanates include meta-phenylene diisocyanate, para-phenylene diisocyanate, 2,6-toluene diisocyanate, 2,4-toluene diisocyanate, xylene diisocyanate, 4,4-biphenylene diisocyanate, 4,4-methylene diphenylisocyanate, 1,5-naphthylene diisocyanate, 1,4-tetramethylene diisocyanate, 11,6-hexamethylene diisocyanate, 2,2,4-trimethyl-1,6-diisocyanatohexane, 1,10-decamethylene diisocyanate, 1,4-cyclohexylene diisocyanate, 4,4-methylenebis(isocyanatocyclohexane), 1-isocyanato-3-isocyanatomethyl-3,5,5-trimethyl cyclohexane, and combinations thereof.

The polyisocyanate may be blocked or unblocked. As used herein, a “blocked polyisocyanate” refers to a compound with isocyanate functional groups that are blocked by a blocking agents which prevents the isocyanate functionality from reacting until the blocking agent is removed. Non-limiting examples of blocking agents include amides, phenols, caprolactams, uretdiones, and the like. If the polyisocyanate comprises a blocked polyisocyanate, the polyisocyanate may be unblocked by heating the blocked polyisocyanate to a temperature of at least 100° C., or at least 150° C., or at least 200° C. When the blocked polyisocyanate is unblocked, the polyisocyanate may then be available to react with the other components present in the mixture of reactants used to form the polyurethane polymer.

The polyisocyanate comprises at least two isocyanate functional groups. For example, the polyisocyanate may comprise at least three isocyanate functional groups, or at least four isocyanate groups, or at least 5 isocyanate groups.

In addition to the isocyanate functional groups, the polyisocyanate may include additional functional groups. Non-limiting examples of additional functional groups that may be present in the polyisocyanate include ether linkages, ethylenically unsaturated groups, carboxyl groups, carbonyl groups, amino groups, thiols, and the like.

In one non-limiting embodiment, the polyisocyanate comprises no additional functional groups in addition to the isocyanate functional groups.

The polyisocyanate may have an isocyanate equivalent weight of at least 80 g/eq, or at least 90 g/eq, or at least 100 g/eq, or at least 110 g/eq. The polyisocyanate may have an isocyanate equivalent weight of up to 225 g/eq, or up to 200 g/eq, or up to 190 g/eq, or up to 175 g/eq. The polyisocyanate may have an isocyanate equivalent weight in the range of from 80 g/eq to 225 g/eq, or in the range of from 90 g/eq to 200 g/eq, or in the range of from 100 g/eq to 190 g/eq, or in the range of from 110 g/eq to 175 g/eq.

The mixture of reactants used to form the polyurethane polymer may include an polyisocyanate in an amount of at least 15 weight %, or at least 20 weight %, or at least 25 weight %, or at least 30 weight %, based on the total solids weight of the mixture of reactants used to form the polyurethane polymer. The mixture of reactants used to form the polyurethane polymer may include a polyisocyanate in an amount of up to 55 weight %, or up to 50 weight %, or up to 45 weight %, or up to 40 weight %, based on the total solids weight of the mixture of reactants used to form the polyurethane polymer. The mixture of reactants used to form the polyurethane polymer may include an polyisocyanate in an amount in the range of from 15 weight % to 55 weight %, or in the range of from 20 weight % to 50 weight %, or in the range of from 25 weight % to 45 weight %, or in the range of from 30 weight % to 40 weight %, based on the total solids weight of the mixture of reactants used to form the polyurethane polymer.

The reactants of the mixture of reactants used to form the polyurethane polymer may be reacted simultaneously to form the polyurethane polymer, or they can be reacted stepwise.

The mixture of reactants used to form the polyurethane polymer may include the polyester polyol and the polyether polyol in a specific ratio. The mixture of reactants used to form the polyurethane polymer may comprise a ratio of polyester polyol to polyether polyol in the range of from 10:1 to 1:1, or in the range of from 8:1 to 2:1, or in the range of from 7:1 to 3:1, or in the range of from 6:1 to 4:1. For example, the mixture of reactants used to form the polyurethane polymer may comprise a ratio of polyester polyol to polyether polyol of about 5:1.

The mixture of reactants used to form the polyurethane polymer may include the polyester polyol and the acid functional polyol in a specific ratio. The mixture of reactants used to form the polyurethane polymer may comprise a ratio of polyester polyol to acid functional polyol in the range of from 2:1 to 1:2, or in the range of from 1.75:1 to 1:1.5, or in the range of from 1.5:1 to 1:1, or in the range of from 1.4:1 to 1.2:1. For example, the mixture of reactants used to form the polyurethane polymer may have a ratio of polyester polyol to acid functional polyol of about 1:0.75.

The mixture of reactants used to form the polyurethane polymer may include the oil polyol and the polyisocyanate in a specific ratio. The mixture of reactants used to form the polyurethane polymer may comprise a ratio of oil polyol to polyisocyanate in the range of from 2:1 to 1:1.25, or in the range of from 1.75:1 to 1:1, or in the range of from 1.5:1 to 1:1, or in the range of from 1.3:1 to 1.2:1. For example, the mixture of reactants used to form the polyurethane polymer may comprise a ratio of oil polyol to the polyisocyanate of about 1:0.8.

The polyurethane polymer comprises at least one urethane linkage. For example, the polyurethane polymer may comprise at least one urethane linkage, or at least two urethane linkages, or at least three urethane linkages, or at least 5 urethane linkages, or at least 10 urethane linkages, or at least 20 urethane linkages.

In addition to urethane linkages, the polyurethane polymer may comprise additional linkages. For example, the polyurethane polymer may comprise ester linkages, ether linkages, urea linkages, ethylenically unsaturated groups, and combinations thereof.

The polyurethane polymer may comprise at least one ester linkage. For example, the polyurethane polymer may comprise at least one ester linkage, or at least two ester linkages, or at least three ester linkages, or at least 5 ester linkages.

The polyurethane polymer may comprise at least one ether linkage. For example, the polyurethane polymer may comprise at least one ether linkage, or at least two ether linkages, or at least three ether linkages, or at least 5 ether linkages.

The polyurethane polymer may comprise at least one urea linkage. For example, the polyurethane polymer may comprise at least one urea linkage, or at least two urea linkages, or at least three urea linkages, or at least 5 urea linkages.

The polyurethane polymer may comprise at least one ethylenically unsaturated group. For example, the polyurethane polymer may comprise at least one ethylenically unsaturated group, or at least two ethylenically unsaturated groups, or at least three ethylenically unsaturated groups, or at least 5 ethylenically unsaturated groups. The ethylenically unsaturated group(s) may be provided in the backbone of the polyurethane polymer, pendant from the polyurethane polymer, and/or terminal from the polyurethane polymer. For example, the ethylenically unsaturated groups may be provided in the backbone of the polyurethane polymer, such as to form ethylenically unsaturated linkage(s) within the backbone of the polyurethane polymer. The ethylenically unsaturated group(s) may also be provide within a pendant carbon chain and/or terminal carbon chain of the polyurethane polymer, such as forming ethylenically unsaturated linkage(s) within a pendant carbon chain and/or terminal carbon chain of the polyurethane polymer. The ethylenically unsaturated group(s) may also be pendant from and/or terminal from the polyurethane polymer, such as providing ethylenically unsaturated group(s) at the end of a pendant carbon chain and/or at the end of a terminal carbon chain attached to the polyurethane polymer such that it may readily react with other components present.

The ethylenically unsaturated group may be pendant from and/or terminal from the polyurethane polymer and provided on at least a C₅ carbon chain, or at least a C₈ carbon chain, or at least a C₁₀ carbon chain. The ethylenically unsaturated group may be pendant from and/or terminal from the polyurethane polymer and provided on up to a C₃₀ carbon chain, or up to C₂₅ carbon chain, or up to C₂₀ carbon chain. The ethylenically unsaturated group may be pendant from and/or terminal from the polyurethane polymer and provided on a C₅-C₃₀ carbon chain, or on a C₈-C₂₅ carbon chain, or on a C₁₀-C₂₀ carbon chain.

The ethylenically unsaturated groups may provide the polyurethane polymer with specific properties where the ethylenically unsaturated group are located. For example, an ethylenically unsaturated group may be provided as a pendant group from the polyurethane backbone, where said pendant group comprising the ethylenically unsaturated group is more hydrophobic compared to the polyurethane backbone due to the presence of the ethylenically unsaturated group. The ethylenically unsaturated group may be provided as a terminal group from the polyurethane backbone, where said terminal group comprising the ethylenically unsaturated group is more hydrophobic compared to the polyurethane backbone due to the presence of the ethylenically unsaturated group. The ethylenically unsaturated group may be reactive with air, or the oxygen in air, to provide an oxidative cure.

The polyurethane polymer may comprise at least one carboxylic acid group. For example, the polyurethane polymer may comprise at least one carboxylic acid group, or at least two carboxylic acid groups, or at least three carboxylic acid groups, or at least 5 carboxylic acid groups. The carboxylic acid group(s) may be pendant from the polyurethane polymer, such that they may readily react with other components present. The carboxylic acid group(s) may be terminal from the polyurethane polymer, such that they may readily react with other components present.

The carboxylic acid group may be pendant from and/or terminal from the polyurethane polymer and provided on at least a C₂ carbon chain. The carboxylic acid group may be pendant from and/or terminal from the polyurethane polymer and provided on up to a C₁₀ carbon chain, or up to a C₈ carbon chain, or up to a C₅ carbon chain, or up to a C₃ carbon chain. The carboxylic acid group may be pendant from and/or terminal from the polyurethane polymer and provided on a C₂-C₁₀ carbon chain, or a C₂-C₈ carbon chain, or a C₂-C₅ carbon chain, or a C₂-C₃ carbon chain.

The carboxylic acid groups may provide the polyurethane polymer with specific properties where the carboxylic acid group(s) are located. For example, a carboxylic acid group may be provided as a pendant group from the polyurethane backbone, where said pendant group comprising the carboxylic acid group is more hydrophilic compared to the polyurethane backbone due to the presence of the carboxylic acid group. The carboxylic acid group may be provided as a terminal group from the polyurethane backbone, where said terminal group comprising the carboxylic acid group is more hydrophilic compared to the polyurethane backbone due to the presence of the carboxylic acid group. The carboxylic acid group may provide the polyurethane polymer with stability in solution (i.e., in water), and also may provide a reactive site for a crosslinker that may be present in the composition.

The polyurethane polymer may have a weight average molecular weight of at least 5,000 g/mol, or at least 10,000 g/mol, or at least 15,000 g/mol, or at least 20,000 g/mol. The polyurethane polymer may have a weight average molecular weight of up to 60,000 g/mol, or up to 50,000 g/mol, or up to 45,000 g/mol, or up to 40,000 g/mol. The polyurethane polymer may have a weight average molecular weight in the range of from 5,000 g/mol to 60,000 g/mol, or in the range of from 10,000 g/mol to 50,000 g/mol, or in the range of from 15,000 g/mol to 45,000 g/mol, or in the range of from 20,000 g/mol to 40,000 g/mol. Weight average molecular weight was measured herein using gas permeation chromatography with a Waters Alliance 2690 and a dimethyl formamide solvent.

The polyurethane polymer may have a glass transition temperature of at least −30° C., or at least −20° C., or at least −10° C. The polyurethane polymer may have a glass transition temperature of up to 20° C., or up to 10° C., or up to 0° C. The polyurethane polymer may have a glass transition temperature in the range of from −30° C. to 20° C., or in the range of from −20° C. to 10° C., or in the range of from −10° C. to 0° C. Glass transition temperature was measured using differential scanning calorimetry according to ASTM D7426.

The polyurethane polymer may have a viscosity of at least 15 cps, or at least 20 cps, or at least 25 cps. The polyurethane polymer may have a viscosity of up to 225 cps, or up to 200 cps, or up to 175 cps. The polyurethane polymer may have a viscosity in the range of from 15 cps to 225 cps, or in the range of from 20 cps to 200 cps, or in the range of from 25 cps to 175 cps. Unless otherwise stated, viscosity measurements were measured using a Brookfield viscometer and LV1 spindle at 25° C.

The polyurethane polymer may have an acid value of at least greater than 0 KOH/mg, or at least 1 KOH/mg, or at least 3 KOH/mg, or at least 5 KOH/mg. The polyurethane polymer may have an acid value of up to 45 KOH/mg, or up to 40 KOH/mg, or up to 35 KOH/mg, or up to 30 KOH/mg. The polyurethane polymer may have an acid value in the range of from greater than 0 KOH/mg to 45 KOH/mg, or in the range of from 1 KOH/mg to 40 KOH/mg, or in the range of from 3 KOH/mg to 35 KOH/mg, or in the range of from 5 KOH/mg to 30 KOH/mg.

The polyurethane polymer may have a certain number of hydrocarbon chains contained in the backbone of the polyurethane polymer, depending on the monomers and amounts of monomers used. For example, the polyurethane polymer may comprise at least 3, or at least 4, or at least 5, or at least 6, or at least 7, or at least 8 different hydrocarbon chains in the backbone of the polyurethane polymer.

The longest of the hydrocarbon chains contained in the backbone of the polyurethane polymer may be a structural unit derived from the unsaturated oil and/or fatty acid used to form the oil polyol. For example, the longest hydrocarbon chain contained in the backbone of the polyurethane polymer may comprise a C₅ or greater, or a C₈ or greater, or a C₁₀ or greater, or a C₁₅ or greater, or a C₂₀ or greater hydrocarbon chain.

The polyurethane polymer may be a copolymer. The polyurethane copolymer may have a specific structure. For example, the polyurethane copolymer may have an alternating, block, or random structure. In one non-limiting embodiment, the polyurethane polymer may comprise a random structure.

The polyurethane polymer may be formed by step-growth polymerization. As used herein, “step-growth polymerization” refers to a type of polymerization where bi-functional or multifunctional monomers react to form dimers, then trimers, and then long chain polymers. In one non-limiting embodiment, the polyurethane polymer may be formed by condensation polymerization. As used herein, “condensation polymerization” is a form of step-growth polymerization that produces a small molecule byproduct when reactive molecules are linked together.

The polyurethane polymer may be used to form a polyurethane dispersion. The polyurethane dispersion may comprise the polyurethane polymer in an amount of at least 15 weight %, or at least 20 weight %, or at least 25 weight %, or at least 30 weight %, based on the total weight of the polyurethane dispersion. The polyurethane dispersion may comprise the polyurethane polymer in an amount of up to 50 weight %, or up to 45 weight %, or up to 40 weight %, or up to 35 weight %, based on the total weight of the polyurethane dispersion. The polyurethane dispersion may comprise the polyurethane polymer in an amount in the range of from 15 weight % to 50 weight %, or in the range of from 25 weight % to 45 weight %, or in the range of from 30 weight % to 40 weight %, or in the range of from 30 weight % to 35 weight %, based on the total weight of the polyurethane dispersion.

The polyurethane dispersion may include a neutralizing amine that at least partially neutralizes the polyurethane polymer. Non-limiting examples of neutralizing amines include ammonium hydroxide, dimethylamine, trimethylamine, triethyleamine, monoethanolamine, diisopropanolamine, diethanolamine, dimethylethanolamine, or a combination thereof.

The polyurethane dispersion may include a neutralizing amine in an amount of at least greater than 0 weight %, or at least 0.1 weight %, or at least 0.5 weight %, or at least 1 weight %, based on the total weight of the polyurethane dispersion. The polyurethane dispersion may include a neutralizing amine in an amount of up to 10 weight %, or up to 8 weight %, or up to 5 weight %, or up to 2 weight %, based on the total weight of the polyurethane dispersion. The polyurethane dispersion may include a neutralizing amine in an amount in the range of from greater than 0 weight % to 10 weight %, or in the range of from 0.1 weight % to 8 weight %, or in the range of from 0.5 weight % to 5 weight %, or in the range of from 1 weight % to 2 weight %, based on the total weight of the polyurethane dispersion.

The polyurethane dispersion may include a chain extender. For example, the polyurethane dispersion may include an amine functional chain extender. The amine chain extender may be aliphatic, cycloaliphatic, or aromatic. In one non-limiting embodiment, the amine chain extender may be aliphatic. Non-limiting examples of amine functional chain extenders include: 4,4-diaminodicyclohexylmethane, 4,4-diamino-3,3-dimethyldicyclohexylmethane, 1,4-bis((2-amino-2-yl)-cyclohexane, 3,3-dimethyl-4,4-diaminodicyclohexylmethane, 1,3-diaminohexane, 1,4-diaminohexane, diethylene triamine, dipropylene triamine, hydrazine, ethylene diamine, 1-2-diamino propane, 1,3-diaminopropane, 1,6-diaminopropane, 1,3-diamino-2,2-dimethylpropane, isophorone diamine, triethylene tetramine, tripropylene tetramine, tetraethylene pentamine, and combinations thereof. Alternatively, the polyurethane dispersion may not include a chain extender, such as an amine chain extender.

The amine chain extender may comprise an amine value of at least 1,000 KOH/mg, or at least 1,100 KOH/mg, or at least 1,200 KOH/mg, or at least 1,300 KOH/mg. The amine chain extender may comprise an amine value of up to 2,500 KOH/mg, or up to 2,300 KOH/mg, or up to 2,100 KOH/mg, or up to 1,900 KOH/mg. The amine chain extender may comprise an amine value in the range of from 1,000 KOH/mg to 2,500 KOH/mg, or in the range of from 1,100 KOH/mg to 2,300 KOH/mg, or in the range of from 1,200 KOH/mg to 2,100 KOH/mg, or in the range of from 1,300 KOH/mg to 1,900 KOH/mg.

The amine chain extender may comprise at least two amine groups. For example, the amine chain extender may comprise at least two amine groups, or at least three amine groups, or at least four amine groups, or at least 5 amine groups.

The amine chain extender may comprise up to 10 amine groups, or up to 8 amine groups, or up to 6 amine groups. For example, the amine chain extender may comprise 2 amine groups to 6 amine groups.

The polyurethane dispersion may include an amine functional chain extender in an amount of at least greater than 0 weight %, based on the total weight of the polyurethane dispersion. The polyurethane dispersion may include an amine functional chain extender in an amount of up to 5 weight %, or up to 3 weight %, or up to 2 weight %, or up to 1 weight %, based on the total weight of the polyurethane dispersion. The polyurethane dispersion may include an amine functional chain extender in an amount in the range of from greater than 0 weight % to 5 weight %, or in the range of from greater than 0 weight % to 3 weight %, or in the range of from greater than 0 weight % to 2 weight %, or in the range of from greater than 0 weight % to 1 weight %, based on the total weight of the polyurethane dispersion.

The amine chain extender may react stepwise to chain extend the polyurethane polymer of the polyurethane dispersion.

The polyurethane dispersion may comprise water. The polyurethane dispersion may comprise water in an amount of at least 50 weight %, or at least 53 weight % or at least 55 weight %, or at least 60 weight %, based on the total weight of the polyurethane dispersion. The polyurethane dispersion may comprise water in an amount of up to 80 weight %, or up to 75 weight %, or up to 70 weight %, or up to 65 weight %, based on the total weight of the polyurethane dispersion. The polyurethane dispersion may comprise water in an amount in the range of from 50 weight % to 80 weight %, or in the range of from 53 weight % to 75 weight %, or in the range of from 55 weight % to 70 weight %, or in the range of from 60 weight % to 65 weight %, based on the total weight of the polyurethane dispersion.

The polyurethane polymer/polyurethane dispersion may be formed according to a specific method. For example, the components used to form the oil polyol may be reacted simultaneously first, followed by reaction of the components used to form the polyurethane polymer simultaneously, and then finally stepwise chain extension of the polyurethane polymer in an aqueous medium.

As previously described, the coating composition may comprise an epoxide. Examples of epoxides include epoxy functional polymeric materials, which is also known as a polyepoxide and which comprises two or more epoxy functional groups. The epoxide may be an emulsion. The epoxide can comprise one or more additional functional groups (e.g. carboxylic acid and/or hydroxyl functional groups) and be reactive with itself as a self-crosslinkable compound to form the reaction product. Alternatively, the epoxide can be reacted with a second compound such as a carboxylic acid and/or hydroxyl functional compound to form the reaction product. The epoxide layer may also comprise epoxy functional groups when there are excess epoxy functional groups in the reactants. Alternatively, the epoxy functional groups may all react during the reaction to form the reaction product such that no epoxy functional groups are present in the epoxide layer.

The coating composition may further include additional components such as, for example, a wax, an organic oil (e.g., tung oil), a polyolefin, a poly(meth)acrylate, a polyester, an alkene, a polyethylene, a polypropylene, an emulsion thereof, or some combination thereof. For instance the coating composition used to form the temporary protective layer 114 may further comprise polylactic acid (PLA), polyethylene carbonate (PEC), polypropylene carbonate (PPC), polycaprolactone, polyoxymethylene, polyethylene, polypropylene, or some combination thereof. The wax may include stearic acid, paraffin, carnauba, microcrystalline wax, polyethylene wax, or some combination thereof. Examples of wax emulsions include those available from Michelman, Inc. (Cincinnati, Ohio) (e.g., MGRD 1350, ML160, ME62330, Aqua240 PH90602L, ME48040M2) or BYK-Chemie GmbH (Wesel, Germany) (e.g., AQUACER 526, AQUACER 541, AQUACER 1031, AQUACER 8500). The wax emulsion may be a paraffin/polyethylene emulsion, an anionic polyamide emulsion, an anionic carnauba emulsion, an amine dispersed carnauba emulsion, an ethylene acrylic acid emulsion, a non-ionic microcrystalline emulsion, or some combination thereof. In some non-limiting examples, the temporary protective layer 114 may include an alkane, an ester, or a carboxylic acid and have at least 40 wt. % carbon, based on the total weight of the temporary protective layer, such as at least 50 wt. %, at least 60 wt. %, at least 70 wt. %, at least 80 wt. %, or at least 90 wt. %.

The temporary protective layer 114 may include a material that when included in the coating composition and applied to a substrate and solidified to form the temporary protective layer 114, the layer exhibits a water contact angle (WCA) (upon contact with water) of at least 60°, such as at least 70°, or at least 80°. The temporary protective layer 114 may include a hydrophobic material. A hydrophobic material is defined herein as a material that when included in a composition and applied to a substrate and solidified to form a layer, the layer exhibits a WCA (upon contact with water) of at least 90°, such as at least 100°, at least 110°, at least 120°, at least 130°, at least 140°, or at least 150°.

The coating composition used to form the temporary protective layer 114 may be dispersed in an aqueous medium. As used herein, an “aqueous medium” refers to a liquid medium comprising greater than 50 weight % of water, based on the total weight of said liquid medium. For example, the coating composition may be dispersed in a liquid medium that comprises greater than 50 weight % of water, or at least 55 weight % of water, or at least 60 weight % of water, or at least 65 weight % of water, or at least 70 weight % of water, or at least 75 weight % of water, based on the total liquid weight of said medium. The coating composition may be dispersed in a liquid medium that comprises water in an amount of from 50 weight % to 80 weight %, or in the range of from 50 weight % to 75 weight %, or in the range of from 50 weight % to 70 weight %, or in the range of from 55 weight % to 70 weight %, or in the range of from 60 weight % to 70 weight %, or in the range of from 60 weight % to 65 weight %, based on the total liquid weight of said medium. As such, the liquid medium may comprise less than 50 weight % of a solvent, based on the total weight of said liquid medium. The coating composition may be dispersed in a liquid medium that comprises a solvent in an amount of from greater than 0 weight % to 50 weight %, or in the range of from 0.5 weight % to 25 weight %, or in the range of from 0.5 weight % to 15 weight %, or in the range of from 1 weight % to 10 weight %, or in the range of from 1 weight % to 5 weight %, based on the total liquid weight of said medium.

The coating composition used to form the temporary protective layer 114 may be free of a solvent, such as volatile organic compounds (“VOC”).

Non-limiting examples of solvents that may be used in the coating composition include glycols, alcohols, glycol ether alcohols, volatile ketones, glycol diethers, esters, amines, diesters, aromatic and aliphatic hydrocarbons, pyrrolidones such as n-methyl pyrrolidone, and combinations thereof.

The coating composition used to form the temporary protective layer 114 may comprise a one-component coating composition. As used herein, the terms “one-component” or “1K” refer to a coating composition wherein all of the coating components are combined and stored in a single container. Alternatively, the coating composition may comprise a two-component coating composition. As used herein, the terms “two-component” or “2K” refer to a coating composition wherein the components are stored separately and, when mixed with one another, react to crosslink to form a crosslinked material. For example, a polyurethane and/or an epoxide may be contained within a first container and a crosslinker may be contained within a second container. The temporary protective layer 114 may comprise a thermoset resin system of any of the previously mentioned materials of the temporary protective layer 114. As used herein, a “thermoset resin system” is a network of at least one crosslinked material that forms a layer.

The coating composition may comprise optional additional components. Non-limiting examples of additional components include plasticizers, crosslinkers, viscosity modifiers, corrosion inhibitors, infrared (IR) absorbers, adhesion modifiers, UV absorbers, pigments, surfactants, and hydrophobic agents.

Non-limiting examples of suitable plasticizers for use in the coating composition of the temporary protective layer 114 include oils such as cotton seed oil, epoxidized soybean oil, and canola oil, waxes such as carnauba wax, paraffin, and microcrystalline wax, polyethylene glycol, and polypropylene glycol. Plasticizers are included in the coating composition used to form the temporary protective layer 114 to aid in the removal of the temporary protective layer 114 via abrasion wheels, especially when the temporary protective layer 114 is a thermoset resin system. A plasticizer may be included in the coating composition used to form the temporary protective layer 114 in an amount in the range of 1 to 50 wt %, or 4 to 40 wt %, or 10 to 30 wt %, based on the total components of the coating composition used to form the temporary protective layer 114.

Examples of suitable viscosity modifiers include RHEOBYK-425, RHEOBYK-T 1000VF, RHEOBYK-L 1400 VF, and RHEOBYK-H 3300 VF commercially available from BYK and H1335 and HY124 commercially available from Spectrum. A viscosity modifier may be included in the coating composition used to form the temporary protective layer 114 in an amount in the range of 0.05 to 20 wt %, or 0.1 to 15 wt %, or 0.1 to 10 wt %, based on the total components of the coating composition used to form the temporary protective layer 114.

Examples of suitable hydrophobic agents include waxes, oils, and fatty acids. A hydrophobic agent may be included in the temporary protective layer 114 in an amount in the range of 0.5 to 70 wt %, or 1 to 65 wt %, or 1 to 60 wt %, based on the total components of the coating composition used to form the temporary protective layer 114.

Examples of suitable crosslinkers for use in the coating composition of the temporary protective layer 114 composition include polyaziridines, polycarbodiimides, epoxy silanes, melamines, polyisocyanates, and combinations thereof. As used herein, a “crosslinker” refers to a compound that comprises two or more functional groups that are reactive with other functional groups and which is capable of linking two or more compounds through covalent bonds.

The crosslinker may comprise a polyaziridine. The polyaziridine may be any compound that comprise two or more aziridine groups. One non-limiting example of a polyaziridine that may be used as a crosslinker in the temporary protective layer 114 is trimethylolpropane tris(2-methyl-1-aziridinepropionate).

The crosslinker may comprise a polycarbodiimide. The polycarbodiimide may be any compound that comprises

A crosslinker may be included in the coating composition of the temporary protective layer 114 in an amount in the range of 0.05 to 30 wt %, or 0.1 to 20 wt %, or 0.1 to 10 wt %, based on the total components of the coating composition used to form the temporary protective layer 114. Crosslinkers are included in the temporary protective layer 114 composition in order to crosslink the composition, such as to create a thermoset resin system. For example, the coating composition may comprise a crosslinker that is reactive with the functionality of the polyurethane polymer, and may comprise from 1 weight % to 5 weight %, or from 1 weight % to 3 weight %, or from 1 weight % to 2 weight %, based on the total weight of the wet polyurethane polymer. A stoichiometric ratio of reactive groups on the polyurethane polymer to the reactive groups on the crosslinker may be in the range of from 1:1 to 1:0.05, or in the range of from 1:0.8 to 1:0.1, or in the range of from 1:0.6 to 1:0.2, or in the range of from 1:0.5 to 1:0.3.

The coating composition used to form the temporary protective layer 114 may comprise inorganic compounds, such as talc, silica, metallic catalysts, inorganic pigments, and the like. Alternatively, one or more of the coating layers (e.g. one or all of the coating layers) may be free of any of the previously described additional components, such as being free of inorganic compounds such as talc, silica, metallic catalysts, inorganic pigments, and the like.

The coating composition used to form the temporary protective layer 114 may be a dual cure coating composition. As used herein, a “dual cure” coating composition refers to a coating composition that may use both light and chemical initiation to activate polymerization. If the coating composition used to form the temporary protective layer 114 comprises a dual cure coating composition, said dual cure coating composition may comprise one or more improved properties over a single, light or chemical cure coating composition. For example, a dual cure coating composition may result in a higher crosslinking density, improved chemical and water resistance properties, higher hardness, lower elongation properties, and higher tensile strength, compared to a single, light or chemical cure coating composition. In one non-limiting embodiment, the coating composition may comprise at least 2 crosslinkers, or at least 3 crosslinkers, or at least 4 crosslinkers. The at least 2 crosslinkers, or at least 3 crosslinkers, or at least 4 crosslinkers may be any of the crosslinkers previously described as suitable for use in the coating composition. The at least 2 crosslinkers, or at least 3 crosslinkers, or at least 4 crosslinkers may initiate polymerization and/or crosslinking with different mechanisms, such as light and chemical initiation. Alternatively, the coating composition may comprise at least one crosslinker and the polyurethane polymer may be self-crosslinking. For example, the coating composition may comprise at least one crosslinker and the polyurethane polymer may be self-crosslinking through oxidative cure.

The polyurethane polymer and/or polyurethane dispersion may be burnable. As such, if the polyurethane polymer and/or polyurethane dispersion is used in a coating composition, when said coating composition is cured to form a coating layer, said coating layer may be considered a burnable coating layer. The polyurethane polymer and/or polyurethane dispersion and any additional components discussed herein for use in a coating composition used to form the temporary protective layer, may be also used in a coating composition to form the first and/or second temporary protective sheets 116, 118, the temporary protective layer 214, the first and/or second temporary protective sheets 216, 218, the temporary protective layer 314, the first and/or second temporary protective sheets 316, 318, the first and or second temporary protective sheets 1016, 1018, the temporary protective layer 514, the first and/or second temporary protective sheets 516, 518, the temporary protective layer 1114, the burnable sheet 1128, the burn-off temporary protective layer 426, and/or the burn-off temporary protective layer 626. As such, the temporary protective layer 114, the first and/or second temporary protective sheets 116, 118, the temporary protective layer 214, the first and/or second temporary protective sheets 216, 218, the temporary protective layer 314, the first and/or second temporary protective sheets 316, 318, the first and or second temporary protective sheets 1016, 1018, the temporary protective layer 514, the first and/or second temporary protective sheets 516, 518, the temporary protective layer 1114, the burnable sheet 1128, the burn-off temporary protective layer 426, and/or the burn-off temporary protective layer 626 may be removable by burning, vaporizing, removing using a solvent, or peeling. For example, the temporary protective layer 114, the first and/or second temporary protective sheets 116, 118, the temporary protective layer 214, the first and/or second temporary protective sheets 216, 218, the temporary protective layer 314, the first and/or second temporary protective sheets 316, 318, the first and or second temporary protective sheets 1016, 1018, the temporary protective layer 514, the first and/or second temporary protective sheets 516, 518, the temporary protective layer 1114, the burnable sheet 1128, the burn-off temporary protective layer 426, and/or the burn-off temporary protective layer 626 may be removable by a heat treatment process that does not substantially damage the surface.

The temporary protective layer 114 may include a material having a melting point of at least 60° C., such as at least 70° C. or at least 80° C. The temporary protective layer 114 may include a material having a melting point of up to 700° C., or up to 650° C., or up to 600° C. The temporary protective layer may have a melting point of from 60° C.-700° C., or of from 60° C.-650° C., or of from 60° C.-600° C., or of from 70° C.-700° C., or of from 70° C.-650° C., or of from 70° C.-600° C., or of from 80° C.-700° C., or of from 80° C.-650° C., or of from 80° C.-600° C. The temporary protective layer 114 may include a material that, when solidified, is impermeable to water and other standard processing liquids, such as cooling agents, cutting oils, and the like. The temporary protective layer 114 may provide increased corrosion protection to the substrate 112 compared to the same substrate not including the temporary protective layer 114 positioned thereover.

The material applied to form the temporary protective layer 114 may be a thermoplastic or thermoset. As used herein, a “thermoplastic” is a material that softens when heated and has a defined melting point. The material applied to form the temporary protective layer 114 may be a thermoset of any of the previously mentioned materials of the temporary protective layer 114. As used herein, a “thermoset” is any crosslinked material that does not have a defined melting point, and instead burns or decomposes when heated. The material applied to form the temporary protective layer 114 may have a low degree of cross-linking such that the material has a defined melting temperature. The material applied to form the temporary protective layer 114 may have a high degree of cross-linking such that the material does not have a defined melting temperature. A high degree of cross-linking can be achieved, for example, via solvent based formulations or by the addition of a crosslinker to an aqueous formulation.

In some non-limiting examples, the material applied to form the temporary protective layer 114 may include an emulsion comprising a hydrophobic material, water, and a surfactant, and the surfactant may be a non-ionic surfactant or an ionic surfactant (e.g., a cationic or an anionic surfactant). The material applied to form the temporary protective layer 114 may include a material comprising a hydrophobic material dissolved in a solvent. Alternatively, the material applied to form the temporary protective layer 114 may not be required to be dissolved in a solvent. The material applied to form the temporary protective layer may include an ultraviolet (“UV”) curable or heat curable material. As used herein, a “UV curable” material is a material that, when applied to a surface of a substrate and exposed to an UV source, results in crosslinking of the applied material on the substrate. As used herein, a “heat curable” material is a material that, when applied to a surface of a substrate and exposed to a heat source, results in crosslinking of the applied material on the substrate.

In some non-limiting examples, the material is heated until its temperature is at least the Tg of the material, and the material is applied at the temperature that is at least the Tg of the material. In other non-limiting examples the material is applied at a temperature below the Tg of the material and subsequently heated to a temperature suitable for the material to soften, such as above the Tg of the material. The material may also require a curing step at a temperature for a period of time. For example, the material may be cured at room temperature (i.e., in the range of 20-27° C., such as 25° C.) for a period of time of up to 72 hours, or up to 48 hours, or up to 36 hours, or up to 24 hours. The material may also be cured at an elevated temperature, such as in the range of 90-180° C., or 100-170° C., or 110-150° C., or 120-130° C. (such as 121° C.), for a period of time of up to 2 hours, such as 1 hour, such as 30 minutes, such as 15 minutes.

The temporary protective layer 114 may be a layer removable from the surface of the substrate 112, even after the composition of the temporary protective 114 layer has been applied and solidified over the substrate 112 to form the temporary protective layer 114. The temporary protective layer 114 may be removed without substantially damaging the substrate 112 or rendering it unsuitable for its intended use (as hereinafter defined). The temporary protective layer 114 may be removed from the substrate 112 using any sufficient means, such as by burning, vaporizing, removing using a solvent, or peeling the temporary protective layer 114 from the substrate 112.

The temporary protective layer 114 may have a thickness ranging from 10 nm to 5,000 μm, such as 10 nm to 1,000 μm, 10 nm to 500 μm, 0.5 μm to 100m, 0.5 μm to 10 μm, 10 μm to 30 μm, or 50 μm to 100 μm. The thickness should be sufficiently thick such that a continuous layer is formed. The temporary protective layer 114 may also be sufficiently thick so as to provide corrosion protection to the substrate 112. The temporary protective layer 114 may be thin enough such that upon burning, evaporating, or otherwise thermally decomposing of the temporary protective layer 114, substantial amounts of residue do not remain on the substrate 112. In this way, the temporary protective layer 114 may be burnable.

With continued reference to FIG. 1, the protected substrate 100 may further include a plurality of temporary protective sheets, including a first temporary protective sheet 116 and a second temporary protective sheet 118. The first temporary protective sheet 116 and the second temporary protective sheet 118 may be made of a plastic material, such as a polyethylene, polypropylene, polyester, polyethylene terephthalate, nylon, polyvinyl chloride, vinyl, polylactic acid, polyoxymethylene, or some combination thereof. The first temporary protective sheet 116 and/or the second temporary protective sheet 118 may comprise a thermoset resin system of any of the previously mentioned materials of the temporary protective sheet 116. In some non-limiting examples the second temporary protective sheet 118 may include a plastic film and a pressure sensitive adhesive applied on the plastic film. Examples of commercially available protective sheets include CGP-470, CGP-551, CGP-572, and/or CGP-591 protective films commercially available from Nitto Belgium NV (Genk, Belgium). The temporary protective sheets 116, 118 may include an adhesive layer that allows the temporary protective sheets 116, 118 to adhere to the layer over which they are placed. The adhesive layer may include a hydrophobic material exhibiting a water contact angle of at least 90°. In other examples, the temporary protective sheets 116, 118 do not include an adhesive layer and are positioned over the layer over which they are placed without adhering thereto using an adhesive.

The first and second temporary protective sheets 116, 118 may be positioned over the surface of the substrate 112. The first and/or second temporary protective sheets 116, 118 may be positioned over at least a portion of the temporary protective layer 114. The first and second temporary protective sheets 116, 118 may be separately formed plastic sheets positioned over the substrate 112. The temporary protective sheets 116, 118 may be positioned over the temporary protective layer 114 after the temporary protective layer 114 has been cooled to ambient temperature (after it has been solidified to form the temporary protective layer 114).

To form the protected substrate 100, the first and/or second temporary protective sheet 116, 118 may be positioned over the temporary protective layer 114 prior to shipping the protected substrate 100. Once the protected substrate 100 reaches its destination, the first and/or the second temporary protective sheets 116, 118 may be removed from the protected substrate 100, such that the removal (e.g., peeling or otherwise removing the sheets from the substrate) of the temporary protective sheets 116, 118 does not peel a majority (>50% by weight of the temporary protective layer 114) of the temporary protective layer 114 from the surface of the substrate 112. The removal of the first and/or second temporary protective sheets 116, 118 may leave substantially all (greater than 90% or greater than 95% by weight of the temporary protective layer 114) of the temporary protective layer 114 on the surface of the substrate 112. Thus, removal of the temporary protective sheets 116, 118 may leave the temporary protective layer 114 substantially intact over the surface of the substrate 112.

The first and second temporary protective sheets 116, 118 may be positioned over the substrate 112 in any number of arrangements to form the protected substrate 100, and FIGS. 1-11 show various non-limiting embodiments of protected substrates 100, 200, 300, 400, 500, 600, 700, 800, 900, 1000, 1100 each of which is described in more detail hereinafter. It will be appreciated that components in FIGS. 1-11 having the same last two digits in their element number correspond to components from the other FIGS. in the application and include the same characteristics of the corresponding components. For example, components 112, 212, 312, 412, 512, and the like all refer to the previously described substrate since all of these element numbers have the same last two digits (12).

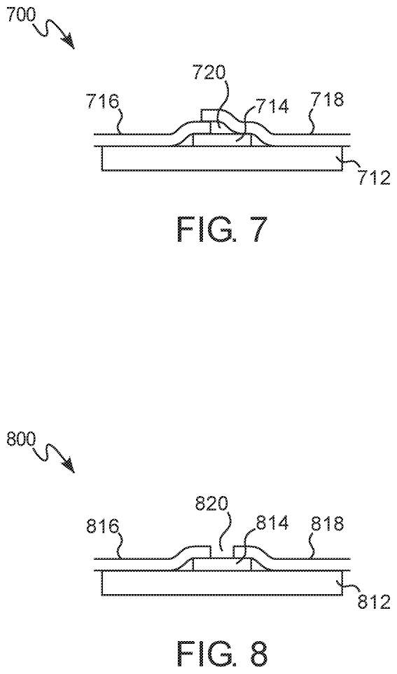

Referring to FIG. 1, the temporary protective layer 114 is positioned over at least a portion of the surface of the substrate 112. The first and second temporary protective sheets 116, 118 are positioned over at least a portion of the surface of the substrate 112 and at least a portion of the temporary protective layer 114. The first and second temporary protective sheets 116, 118 overlap with each other to form an overlap portion. The first and/or second temporary protective sheets 116, 118 may be formed from a coating composition comprising any of the polymers and/or additives disclosed for use in a coating composition used to form the temporary protective layer 114. For example, the first and/or second temporary protective sheets 116, 118 may be formed from a coating composition comprising any of the coating compositions discussed herein that may be used as a coating composition used to form the temporary protective layer 114, including any of the materials and/or additives discussed herein; for example, the polyurethane polymer and/or polyurethane dispersion. In the example shown in FIG. 1, the temporary protective layer 114 is applied over an entire surface of the substrate 112, but in other non-limiting examples, the temporary protective layer 114 may be selectively applied over less than the entire substrate 112 (e.g., only over a section at an overlap of the temporary protective sheets 116, 118) (see e.g., FIG. 7). Beneath the overlap portion formed by the first and second temporary protective sheets 116, 118, a gap 120 may be defined between the second temporary protective sheet 118 and a portion of the surface of the substrate 112. This gap 120 may be an air gap and may be free of material from the temporary protective layer 114, the first temporary protective sheet 116, and/or the second temporary protective sheet 118. In this way, the first and second temporary protective sheets 116, 118 are applied over the temporary protective layer 114, such that the gap 120 formed is free of material of the temporary protective layer 114, and the temporary protective layer 114, the first temporary protective sheet 116, and/or the second temporary protective sheet 118 does not fill the gap 120 between the first and second temporary protective sheet 116, 118. A portion of the temporary protective layer 114 is positioned between the second temporary protective sheet 118 and the portion of the surface of the substrate 112.

Referring to FIG. 10, the protected substrate 1000 may be identical to the protected substrates 100, 700 shown in FIGS. 1 and 7, respectively, except as follows. The protected substrate 1000 may further include tape 1022. The tape 1022 may hold the first temporary protective sheet 1016 and second temporary protective sheet 1018 together.

Referring to FIG. 2, the protected substrate 200 includes the substrate 212 having the temporary protective layer 214 applied over at least a first portion of the substrate 212. In the example shown in FIG. 2, the temporary protective layer 214 is applied over an entire surface of the substrate 212, but in other non-limiting examples, the temporary protective layer 214 may be selectively applied over less than the entire substrate 212 (e.g., proximate the gap 220 formed between the first and second temporary protective sheets 216, 218) (see e.g., FIG. 8). The temporary protective layer 214 may be formed from a coating composition comprising any of the polymers and/or additives disclosed for use in a coating composition used to form the temporary protective layer 114. For example, the temporary protective layer 214 may be formed from a coating composition comprising any of the coating compositions discussed herein that may be used as a coating composition used to form the temporary protective layer 114, including any of the materials and/or additives discussed herein; for example, the polyurethane polymer and/or polyurethane dispersion. The first temporary protective sheet 216 may be positioned over at least a second portion of the substrate 212 and a first portion of the temporary protective layer 214. The second temporary protective sheet 218 may be positioned over at least a third portion of the substrate 212 and a second portion of the temporary protective layer 214 and may be spaced apart the first temporary protective sheet 216, such that the first and second temporary protective sheets 216, 218 are not in direct contact. A fourth portion of the surface of the substrate 212 is not covered by either temporary protective sheet 216, 218. The first and/or second temporary protective sheets 216, 218 may be formed from a coating composition comprising any of the polymers and/or additives disclosed for use in a coating composition used to form the temporary protective layer 114. For example, the first and/or second temporary protective sheets 216, 218 may be formed from a coating composition comprising any of the coating compositions discussed herein that may be used as a coating composition used to form the temporary protective layer 114, including any of the materials and/or additives discussed herein; for example, the polyurethane polymer and/or polyurethane dispersion. The temporary protective layer 214 is positioned over this fourth portion (and may also be applied over the first and/or second portion of the substrate 212). The gap 220 may be formed between the first and second temporary protective sheets 216, 218, directly above the temporary protective layer 214 over the fourth portion.

With continued reference to FIG. 2, the protected substrate 200 may include the planar substrate 212 and a first portion thereof over which the temporary protective layer 214 is applied. The substrate 212 may include a second portion over which the first temporary protective sheet 216 is positioned. The substrate may include a third portion over which the second temporary protective sheet 218 is applied. The first portion is not covered by the temporary protective sheets 216, 218. The temporary protective layer 214 is positioned directly beneath the first and/or the second temporary protective sheet 216, 218 and between the substrate 212 and the first and/or the second temporary protective sheet 216, 218. The temporary protective sheets 216, 218 may or may not overlap with one another.

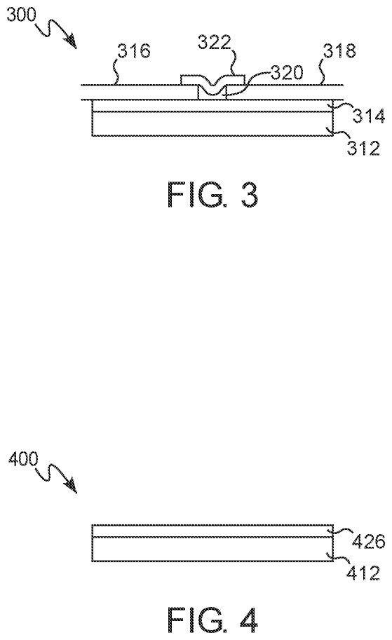

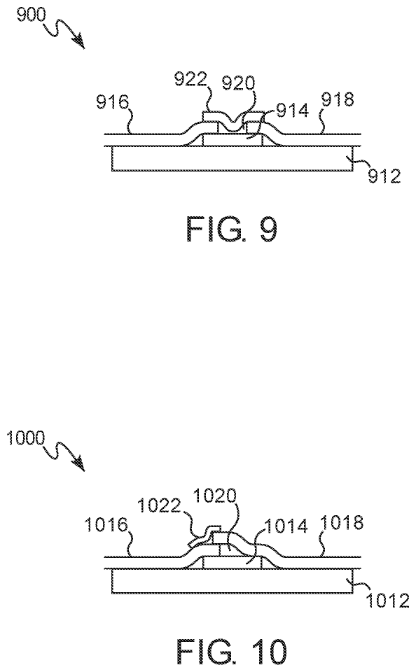

Referring to the protected substrate 300 of FIG. 3, the substrate 312, temporary protective layer 314, and first and second temporary protective sheets 316, 318 may be arranged as described in connection with FIG. 2. The first and/or second temporary protective sheets 316, 318 may be formed from a coating composition comprising any of the polymers and/or additives disclosed for use in a coating composition used to form the temporary protective layer 114. For example, the first and/or second temporary protective sheets 316, 318 may be formed from a coating composition comprising any of the coating compositions discussed herein that may be used as a coating composition used to form the temporary protective layer 114, including any of the materials and/or additives discussed herein; for example, the polyurethane polymer and/or polyurethane dispersion. The protected substrate 300 may further include tape 322 positioned over the third portion of the surface of the substrate 312, a portion of the temporary protective layer 314, a portion of the first temporary protective sheet 316, and/or a portion of the second temporary protective sheet 318. The tape 322 may hold the first temporary protective sheet 316 and second temporary protective sheet 318 together. The gap 320 may be defined between the portion of the tape 322 positioned above the temporary protective layer 314 and the temporary protective layer 314 and between the temporary protective sheets 316, 318. The tape 322 from FIG. 3 may also be used in the protected substrate 100 of FIG. 1 to hold the first protective sheet 116 and second protective sheet 118 together. In the example shown in FIG. 3, the temporary protective layer 314 is applied over an entire surface of the substrate 312, but in other non-limiting examples, the temporary protective layer 314 may be selectively applied over less than the entire substrate 312 (e.g., only over a section beneath the tape 322) (see e.g., FIG. 9). The temporary protective layer 314 may be formed from a coating composition comprising any of the polymers and/or additives disclosed for use in the temporary protective layer 114. For example, the temporary protective layer 314 may be formed from a coating composition comprising any of the coating compositions discussed herein that may be used for the temporary protective layer 114, including any of the materials and/or additives discussed herein; for example, the polyurethane polymer and/or polyurethane dispersion.

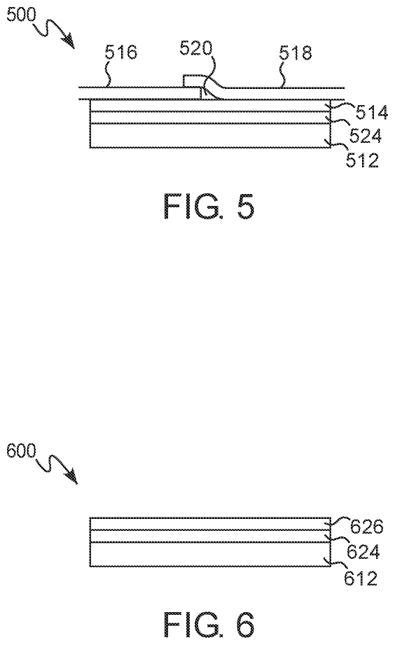

Referring to FIG. 5, the protected substrate 500 may further include a coating layer 524 positioned between the surface of the substrate 512 and the temporary protective layer 514. The temporary protective layer 514 may be formed from a coating composition comprising any of the polymers and/or additives disclosed for use in the temporary protective layer 114. For example, the temporary protective layer 514 may be formed from a coating composition comprising any of the coating compositions discussed herein that may be used for the temporary protective layer 114, including any of the materials and/or additives discussed herein; for example, the polyurethane polymer and/or polyurethane dispersion. Multiple coating layers may be positioned over the substrate 512 and under the temporary protective layer 514, such that the temporary protective layer 514 protects the multi-layer coating. The coating layer 524 may, for example, include a low-E coating layer (or other functional coating layer as previously described). The coating layer 524 may be suitable for tempering after application to the substrate 512. The coating layer 524 may include a metal or metal oxide. The coating layer 524 may include a polymer. The coating layer 524 may include any temperable coating layer, for example, those disclosed in British Patent No. GB 2,302,102; U.S. Pat. Nos. 4,504,109; 4,952,423; 5,028,759; 5,059,295; 5,653,903; 7,749,621; 8,865,325; U.S. Published Patent Application No. 2014/0272453. The coating layer 524 may include coatings available under the tradename Solarban® or Sungate®, commercially available from Vitro Architectural Glass (Cheswick, Pa.). The first and second temporary protective sheets 516, 518 may be positioned over the temporary protective layer 514 and form the gap 520, as previously described. It will be appreciated that any of the previously-described embodiments of protected substrates may include a coating layer (e.g., a functional coating layer) positioned between the substrate and the temporary protective layer.

The present invention is also directed to a method of protecting the previously-described substrates by forming the previously-described protected substrates.

In one non-limiting embodiment, the method for protecting a substrate may include: providing a substrate comprising a surface; applying a material to form a temporary protective layer over at least a first portion of the surface; adhering and/or positioning a first temporary protective sheet over a second portion of the surface, where a portion of the first temporary protective sheet overlaps a first portion of the temporary protective; and adhering and/or positioning a second temporary protective sheet over a second portion of the temporary protective layer and over a third portion of the surface. An overlap may be formed between the first temporary protective sheet and the second temporary protective sheet, and the gap may be defined by the overlap between the second temporary protective sheet and the surface.

In one non-limiting embodiment, the method for protecting a substrate may include: providing a planar substrate including a surface; applying a material to form a temporary protective layer over at least a first portion of the surface; adhering and/or positioning a first temporary protective sheet over a second portion of the surface; and adhering and/or positioning a second temporary protective sheet over a third portion of the surface where a space is formed between the first temporary protective sheet and the second temporary protective sheet. The space may be over the first portion of the surface, and the temporary protective layer may be positioned directly beneath the first and/or second protective sheet and positioned between the substrate and the first and/or second temporary protective sheet.

The material applied to form the temporary protective layer may be applied over the surface of the substrate by any suitable method, such as spray coating, curtain coating, powder coating, brush coating, roll coating, inkjet printing, or some combination thereof. The temporary protective layer formed using any of these methods may include a polyurethane layer, an epoxide layer, or a combination thereof, which upon solidification forms the temporary protective layer. Examples of polyurethanes for the polyurethane layer include aqueous polyurethanes, polyurethanes formed from a two component system, emulsions thereof, and combinations thereof. Examples of epoxides for the epoxide layer include epoxy functional polymeric materials.

The method may include heating the material applied to form the temporary protective layer to a temperature sufficient to form a molten liquid prior to application of the material to the substrate. In some examples, this material may be applied to the surface of the substrate at a temperature above the melting point of the material. In some examples, the molten liquid may be applied to the surface of the substrate by bubbling a gas through the molten liquid (vapor deposition method) such that the material forms the temporary protective layer over the substrate. The gas bubbled through the molten liquid to deposit the material and to form the temporary protective layer may include an inert gas, such as nitrogen or helium. The inert gas may reduce the possibility of a chemical reaction with the material used to form the temporary protective layer. The material may further require a curing step at a temperature for a period of time. For example, the material may be cured at room temperature (i.e., in the range of 20-27° C., such as 25° C.) for a period of time of up to 72 hours, or up to 48 hours, or up to 36 hours, or up to 24 hours. The material may also be cured at an elevated temperature, such as in the range of 90-180° C., or 100-170° C., or 110-150° C., or 120-130° C. (such as 121° C.), for a period of time of up to 2 hours, such as 1 hour, such as 30 minutes, such as 15 minutes.

A method of removing a temporary protective layer from a coated substrate may include: providing a protected substrate, comprising: a planar substrate comprising a surface; a temporary protective layer positioned over at least a portion of the surface; a first temporary protective sheet positioned over at least a first portion of the surface; and a second temporary protective sheet positioned over at least a second portion the surface, wherein an overlapping portion of the second temporary protective sheet overlaps an overlapping portion of the first temporary protective sheet at an overlap, where a gap is defined by the overlap between the second temporary protective sheet and a portion of the surface and a portion of the temporary protective layer is positioned between the second temporary protective sheet and the portion of the surface. The method may include removing the first temporary protective sheet and/or the temporary protective sheet by peeling. The method may include removing the temporary protective layer from the surface by burning, vaporizing, removing using a solvent, or peeling the temporary protective layer to form an unprotected substrate. The protected substrate may be heated to a temperature of up to 1000° C. to remove the temporary protective layer from the surface.

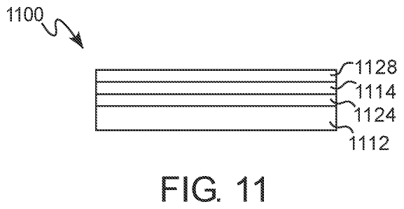

Referring to FIG. 11, the protected substrate 1100 may include the substrate 1112, a temporary protective layer 1114 positioned over at least a portion of the surface of the substrate 1112, and a burnable sheet 1128 positioned over at least a portion of the temporary protective layer 1114, and optionally in direct contact with the temporary protective layer 1114. The temporary protective layer 1114 and/or the burnable sheet 1128 may be formed from a coating composition comprising any of the polymers and/or additives disclosed for use in a coating composition used to form the temporary protective layer 114. For example, the temporary protective layer 1114 and/or the burnable sheet 1128 may be formed from a coating composition comprising any of the coating compositions discussed herein that may be used as a coating composition used to form the temporary protective layer 114, including any of the materials and/or additives discussed herein; for example, the polyurethane polymer and/or polyurethane dispersion. The burnable sheet 1128 may include polyethylene, polypropylene, polyacrylate, polymethyl methacrylate, polylactic acid, polycaprolactone, polyoxymethylene, or a combination thereof. The burnable sheet 1128 may optionally include an adhesive. The burnable sheet 1128 may be made of a material that allows at least some of the UV light to pass through it so as to cure the temporary protective layer 1114 arranged thereunder. UV radiation may be applied to the protected substrate 1100 using a UV source, and the UV radiation may cure the temporary protective layer 1114, which may also function as an adhesive to adhere the burnable sheet 1128 to the substrate 1112. The temporary protective layer 1114 and/or the burnable sheet 1128 may comprise any of the polymers and/or additives disclosed for use in the temporary protective layer 114. For example, the temporary protective layer 1114 and/or the burnable sheet 1128 may comprise any of the coating compositions discussed herein that may be used for the temporary protective layer 114, including any of the materials and/or additives discussed herein; for example, the polyurethane polymer and/or polyurethane dispersion. Both the temporary protective layer 1114 and the burnable sheet 1128 may burn away during a tempering process. The temporary protective layer 1114 may have the previously-described thickness. The burnable sheet 1128 may have a thickness of 0.1-10 mils, such as 0.5-5 mils or 0.5-2 mils. The burnable sheet 1128 may be an outermost sheet over the substrate 1112. The temporary protective layer 1114 and the burnable sheet 1128 may be made of a burnable material. The protected substrate 1100 may include a coating layer 1124, as previously described.

As used in this disclosure, the term “burnable” refers to a material that will burn, evaporate, or otherwise thermally decompose from the substrate, without interacting with the substrate or otherwise substantially damaging (as defined hereinafter) the aesthetics or performance of the substrate (including any coating thereover). Burnable materials would burn, evaporate or otherwise thermally decompose at least when the temperature of the substrate is from 500° C. to 1000° C. It is anticipated that the burnable material will burn, evaporate, or otherwise thermally decompose before the substrate reaches a temperature of 1000° C., such as a temperature of 900° C., 800° C., 700° C., 650° C. or 600° C. The heat treatment process may be conducted in a furnace having a temperature of up to 1200° C., such as up to 1100° C., up to 1000° C., up to 900° C., up to 800° C., up to 700° C., or up to 650° C. The furnace may operate at a temperature of 700° C., such that the substrate reaches a temperature of 640° C. for the burn-off temporary protective layer (described hereinafter) to be removed during the heat treatment process. In some non-limiting embodiments, the burnable material may be removed during standard heat treatment processes, such as tempering, heat strengthening, or bending or during a heat treatment specifically performed to remove the burnable material without adversely affecting the substrate, as previously described. In some non-limiting examples, the burnable material may be removed during a standard tempering procedure in which the tempering ovens operate in the range of 500° C.-1000° C., such as 600° C.-800° C., or such a 650° C.-750° C.

Referring to FIG. 4, the protected substrate 400 may include the substrate 412 and a burn-off temporary protective layer 426 positioned over at least a portion of the surface of the substrate 412. The burn-off temporary protective layer 426 may be formed from a coating composition comprising any of the polymers and/or additives disclosed for use in the temporary protective layer 114. For example, the burn-off temporary protective layer 426 may be formed from a coating composition comprising any of the coating compositions discussed herein that may be used for the temporary protective layer 114, including any of the materials and/or additives discussed herein; for example, the polyurethane polymer and/or polyurethane dispersion. Referring to FIG. 6, the protected substrate 600 may include the substrate 612 and the burn-off temporary protective layer 626 positioned over at least a portion of the surface of the substrate 612 (like in FIG. 4), and may further include coating layer 624 between the substrate 612 and the burn-off temporary protective layer 626. The burn-off temporary protective layer 626 may be formed from a coating composition comprising any of the polymers and/or additives disclosed for use in the temporary protective layer 114. For example, the burn-off temporary protective layer 626 may be formed from a coating composition comprising any of the coating compositions discussed herein that may be used for the temporary protective layer 114, including any of the materials and/or additives discussed herein; for example, the polyurethane polymer and/or polyurethane dispersion. As used herein, the term “burn-off temporary protective layer” means a layer that is removable by a heat treatment process that does not substantially damage the surface. The burn-off temporary protective layer 426 and burn-off temporary protective layer 626 may be identical to or comprise the same components or similar components to the temporary protective layer 114 of FIG. 1.

The burn-off temporary protective layer 626 may comprise any of the polymers and/or additives disclosed for use in the temporary protective layer 114. For example, the burn-off temporary protective layer 626 may comprise any of the coating compositions discussed herein that may be used for the temporary protective layer 114, including any of the materials and/or additives discussed herein; for example, the polyurethane polymer and/or polyurethane dispersion.

The burn-off temporary protective layer 626 may have a thickness of 10 nm to 5000 μm, such as 1 μm to 100 μm, such as 5 μm to 50 μm, such as from 5 μm to 20 μm. The burn-off temporary protective layer 626 may be an outermost layer over the substrate 612.

The burn-off temporary protective layer 626 may be removed by burning (or other heat treatment process) without substantially damaging the surface. As used herein, “substantially damaging” is defined as a change that is detrimental to the function or aesthetics of the substrate that constitutes any unwanted change in a substrate property that would make the substrate unacceptable for its intended purpose. For example, substantially damaging the surface may include substantial discoloration to the surface from the heat treatment process. In other applications where a heating step is part of the standard procedure, the damage may be defined as an unwanted color change due to the presence of burn-off coating as compared to a similar sample that is heated without the burn-off coating. As used here, substantial discoloration means a color change (DECMC) of more than 3 units, more than 2 units, or more than 1 unit compared to the color of an identical substrate processed without the burn-of coating subject to the same heat treatment process. DECMC (CIELAB) may be measured using an integrating sphere with D65 Illumination, 10° observer with specular component included according to ASTM Designation: D 2244-05 unless otherwise stated. Other examples of substantial damage include or could be induced by a change in surface roughness, a change in the oxidation state of the surface, or a change in surface energy due to the presence of burn-off coating during the heat treatment process, or an unwanted reaction between the burn-off temporary protective layer and the substrate during the heat treatment process. Substantial damage may include any detrimental change to a functional coating disposed over the substrate beneath the burn-off temporary protective layer (e.g., an anti-microbial functional coating that no longer sanitizes the surface after the heat treatment process, a hydrophobic functional coating that loses its hydrophobicity after the heat treatment process, a color change to the functional coating discernable by the human eye (e.g., DECMC>3, 2, or 1) compared to an identical substrate exposed to the same heat treatment process without the burn-off temporary protective layer.

The burn-off temporary protective layer 626 may be removable by burning at a temperature of up to 1000° C., such as up to 900° C., up to 800° C., up to 700° C., up to 600° C., or up to 500° C. The burn-off temporary protective layer 626 may be removed during standard heat treatment processes, such as tempering, heat strengthening, or bending or during a heat treatment specifically performed to remove the burnable material without substantially damaging the substrate 612. In one non-limiting examples, the burnable material may be removed during a standard tempering procedure in which the tempering furnaces operate in the range of 500° C.-1000° C. The protected substrate 600 may include an optional coating layer 624, as previously described.

With continued reference to FIGS. 4 and 6, the substrate may not include any temporary protective sheet over a surface of the substrate, as the burn-off temporary protective layer may sufficiently protect the substrate as the outermost layer.

In some non-limiting examples, the burn-off temporary protective layer may be positioned over the entire surface of the substrate. The burn-off temporary protective layer may also cover at least a portion of the edge of the substrate.

A method for protecting the substrate may include: providing the planar substrate comprising a surface and applying a material to form the burn-off temporary protective layer over at least a first portion of the surface. The burn-off temporary protective layer may be applied over the substrate using any of the previously describe methods of applying the temporary protective layer. The method may further include preparing the material via an emulsion, where the material is dispersed in water or an aqueous medium. As used herein, an “aqueous medium” is a liquid mixture comprising greater than 50% water. Additional additives, such as crosslinkers, may be added during preparation of the material that forms the burn-off protective layer. Alternatively, the additional additives may be added right before the material is applied to form the burn-off temporary protective layer. The material may also require a curing step at a temperature for a period of time. For example, the material may be cured at room temperature (i.e., in the range of 20-27° C., such as 25° C.) for a period of time of up to 72 hours, or up to 48 hours, or up to 36 hours, or up to 24 hours. The material may also be cured at an elevated temperature, such as in the range of 90-180° C., or 100-170° C., or 110-150° C., or 120-130° C., for a period of time of up to 2 hours, such as 1 hour, such as 30 minutes, such as 15 minutes.

A method of removing a burn-off temporary protective layer from a coated substrate, may include: providing a coated substrate comprising a surface over a portion of which a burn-off temporary protective layer is applied and removing the burn-off temporary protective layer from the surface by burning the burn-off temporary protective layer to form an unprotected substrate. The coated substrate may be heated to a temperature of up to 1000° C. to remove the burn-off temporary protective layer from the surface.

The present invention further includes the subject matter of the following clauses.

Clause 1: A protected substrate, comprising: a planar substrate comprising a surface; a temporary protective layer positioned over at least a portion of the surface; a first temporary protective sheet positioned over at least a first portion the surface; and a second temporary protective sheet positioned over at least a second portion the surface, wherein an overlapping portion of the second temporary protective sheet overlaps an overlapping portion of the first temporary protective sheet at an overlap; wherein a gap is defined by the overlap between the second temporary protective sheet and a portion of the surface, wherein a portion of the temporary protective layer is positioned between the second temporary protective sheet and the portion of the surface.

Clause 2: The protected substrate of clause 1, wherein the temporary protective layer is removable by burning, vaporizing, removing using a solvent, or peeling.

Clause 3: The protected substrate of clause 1 or 2, wherein the planar substrate comprises glass.

Clause 4: The protected substrate of any of clauses 1-3, wherein the planar substrate comprises metal or wood.

Clause 5: The protected substrate of any of clauses 1-4, further comprising a functional coating positioned over the surface and between the surface and the temporary protective layer.

Clause 6: The protected substrate of clause 5, wherein the functional coating comprises a low-E coating layer.

Clause 7: The protected substrate of any of clauses 1-6, wherein the temporary protective layer comprises a polyurethane layer, an epoxide layer, or a combination thereof.

Clause 8: The protected substrate of clause 7, wherein the polyurethane layer comprises an aqueous polyurethane, a polyurethane formed from a two component system, or a combination thereof.

Clause 9: The protected substrate of clauses 7-8, wherein the epoxide layer comprises an epoxy functional polymeric material.

Clause 10: The protected substrate of any of clauses 1-9, wherein the temporary protective layer comprises a thickness of at least 10 nm and at most 5,000 μm.

Clause 11: The protected substrate of any of clauses 1-10, wherein the first temporary protective sheet and/or the second temporary protective sheet is configured to be removed from the protected substrate, wherein removal of the first temporary protective sheet and/or the second temporary protective sheet from the protected substrate does not peel a majority of the temporary protective layer from the surface.

Clause 12: The protected substrate of any of clauses 1-11, wherein the temporary protective layer comprises a material having a melting point of at least 60° C.

Clause 13: The protected substrate of any of clauses 1-12, wherein the temporary protective layer comprises a hydrophobic material.

Clause 14: The protected substrate of any of clauses 1-13, wherein when the temporary protective layer contacts water, the temporary protective layer exhibits a water contact angle of at least 60°.

Clause 15: The protected substrate of any of clauses 1-14, wherein the temporary protective layer is water impermeable.

Clause 16: The protected substrate of any of clauses 1-15, wherein the temporary protective layer provides increased corrosion protection to the substrate, compared to a same substrate not including the temporary protective layer.

Clause 17: The protected substrate of any of clauses 1-16, further comprising tape positioned between the first temporary protective sheet and the second temporary protective sheet.

Clause 18: The protected substrate of any of clauses 1-17, wherein the temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 19: The protected substrate of any of clauses 1-18, wherein the temporary protective layer comprises a thermoset resin system.

Clauses 20: The protected substrate of any of clauses 1-19, wherein the temporary protective layer is UV curable.

Clause 21: A protected substrate, comprising: a planar substrate comprising a surface; a first temporary protective sheet positioned over a first portion of the surface; a second temporary protective sheet positioned over a second portion of the surface, wherein a third portion of the surface is not covered by the first temporary protective sheet and wherein the third portion of the surface is not covered by the second temporary protective sheet; and a temporary protective layer over at least the third portion of the surface, wherein the temporary protective layer is positioned directly beneath the first and/or second protective sheet and is positioned between the substrate and the first and/or second temporary protective sheet.

Clause 22: The protected substrate of clause 21, further comprising a tape positioned over at least the third portion of the surface, a portion of the first temporary protective sheet and a portion of the second temporary protective sheet.

Clause 23: The protected substrate of clause 22, wherein a portion of the tape is positioned over at least a portion of the temporary protective layer.

Clause 24: The protected substrate of clause 23, wherein a gap is defined between the portion of the tape positioned over the portion of the temporary protective layer, and the portion of the temporary protective layer.

Clause 25: The protected substrate of any of clauses 21-24, wherein the temporary protective layer is removable by burning, vaporizing, removing using a solvent, or peeling.

Clause 26: The protected substrate of any of clauses 21-25, wherein the planar substrate comprises glass.

Clause 27: The protected substrate of any of clauses 21-26, wherein the planar substrate comprises metal or wood.

Clause 28: The protected substrate of any of clauses 21-27, further comprising a functional coating positioned over the surface and between the surface and the temporary protective layer.

Clause 29: The protected substrate of clause 28, wherein the functional coating comprises a low-E coating.

Clause 30: The protected substrate of any of clauses 21-29, wherein the temporary protective layer comprises a polyurethane layer, an epoxide layer, or a combination thereof.

Clause 31: The protected substrate of clause 30, wherein the polyurethane layer comprises an aqueous polyurethane, a polyurethane formed from a two component system, or a combination thereof.

Clause 32: The protected substrate of clauses 30-31, wherein the epoxide layer comprises an epoxy functional polymeric material.

Clause 33: The protected substrate of any of clauses 21-32, wherein the temporary protective layer comprises a thickness of at least 10 nm and at most 5,000 μm.

Clause 34: The protected substrate of any of clauses 21-33, wherein the first temporary protective sheet and/or the second temporary protective sheet is configured to be removed from the protected substrate, wherein removal of the first temporary protective sheet and/or the second temporary protective sheet from the protected substrate does not peel a majority of the temporary protective layer from the surface.

Clause 35: The protected substrate of any of clauses 21-34, wherein the temporary protective layer comprises a material having a melting point of at least 60° C.

Clause 36: The protected substrate of any of clauses 21-35, wherein the temporary protective layer comprises a hydrophobic material.

Clause 37: The protected substrate of any of clauses 21-36, wherein when the temporary protective layer contacts water, the temporary protective layer exhibits a water contact angle of at least 60°.

Clause 38: The protected substrate of any of clauses 21-37, wherein the temporary protective layer is water impermeable.

Clause 39: The protected substrate of any of clauses 21-38, wherein the temporary protective layer provides increased corrosion protection to the substrate, compared to the same substrate not including the temporary protective layer.

Clause 40: The protected substrate of any of clauses 21-39, wherein the temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 41: The protected substrate of any of clauses 21-40, wherein the temporary protective layer comprises a thermoset resin system.

Clauses 42: The protected substrate of any of clauses 21-41, wherein the temporary protective layer is UV curable.

Clause 43: A protected substrate, comprising: a planar substrate comprising a surface; a first portion of the surface over which a temporary protective layer is applied; a second portion of the surface over which a first temporary protective sheet is positioned; and a third portion of the surface over which a second temporary protective sheet is positioned, wherein the first portion is not covered by the first or second temporary protective sheets, wherein the temporary protective layer is positioned directly beneath the first and/or second protective sheet and is positioned between the substrate and the first and/or second temporary protective sheet, wherein the first temporary protective sheet does or does not overlap the second temporary protective sheet.

Clause 44: The protected substrate of clause 43, further comprising a tape positioned over at least the first portion of the surface, a portion of the first temporary protective sheet and a portion of the second temporary protective sheet.

Clause 45: The protected substrate of clause 44, wherein a portion of the tape is positioned over at least a portion of the temporary protective layer.

Clause 46: The protected substrate of clause 45, wherein a gap is defined between the portion of the tape positioned over the portion of the temporary protective layer, and the portion of the temporary protective layer.

Clause 47: The protected substrate of any of clauses 43-46, wherein the temporary protective layer is removable by burning, vaporizing, removing using a solvent, or peeling.

Clause 48: The protected substrate of any of clauses 43-47, wherein the planar substrate comprises glass.

Clause 49: The protected substrate of any of clauses 43-48, wherein the planar substrate comprises metal or wood.

Clause 50: The protected substrate of any of clauses 43-49, further comprising a functional coating positioned over the surface and between the surface and the temporary protective layer.

Clause 51: The protected substrate of clause 50, wherein the functional coating comprises a low-E coating.

Clause 52: The protected substrate of any of clauses 43-51, wherein the temporary protective layer comprises a polyurethane layer, an epoxide layer, or a combination thereof.

Clause 53: The protected substrate of clause 52, wherein the polyurethane layer comprises an aqueous polyurethane, a polyurethane formed from a two component system, or a combination thereof.

Clause 54: The protected substrate of clauses 52-53, wherein the epoxide layer comprises an epoxy functional polymeric material.

Clause 55: The protected substrate of any of clauses 43-54, wherein the temporary protective layer comprises a thickness of at least 10 nm and at most 5,000 μm.

Clause 56: The protected substrate of any of clauses 43-55, wherein the first temporary protective sheet and/or the second temporary protective sheet is configured to be removed from the protected substrate, wherein removal of the first temporary protective sheet and/or the second temporary protective sheet from the protected substrate does not peel a majority of the temporary protective layer from the surface.

Clause 57: The protected substrate of any of clauses 43-56, wherein the temporary protective layer comprises a material having a melting point of at least 60° C.

Clause 58: The protected substrate of any of clauses 43-57, wherein the temporary protective layer comprises a hydrophobic material.

Clause 59: The protected substrate of any of clauses 43-58, wherein when the temporary protective layer contacts water, the temporary protective layer exhibits a water contact angle of at least 60°.

Clause 60: The protected substrate of any of clauses 43-59, wherein the temporary protective layer is water impermeable.

Clause 61: The protected substrate of any of clauses 43-60, wherein the temporary protective layer provides increased corrosion protection to the substrate, compared to the same substrate not including the temporary protective layer.

Clause 62: The protected substrate of any of clauses 43-61, wherein the temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 63: The protected substrate of any of clauses 43-62, wherein the temporary protective layer comprises a thermoset resin system.

Clauses 64: The protected substrate of any of clauses 43-63, wherein the temporary protective layer is UV curable.

Clause 65: A protected substrate, comprising: a planar substrate comprising a surface; and a temporary protective layer positioned over at least a portion of the surface, wherein the temporary protective layer comprises a polyurethane layer, an epoxide layer, or a combination thereof.

Clause 66: The protected substrate of clause 65, wherein the temporary protective layer comprises a thickness of at least 10 nm and at most 5,000 μm.

Clause 67: The protected substrate of clause 65 or 66, wherein the planar substrate comprises glass.

Clause 68: The protected substrate of any of clauses 65-67, wherein the planar substrate comprises metal or wood.

Clause 69: The protected substrate of any of clauses 65-68, wherein the temporary protective layer comprises at least 40 wt. % carbon.

Clause 70: The protected substrate of any of clauses 65-69, wherein the protected substrate does not include a temporary protective sheet positioned over the surface.

Clause 71: The protected substrate of any of clauses 65-70, wherein the temporary protective layer is an outermost layer of the planar substrate.

Clause 72: The protected substrate of any of clauses 65-71, wherein the temporary protective layer is positioned over at least the entire surface.

Clause 73: The protected substrate of any of clauses 65-72, wherein the polyurethane layer comprises an aqueous polyurethane, a polyurethane formed from a two component system, or a combination thereof.

Clause 74: The protected substrate of any of clauses 65-73, wherein the epoxide layer comprises an epoxy functional polymeric material.

Clause 75: The protected substrate of any of clauses 65-74, wherein the temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 76: The protected substrate of any of clauses 65-75, wherein the temporary protective layer comprises a thermoset resin system.

Clauses 77: The protected substrate of any of clauses 65-76, wherein the temporary protective layer is UV curable.

Clause 78: A protected substrate, comprising: a planar substrate comprising a surface; a temporary protective layer positioned over at least a portion of the surface; a first temporary protective sheet positioned over at least a first portion of the surface; and a second temporary protective sheet positioned over at least a second portion the surface, wherein an overlapping portion of the second temporary protective sheet overlaps an overlapping portion of the first temporary protective sheet at an overlap; wherein a gap is defined by the overlap between the second temporary protective sheet and a portion of the surface, wherein a portion of the temporary protective layer is positioned between the second temporary protective sheet and the portion of the surface.

Clause 79: The protected substrate of clause 78, wherein the temporary protective layer is removable by burning, vaporizing, removing using a solvent, or peeling.

Clause 80: The protected substrate of clause 78 or 79, wherein the planar substrate comprises glass.

Clause 81: The protected substrate of any of clauses 78-80, further comprising a functional coating positioned over the surface and between the surface and the temporary protective layer.

Clause 82: The protected substrate of clause 81, wherein the functional coating comprises a low-E coating layer.

Clause 83: The protected substrate of any of clauses 78-82, wherein the temporary protective layer comprises a polyurethane layer, an epoxide layer, or a combination thereof.

Clause 84: The protected substrate of clause 83, wherein the polyurethane layer comprises an aqueous polyurethane, a polyurethane formed from a two component system, or a combination thereof.

Clause 85: The protected substrate of any of clauses 83-84, wherein the epoxide layer comprises an epoxy functional polymeric material.

Clause 86: The protected substrate of any of clauses 78-85, wherein the first temporary protective sheet and/or the second temporary protective sheet is configured to be removed from the protected substrate, wherein removal of the first temporary protective sheet and/or the second temporary protective sheet from the protected substrate does not peel a majority of the temporary protective layer from the surface.

Clause 87: The protected substrate of any of clauses 78-86, wherein the temporary protective layer comprises a material having a melting point of at least 60° C. and at most 600° C.

Clause 88: The protected substrate of any of clauses 78-87, wherein when the temporary protective layer contacts water, the temporary protective layer exhibits a water contact angle of at least 60°.

Clause 89: A protected substrate, comprising: a planar substrate comprising a surface; a first temporary protective sheet positioned over a first portion of the surface; a second temporary protective sheet positioned over a second portion of the surface, wherein a third portion of the surface is not covered by the first temporary protective sheet and wherein the third portion of the surface is not covered by the second temporary protective sheet; and a temporary protective layer over at least the third portion of the surface, wherein the temporary protective layer is positioned directly beneath the first and/or second protective sheet and is positioned between the substrate and the first and/or second temporary protective sheet.

Clause 90: The protected substrate of clause 89, further comprising a tape positioned over at least the third portion of the surface, a portion of the first temporary protective sheet and a portion of the second temporary protective sheet.

Clause 91: The protected substrate of clause 89 or 90, wherein the temporary protective layer is removable by burning, vaporizing, removing using a solvent, or peeling.

Clause 92: The protected substrate of any of clauses 89-91, wherein the planar substrate comprises glass.

Clause 93: The protected substrate of any of clauses 89-92, further comprising a coating positioned between the surface and the temporary protective layer.

Clause 94: The protected substrate of clause 93, wherein the coating comprises a low-E coating.

Clause 95: The protected substrate of any of clauses 89-94, wherein the temporary protective layer comprises a polyurethane layer, an epoxide layer, or a combination thereof.

Clause 96: The protected substrate of clause 95, wherein the polyurethane layer comprises an aqueous polyurethane, a polyurethane formed from a two component system, or a combination thereof.

Clause 97: The protected substrate of any of clauses 95-96, wherein the epoxide layer comprises an epoxy functional polymeric material.

Clause 98: The protected substrate of any of clauses 89-97, wherein the temporary protective layer comprises a material having a melting point of at least 60° C. and at most 600° C.

Clause 99: The protected substrate of any of clauses 1-98, wherein the temporary protective layer comprises a polyurethane layer formed from a coating composition comprising an aqueous polyurethane, a polyurethane formed from a two component system, or a combination thereof.

Clause 100: The protected substrate of any of clauses 1-99, wherein the temporary protective layer comprises a polyurethane layer formed from a coating composition comprising a polyurethane polymer.

Clause 101: The protected substrate of clause 100, wherein the polyurethane polymer comprises an oil-modified polyurethane polymer.

Clause 102: The protected substrate of any of clauses 99-101, wherein the polyurethane layer is formed from a coating composition comprising a polyurethane polymer formed from a mixture of reactants comprising at least one polyol; and a polyisocyanate.

Clause 103: The protected substrate of clause 102, wherein the at least one polyol comprises an oil polyol.

Clause 104: The protected substrate of clause 103, wherein the oil polyol is formed from a mixture of reactants comprising at least one unsaturated oil and/or fatty acid; and at least one polyol.

Clause 105: The protected substrate of clause 104, wherein the at least one unsaturated oil and/or fatty acid used to form the oil polyol comprises palm oil, soybean oil, sunflower seed oil, peanut oil, cottonseed oil, rapeseed oil, coconut oil, palm kernel oil, olive oil, corn oil, grape seed oil, hazelnut oil, linseed oil, sesame oil, avocado oil, hemp seed oil, tung oil, canola oil, safflower oil, tall oil, sunflower oil, poppyseed oil, perilla oil, walnut oil, castor oil, sardine oil, ricinoleic acid, eleostearic acid, linolenic acid, linoleic acid, palmitoleic acid, arachidonic acid, or a combination thereof.

Clause 106: The protected substrate of any of clauses 104-105, wherein the unsaturated oil and/or fatty acid has an iodine value in the range of from 70 to 250, such as in the range of from 80 to 225, such as in the range of from 90 to 210, such as in the range of from 100 to 200.

Clause 107: The protected substrate of any of clauses 104-106, wherein the mixture of reactants used to form the oil polyol comprises the unsaturated oil and/or fatty acid in an amount in the range of from 80 weight % to 97 weight %, such as in the range of from 85 weight % to 96 weight %, such as in the range of from 90 weight % to 95 weight %, based on the total solids weight of the mixture of reactants used to form the oil polyol.

Clause 108: The protected substrate of any of clauses 104-107, wherein the at least one polyol used to form the oil polyol comprises cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, ethylene glycol, or combinations thereof.

Clause 109: The protected substrate of any of clauses 104-108, wherein the at least one polyol used to form the oil polyol comprises at least two polyols, such as at least three polyols, such as at least four polyols.

Clause 110: The protected substrate of any of clauses 104-109, wherein the mixture of reactants used to form the oil polyol comprises the at least one polyol in an amount in the range of from 1 weight % to 25 weight %, such as in the range of from 2 weight % to 20 weight %, such as in the range of from 3 weight % to 15 weight %, such as in the range of from 5 weight % to 10 weight %, based on the total solids weight of the mixture of reactants used to form the oil polyol.

Clause 111: The protected substrate of any of clauses 104-110, wherein the mixture of reactants used to form the oil polyol further comprises a catalyst.

Clause 112: The protected substrate of clause 111, wherein the catalyst used to form the oil polyol comprises 1,5,7-triazabicyclo [4.4.0]dec-5-ene, zinc acetate, calcium naphthenate, zinc naphthenate, barium naphthenate, iron naphthenate lithium neodecanoate, or a combination thereof.

Clause 113: The protected substrate of any of clauses 111-112, wherein the mixture of reactants used to form the oil polyol comprises the catalyst in an amount in the range of from greater than 0 weight % to 2 weight %, such as in the range of from greater than 0 weight % to 1 weight %, such as in the range of from 0.01 weight % to 2 weight %, such as in the range of from 0.01 weight % to 1 weight %, based on the total solids weight of the mixture of reactants used to form the oil polyol.

Clause 114: The protected substrate of any of clauses 103-113, wherein the oil polyol comprises at least 3 hydroxyl groups, such as at least 4 hydroxyl groups, such as at least 5 hydroxyl groups, such as at least 10 hydroxyl groups, such as at least 15 hydroxyl groups, such as at least 20 hydroxyl groups.

Clause 115: The protected substrate of any of clauses 103-114, wherein the oil polyol comprises at least one ethylenically unsaturated group, such as at least two ethylenically unsaturated groups, such as at least three ethylenically unsaturated groups, such as at least 5 ethylenically unsaturated groups.

Clause 116: The protected substrate of any of clauses 103-115, wherein the oil polyol comprises no additional functional groups.

Clause 117: The protected substrate of any of clauses 103-116, wherein the oil polyol comprises a hydroxyl value in the range of from 70 KOH/mg to 250 KOH/mg, such as from 80 KOH/mg to 200 KOH/mg, such as from 90 KOH/mg to 180 KOH/mg, such as from 100 KOH/mg to 150 KOH/mg.

Clause 118: The protected substrate of any of clauses 103-117, wherein the mixture of reactants used to form the polyurethane polymer comprises the oil polyol in an amount in the range of from 30 weight % to 65 weight %, such as in the range of from 35 weight % to 60 weight %, such as in the range of from 40 weight % to 55 weight %, such as in the range of from 45 weight % to 50 weight %, based on the total solids weight of the mixture of reactants used to form the polyurethane polymer.

Clause 119: The protected substrate of any of clauses 102-118 wherein the at least one polyol used to form the polyurethane polymer comprises a polyester polyol.

Clause 120: The protected substrate of clause 119, wherein the polyester polyol is formed from a mixture of reactants comprising at least one polyol; and at least one polyacid.

Clause 121: The protected substrate of clause 120, wherein the at least one polyol used to form the polyester polyol comprises dimethyl carbonate, caprolactone, cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, and ethylene glycol, or a combinations thereof.

Clause 122: The protected substrate of any of clauses 120-121, wherein the at least one polyol used to form the polyester polyol comprises at least two polyols, such as at least three polyols, such as at least four polyols.

Clause 123: The protected substrate of any of clauses 120-122, wherein the mixture of reactants used to form the polyester polyol comprises the at least one polyol in an amount in the range of from 50 weight % to 80 weight %, or in the range of from 55 weight % to 80 weight %, or in the range of from 60 weight % to 78 weight %, or in the range of from 65 weight % to 75 weight %, based on the total solids weight of the mixture of reactants used to form the polyester polyol.

Clause 124: The protected substrate of any of clauses 120-123, wherein the at least one polyacid used to form the polyester polyol comprises oxalic acid, malonic acid, succinic acid, glutaric acid, adipic acid, maleic acid, fumaric acid, isophthalic acid, phthalic acid, trimellitic acid, maleic anhydride, phthalic anhydride, trimellitic anhydride, or a combinations thereof.

Clause 125: The protected substrate of any of clauses 120-124, wherein the mixture of reactants used to form the polyester polyol comprises the at least one polyacid in an amount in the range of from 20 weight % to 50 weight %, or in the range of from 20 weight % to 45 weight %, or in the range of from 23 weight % to 40 weight %, or in the range of from 25 weight % to 35 weight %, based on the total solids weight of the mixture of reactants used to form the polyester polyol.

Clause 126: The protected substrate of any of clauses 119-125, wherein the polyester polyol comprises an aliphatic polyester polyol.

Clause 127: The protected substrate of any of clauses 119-126, wherein the polyester polyol comprises a C₂-C₂₅ carbon chain, such as a C₅-C₂₀ carbon chain, such as a C₈-C₁₈ carbon chain, such as a C₁₀-C₁₄ carbon chain.

Clause 128: The protected substrate of any of clauses 119-127, wherein the polyester polyol comprises at least one ester linkage, such as at least two ester linkages, such as at least three ester linkages, such as at least four ester linkages, such as at least five ester linkages.

Clause 129: The protected substrate of any of clauses 119-128, wherein the polyester polyol comprises at least two hydroxyl groups, such as at least three hydroxyl groups, such as at least four hydroxyl groups, such as at least five hydroxyl groups, such as at least 10 hydroxyl groups, such as at least 15 hydroxyl groups, such as at least 20 hydroxyl groups.

Clause 130: The protected substrate of any of clauses 119-129, wherein the polyester polyol comprises no additional functional groups.

Clause 131: The protected substrate of any of clauses 119-130, wherein the polyester polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 132: The protected substrate of any of clauses 119-131, wherein the mixture of reactants used to form the polyurethane polymer comprises the polyester polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 133: The protected substrate of any of clauses 102-133, wherein the at least one polyol used to form the polyurethane polymer comprises a polyether polyol.

Clause 134: The protected substrate of clause 133, wherein the polyether polyol comprises an aliphatic polyether polyol.

Clause 135: The protected substrate of any of clauses 133-134, wherein the polyether polyol comprises an ethylene-based or propylene-based polyether polyol.

Clause 136: The protected substrate of any of clauses 133-135, wherein the polyether polyol comprises ethylene oxide, propylene oxide, tetrahydrofuran, neopentyl glycol, 1,6-hexanediol, 1,4-butane diol, 1,3-butylene glycol, 1,3-propane diol, dipropylene glycol, propylene glycol, diethylene glycol, ethylene glycol, or a combinations thereof.

Clause 137: The protected substrate of any of clauses 133-136, wherein the polyether polyol comprises at least one ether linkage, such as at least two ether linkages, such as at least two ether linkages, such as at least three ether linkages, such as at least four ether linkages, such as at least five ether linkages.

Clause 138: The protected substrate of any of clauses 133-137, wherein the polyether polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 139: The protected substrate of any of clauses 133-138, wherein the polyether polyol comprise no additional functional groups.

Clause 140: The protected substrate of any of clauses 133-139, wherein the polyether polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 141: The protected substrate of any of clauses 133-140, wherein the mixture of reactants used to form the polyurethane polyol comprise the polyether polyol in an amount in the range of from greater than 0 weight % to 15 weight %, such as in the range of from 0.1 weight % to 10 weight %, such as in the range of from 0.5 weight % to 8 weight %, such as in the range of from 1 weight % to 5 weight %, based on the total solids weight of the mixture of reactants used to form the polyurethane polymer.

Clause 142: The protected substrate of any of clauses 102-141, wherein the at least one polyol used to form the polyurethane polymer comprises an acid functional polyol.

Clause 143: The protected substrate of clause 142, wherein the acid functional polyol comprises an aliphatic acid functional polyol.

Clause 144: The protected substrate of any of clauses 142-143, wherein the acid functional polyol comprises 2,2-bis(hydroxymethyl)propionic acid, 2,2-bis(hydroxymethyl)butanoic acid, 2,3-dihydroxypropanoic acid, 2,2-dihydroxypropanedioic acid, 2,3-dihydroxylbutanedioic acid, or a combination thereof.

Clause 145: The protected substrate of any of clauses 142-144, wherein the acid functional polyol comprises at least one carboxylic acid group, such as at least two carboxylic acid groups, such as at least three carboxylic acid groups, such as at least four carboxylic acid groups, such as at least 5 carboxylic acid group.

Clause 146: The protected substrate of any of clauses 142-145, wherein the acid functional polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 147: The protected substrate of any of clauses 142-146, wherein the acid functional polyol comprises no additional functional groups.

Clause 148: The protected substrate of any of clauses 142-147, wherein the mixture of reactants used to form the polyurethane polymer comprises the acid functional polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 149: The protected substrate of any of clauses 102-148, wherein the polyisocyanate comprises an aliphatic polyisocyanate.

Clause 150: The protected substrate of any of clauses 102-149, wherein the polyisocyanate comprises a cycloaliphatic polyisocyanate.

Clause 151: The protected substrate of any of clauses 102-150, wherein the polyisocyanate comprises an aromatic polyisocyanate.

Clause 152: The protected substrate of any of clauses 102-151, wherein the polyisocyanate comprises meta-phenylene diisocyanate, para-phenylene diisocyanate, 2,6-toluene diisocyanate, 2,4-toluene diisocyanate, xylene diisocyanate, 4,4-biphenylene diisocyanate, 4,4-methylene diphenylisocyanate, 1,5-naphthylene diisocyanate, 1,4-tetramethylene diisocyanate, 11,6-hexamethylene diisocyanate, 2,2,4-trimethyl-1,6-diisocyanatohexane, 1,10-decamethylene diisocyanate, 1,4-cyclohexylene diisocyanate, 4,4-methylenebis(isocyanatocyclohexane), 1-isocyanato-3-isocyanatomethyl-3,5,5-trimethyl cyclohexane, or a combination thereof.

Clause 153: The protected substrate of any of clauses 102-152, wherein the polyisocyanate comprises a blocked polyisocyanate.

Clause 154: The protected substrate of clause 153, wherein the blocked polyisocyanate comprises an blocking agent; wherein the blocking agent comprises an amide, a phenol, a caprolactam, a uretdione, or a combination thereof.

Clause 155: The protected substrate of any of clauses 102-154, wherein the polyisocyanate comprises at least two isocyanate functional groups, such as at least three isocyanate functional groups, such as at least four isocyanate groups, such as at least 5 isocyanate groups.

Clause 156: The protected substrate of any of clauses 102-155, wherein the polyisocyanate comprises no additional functional groups.

Clause 157: The protected substrate of any of clauses 102-156, wherein the polyisocyanate has an isocyanate equivalent weight in the range of from 80 g/eq to 225 g/eq, such as in the range of from 90 g/eq to 200 g/eq, such as in the range of from 100 g/eq to 190 g/eq, such as in the range of from 110 g/eq to 175 g/eq.

Clause 158: The protected substrate of any of clauses 102-157, wherein the mixture of reactants used to form the polyurethane polymer comprises the polyisocyanate in an amount in the range of from 15 weight % to 55 weight %, such as in the range of from 20 weight % to 50 weight %, such as in the range of from 25 weight % to 45 weight %, such as in the range of from 30 weight % to 40 weight %, based on the total solids weight of the mixture of reactants used to form the polyurethane polymer.

Clause 159: The protected substrate of any of clauses 133-158, wherein the mixture of reactants used to form the polyurethane polymer comprises a ratio of the polyester polyol to the polyether polyol in the range of from 10:1 to 1:1, such as in the range of from 8:1 to 2:1, such as in the range of from 7:1 to 3:1, such as in the range of from 6:1 to 4:1.

Clause 160: The protected substrate of any of clauses 142-159, wherein the mixture of reactants used to form the polyurethane polymer comprises a ratio of the polyester polyol to the acid functional polyol in the range of from 2:1 to 1:2, such as in the range of from 1.75:1 to 1:1.5, such as in the range of from 1.5:1 to 1:1, such as in the range of from 1.4:1 to 1.2:1.

Clause 161: The protected substrate of any of clauses 103-160, wherein the mixture of reactants used to form the polyurethane polymer comprises a ratio of the oil polyol to the polyisocyanate in the range of from 2:1 to 1:1.25, such as in the range of from 1.75:1 to 1:1, such as in the range of from 1.5:1 to 1:1, such as in the range of from 1.3:1 to 1.2:1.

Clause 162: The protected substrate of any of clauses 100-161, wherein the polyurethane polymer comprises at least one urethane linkage, such as at least two urethane linkages, such as at least three urethane linkages, such as at least 5 urethane linkages, such as at least 10 urethane linkages, such as at least 20 urethane linkages.

Clause 163: The protected substrate of any of clauses 100-162, wherein the polyurethane polymer comprises at least one ester linkage, such as at least two ester linkages, such as at least three ester linkages, such as at least 5 ester linkages.

Clause 164: The protected substrate of any of clauses 100-163, wherein the polyurethane polymer comprises at least one ether linkage, such as at least two ether linkages, such as at least three ether linkages, such as at least 5 ether linkages.

Clause 165: The protected substrate of any of clauses 100-164, wherein the polyurethane polymer comprises at least one urea linkage, such as at least two urea linkages, such as at least three urea linkages, such as at least 5 urea linkages.

Clause 166: The protected substrate of any of clauses 100-165, wherein the polyurethane polymer comprises at least one ethylenically unsaturated group, such as at least two ethylenically unsaturated groups, such as at least three ethylenically unsaturated groups, such as at least 5 ethylenically unsaturated groups.

Clause 167: The protected substrate of clause 166, wherein the ethylenically unsaturated group is pendant from the backbone of the polyurethane polymer.

Clause 168: The protected substrate of any of clauses 166-167, wherein the ethylenically unsaturated group is provided on a C₅-C₃₀ carbon chain, such as on a C₈-C₂₅ carbon chain, such as on a C₁₀-C₂₀ carbon chain.

Clause 169: The protected substrate of any of clauses 100-168, wherein the polyurethane polymer comprises at least one carboxylic acid group, such as at least two carboxylic acid groups, such as at least three carboxylic acid groups, such as at least 5 carboxylic acid groups

Clause 170: The protected substrate of clause 169, wherein the carboxylic acid group is pendant from the backbone of the polyurethane polymer.

Clause 171: The protected substrate of any of clauses 169-170, wherein the carboxylic acid functional group is provided on a C₂-C₁₀ carbon chain, such as a C₂-C₈ carbon chain, such as a C₂-C₅ carbon chain, such as a C₂-C₃ carbon chain.

Clause 172: The protected substrate of any of clauses 100-171, wherein the polyurethane polymer has a weight average molecular weight in the range of from 5,000 g/mol to 60,000 g/mol, such as in the range of from 10,000 g/mol to 50,000 g/mol, such as in the range of from 15,000 g/mol to 45,000 g/mol, such as in the range of from 20,000 g/mol to 40,000 g/mol.

Clause 173: The protected substrate of any of clauses 4-75, wherein the polyurethane polymer has a glass transition temperature in the range of from −30° C. to 20° C., such as in the range of from −20° C. to 10° C., such as in the range of from −10° C. to 0° C.

Clause 174: The protected substrate of any of clauses 100-173, wherein the polyurethane polymer has a viscosity in the range of from 15 cps to 225 cps, such as in the range of from 20 cps to 200 cps, such as in the range of from 25 cps to 175 cps.

Clause 175: The protected substrate of any of clauses 100-174, wherein the polyurethane polymer has an acid value in the range of from greater than 0 KOH/mg to 45 KOH/mg, such as in the range of from 1 KOH/mg to 40 KOH/mg, such as in the range of from 3 KOH/mg to 35 KOH/mg, such as in the range of from 5 KOH/mg to 30 KOH/mg.

Clause 176: The protected substrate of any of clauses 100-175, wherein the polyurethane polymer comprises at least 3, such as at least 4, such as at least 5, such as at least 6, such as at least 7, such as at least 8 different hydrocarbon chains in the backbone of the polyurethane polymer.

Clause 177: The protected substrate of any of clauses 100-176, wherein the polyurethane polymer comprise a C₅ or greater, such as a C₈ or greater, such as a C₁₀ or greater, such as a C₁₅ or greater, such as a C₂₀ or greater hydrocarbon chain.

Clause 178: The protected substrate of any of clauses 100-177, wherein the polyurethane polymer is a copolymer.

Clause 179: The protected substrate of any of clauses 100-178, wherein the polyurethane polymer is formed via step-growth polymerization.

Clause 180: The protected substrate of any of clauses 100-179, wherein the polyurethane polymer is formed via condensation polymerization.

Clause 181: The protected substrate of any of clauses 100-180, wherein the coating composition comprises a polyurethane dispersion comprising the polyurethane polymer.

Clause 182: The protected substrate of clause 181, wherein the polyurethane dispersion comprises the polyurethane polymer in an amount in the range of from 15 weight % to 50 weight %, such as in the range of from 25 weight % to 45 weight %, such as in the range of from 30 weight % to 40 weight %, such as in the range of from 30 weight % to 35 weight %, based on the total weight of the polyurethane dispersion.

Clause 183: The protected substrate of any of clauses 181-182, wherein the polyurethane dispersion further comprises a neutralizing amine.

Clause 184: The protected substrate of clause 183, wherein the neutralizing amine comprises ammonium hydroxide, dimethylamine, trimethylamine, triethyleamine, monoethanolamine, diisopropanolamine, diethanolamine, dimethylethanolamine, or a combination thereof.

Clause 185: The protected substrate of any of clauses 183-184, wherein the polyurethane dispersion comprises the neutralizing amine in an amount in the range of from greater than 0 weight % to 10 weight %, such as in the range of from 0.1 weight % to 8 weight %, such as in the range of from 0.5 weight % to 5 weight %, such as in the range of from 1 weight % to 2 weight %, based on the total weight of the polyurethane dispersion.

Clause 186: The protected substrate of any of clauses 183-185, wherein the polyurethane dispersion further comprises a chain extender.

Clause 187: The protected substrate of clause 186, wherein the chain extender comprises an amine chain extender.

Clause 188: The protected substrate of clause 187, wherein the amine chain extender comprises an aliphatic amine chain extender.

Clause 189: The protected substrate of any of clauses 187-188, wherein the amine chain extender comprises 4,4-diaminodicyclohexylmethane, 4,4-diamino-3,3-dimethyldicyclohexylmethane, 1,4-bis((2-amino-2-yl)-cyclohexane, 3,3-dimethyl-4,4-diaminodicyclohexylmethane, 1,3-diaminohexane, 1,4-diaminohexane, diethylene triamine, dipropylene triamine, hydrazine, ethylene diamine, 1-2-diamino propane, 1,3-diaminopropane, 1,6-diaminopropane, 1,3-diamino-2,2-dimethylpropane, isophorone diamine, triethylene tetramine, tripropylene tetramine, tetraethylene pentamine, or a combination thereof.

Clause 190: The protected substrate of any of clauses 187-189, wherein the amine chain extender comprises an amine value in the range of from 1,000 KOH/mg to 2,500 KOH/mg, such as in the range of from 1,100 KOH/mg to 2,300 KOH/mg, such as in the range of from 1,200 KOH/mg to 2,100 KOH/mg, such as in the range of from 1,300 KOH/mg to 1,900 KOH/mg.

Clause 191: The protected substrate of any of clauses 187-190, wherein the amine chain extender comprises at least two amine groups, such as at least three amine groups, such as at least four amine groups, such as at least 5 amine groups.

Clause 192: The protected substrate of any of clauses 187-191, wherein the amine chain extender comprises up to 10 amine groups, such as up to 8 amine groups, such as up to 6 amine groups.

Clause 193: The protected substrate of any of clauses 187-192, wherein the polyurethane dispersion comprises the amine chain extender in an amount in the range of from greater than 0 weight % to 3 weight %, such as in the range of from greater than 0 weight % to 2 weight %, such as in the range of from greater than 0 weight % to 1 weight %, based on the total weight of the polyurethane dispersion.

Clause 194: The protected substrate of any of clauses 181-193, wherein the polyurethane dispersion further comprises water.

Clause 195: The protected substrate of clause 194, wherein the polyurethane dispersion comprises water in an amount in the range of from 53 weight % to 75 weight %, such as in the range of from 55 weight % to 70 weight %, such as in the range of from 60 weight % to 65 weight %, based on the total weight of the polyurethane dispersion.

Clause 196: The protected substrate of any of clauses 99-195, wherein the coating composition further comprises an epoxide.

Clause 197: The protected substrate of any of clauses 99-196, wherein the coating composition further comprises a wax, an organic oil, a polyolefin, a poly(meth)acrylate, a polyester, an alkene, a polyethylene, a polypropylene, an emulsion thereof, or some combination thereof.

Clause 198: The protected substrate of any of clauses 99-197, wherein the coating composition further comprises polylactic acid (PLA), polyethylene carbonate (PEC), polypropylene carbonate (PPC), polycaprolactone, polyoxymethylene, polyethylene, polypropylene, or some combination thereof. The wax may include stearic acid, paraffin, carnauba, microcrystalline wax, polyethylene wax, or some combination thereof.

Clause 199: The protected substrate of any of clauses 99-198, wherein the coating composition is dispersed in an aqueous medium.

Clause 200: The protected substrate of clause 199, wherein the aqueous medium comprises water in an amount in the range of from 50 weight % to 80 weight %, such as in the range of from 50 weight % to 75 weight %, such as in the range of from 50 weight % to 70 weight %, such as in the range of from 55 weight % to 70 weight %, such as in the range of from 60 weight % to 70 weight %, such as in the range of from 60 weight % to 65 weight %, based on the total liquid weight of said medium.

Clause 201: The protected substrate of any of clauses 199-200, wherein the aqueous medium comprises a solvent in an amount of from greater than 0 weight % to 50 weight %, such as in the range of from 0.5 weight % to 25 weight %, such as in the range of from 0.5 weight % to 15 weight %, such as in the range of from 1 weight % to 10 weight %, such as in the range of from 1 weight % to 5 weight %, based on the total liquid weight of said medium.

Clause 202: The protected substrate of clause 201, wherein the solvent comprises a glycol, an alcohol, a glycol ether alcohol, a volatile ketone, a glycol di ether, an ester, an amine, a diester, an aromatic hydrocarbon, an aliphatic hydrocarbon, a pyrrolidone, or a combination thereof.

Clause 203: The protected substrate of any of clauses 99-202, wherein the coating composition comprises a one-component coating composition.

Clause 204: The protected substrate of any of clauses 99-203, wherein the coating composition comprises a two-component coating composition.

Clause 205: The protected substrate of any of clauses 99-204, wherein the coating composition further comprises a plasticizer.

Clause 206: The protected substrate of clause 205, wherein the plasticizer comprises an oil, a wax, a glycol, or a combination thereof.

Clause 207: The protected substrate of clause 206, wherein the plasticizer comprises cotton seed oil, epoxidized soybean oil, canola oil, carnauba wax, paraffin wax, microcrystalline wax, polyethylene glycol, and polypropylene glycol, and combination thereof.

Clause 208: The protected substrate of any of clauses 205-207, wherein the coating composition comprises the plasticizer in an amount in the range of from 1 weight % to 50 weight %, such as in the range of from 4 weight % to 40 weight %, such as in the range of from 110 weight % to 30 weight %, based on the total components of the coating composition.

Clause 209: The protected substrate of any of clauses 99-208, wherein the coating composition further comprises a viscosity modifier.

Clause 210: The protected substrate of clause 209, wherein the coating composition comprises the viscosity modifier in an amount in the range of from 0.05 weight % to 20 weight %, or 0.1 weight % to 15 weight %, or 0.1 weight % to 10 weight %, based on the total components of the coating composition.

Clause 211: The protected substrate of any of clauses 99-210, wherein the coating composition further comprises a hydrophobic agent.

Clause 212: The protected substrate of clause 211, wherein the coating composition comprise the hydrophobic agent in an amount in the range of from 0.5 weight % to 70 weight %, such as in the range of from 1 weight % to 65 weight %, such as in the range of from 1 weight % to 60 weight %, a based on the total components of the coating composition.

Clause 213: The protected substrate of any of clauses 99-212, wherein the coating composition further comprises a crosslinker.

Clause 214: The protected substrate of clause 213, wherein the crosslinker comprises a polyaziridine, a polycarbodiimide, an epoxy silane, a melamine, a polyisocyanate, or a combination thereof.

Clause 215: The protected substrate of any of clauses 213-214, wherein the crosslinker comprises a polyaziridine.

Clause 216: The protected substrate of any of clauses 213-215, wherein the crosslinker comprises trimethylolpropane tris(2-methyl-1-aziridinepropionate).

Clause 217: The protected substrate of any of clauses 213-216, wherein the coating composition comprises the crosslinker in an amount in the range of from 0.05 weight % to 30 weight %, such as 0.1 weight % to 20 weight %, such as 0.1 weight % to 10 weight %, based on the total components of the coating composition.

Clause 218: The protected substrate of any of clauses 99-217, wherein the coating composition comprises a dual cure coating composition.

Clause 219: A method for protecting a substrate, comprising: providing a planar substrate comprising a surface; applying a material to form a temporary protective layer over at least a first portion of the surface; adhering a first temporary protective sheet over a second portion of the surface, wherein a portion of the first temporary protective sheet overlaps a first portion of the temporary protective layer; and adhering a second temporary protective sheet over a second portion of the temporary protective layer and over a third portion of the surface, wherein an overlap is formed between the first temporary protective sheet and the second temporary protective sheet, and wherein a gap is defined by the overlap between the second temporary protective sheet and the surface.

Clause 220: The method of clause 219, wherein the material is applied over the at least a first portion of the surface by spray coating, curtain coating, powder coating, brush coating, roll coating, inkjet printing, or some combination thereof.

Clause 221: The method of clause 219 or 220, wherein the material is an emulsion comprising a hydrophobic material, water, and a surfactant.

Clause 222: The method of clause 221, wherein the surfactant is non-ionic.

Clause 223: The method of any of clauses 219-221, further comprising heating the material to a temperature to form a molten liquid prior to application of the material.

Clause 224: The method of clause 223, wherein the material is a thermoplastic or a thermoset.

Clause 225: The method of clause 223 or 224, wherein the material is applied to the first portion of the surface at a temperature above a melting point of the material.

Clause 226: The method of any of clauses 223-225, wherein the molten liquid is applied to the first portion of the surface by bubbling a gas through the molten liquid.

Clause 227: The method of clause 226, wherein the gas comprises an inert gas.

Clause 228: The method of any of clauses 219-227, wherein the material comprises a hydrophobic material dissolved in a solvent.

Clause 229: The method of any of clauses 219-228, wherein the material comprises a UV curable or heat curable material, wherein the applied material is exposed to a UV source or heat to crosslink the applied material.

Clause 230: The method of any of clauses 219-229, wherein the material comprises a two component resin, wherein the components of the resin react to crosslink the resin upon application of the material.

Clause 231: The method of any of clauses 219-230, further comprising removing the temporary protective layer by burning, vaporizing, removing using a solvent, or peeling.

Clause 232: The method of any of clauses 219-231, wherein the planar substrate comprises glass.

Clause 233: The method of any of clauses 219-232, wherein the planar substrate comprises metal or wood.

Clause 234: The method of any of clauses 219-233, wherein the planar substrate comprises a functional coating positioned over the surface and between the surface and the temporary protective layer.

Clause 235: The method of clause 234, wherein the functional coating comprises a low-E coating.

Clause 236: The method of any of clauses 219-235, wherein the temporary protective layer comprises a polyurethane layer, an epoxide layer, or a combination thereof.

Clause 237: The method of clause 236, wherein the polyurethane layer comprises an aqueous polyurethane, a polyurethane formed from a two component system, or a combination thereof.

Clause 238: The method of clauses 236-237, wherein the epoxide layer comprises an epoxy functional polymeric material.

Clause 239: The method of any of clauses 219-238, wherein the material is applied such that the formed temporary protective layer comprises a thickness of at least 10 nm and at most 5,000 μm.

Clause 240: The method of any of clauses 219-239, wherein the first temporary protective sheet and/or the second temporary protective sheet is configured to be removed from the protected substrate, wherein removal of the first temporary protective sheet and/or the second temporary protective sheet from the protected substrate does not peel a majority of the temporary protective layer from the surface.

Clause 241: The method of any of clauses 219-240, wherein the material comprises a melting point of at least 60° C.

Clause 242: The method of any of clauses 219-241 wherein the material comprises a hydrophobic material.

Clause 243: The method of any of clauses 219-242, wherein the temporary protective layer is water impermeable.

Clause 244: The method of any of clauses 219-243, wherein the temporary protective layer provides increased corrosion protection to the substrate, compared to the same substrate not including the temporary protective layer.

Clause 245: The method of any of clauses 219-244, further comprising applying a tape over a portion of the first temporary protective sheet and the second temporary protective sheet.

Clause 246: The method of any of clauses 219-245, wherein the temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 247: The method of any of clauses 219-246, wherein the temporary protective layer comprises a thermoset resin system.

Clauses 248: The method of any of clauses 219-247, wherein the temporary protective layer is UV curable.

Clause 249: A method for protecting a substrate, comprising: providing a planar substrate comprising a surface; applying a material to form a temporary protective layer over at least a first portion of the surface; adhering a first temporary protective sheet over a second portion of the surface; and adhering a second temporary protective sheet over a third portion of the surface wherein a space is formed between the first temporary protective sheet and the second temporary protective sheet, wherein the space is over the first portion of the surface, and wherein the temporary protective layer is positioned directly beneath the first and/or second protective sheet and is positioned between the substrate and the first and/or second temporary protective sheet.

Clause 250: The method of clause 249, further comprising applying tape to over the first portion of the surface, over a portion of the first temporary protective sheet, and over a portion of the second temporary protective sheet.

Clause 251: The method of clause 250, wherein the tape is positioned over the temporary protective layer.

Clause 252: The method of clause 251, wherein a gap is defined between a portion of the tape and a portion of the temporary protective layer.

Clause 253: The method of any of clauses 249-252, wherein the material is applied over the at least a first portion of the surface by spray coating, curtain coating, powder coating, brush coating, roll coating, inkjet printing, or some combination thereof.

Clause 254: The method of any of clauses 249-253, wherein the material is an emulsion comprising a hydrophobic material, water, and a surfactant.

Clause 255: The method of clause 254, wherein the surfactant is non-ionic.

Clause 256: The method of any of clauses 249-255, further comprising heating the material to a temperature to form a molten liquid prior to application of the material.

Clause 257: The method of clause 256, wherein the material is a thermoplastic or a thermoset.

Clause 258: The method of clause 256 or 257, wherein the material is applied to the first portion of the surface at a temperature above a melting point of the material.

Clause 259: The method of any of clauses 256-258, wherein the molten liquid is applied to the first portion of the surface by bubbling a gas through the molten liquid.

Clause 260: The method of clause 259, wherein the gas comprises an inert gas.

Clause 261: The method of any of clauses 249-260, wherein the material comprises a hydrophobic material dissolved in a solvent.

Clause 262: The method of any of clauses 249-261, wherein the material comprises a UV curable or heat curable material, wherein the applied material is exposed to a UV source or heat to crosslink the applied material.

Clause 263: The method of any of clauses 249-262, wherein the material comprises a two component resin, wherein the components of the resin react to crosslink the resin upon application of the material.

Clause 264: The method of any of clauses 249-263, further comprising removing the temporary protective layer by burning, vaporizing, removing using a solvent, or peeling.

Clause 265: The method of any of clauses 249-264, wherein the planar substrate comprises glass.

Clause 266: The method of any of clauses 249-265, wherein the planar substrate comprises metal or wood.

Clause 267: The method of any of clauses 249-266, wherein the planar substrate comprises a functional coating positioned over the surface and between the surface and the temporary protective layer.

Clause 268: The method of clause 267, wherein the functional coating comprises a low-E coating.

Clause 270: The method of any of clauses 249-268, wherein the temporary protective layer comprises a polyurethane layer, an epoxide layer, or a combination thereof.

Clause 271: The method of clause 270, wherein the polyurethane layer comprises an aqueous polyurethane, a polyurethane formed from a two component system, or a combination thereof.

Clause 272: The method of clauses 270-271, wherein the epoxide layer comprises an epoxy functional polymeric material.

Clause 273: The method of any of clauses 249-272, wherein the material is applied such that the formed temporary protective layer comprises a thickness of at least 10 nm and at most 5,000 μm.

Clause 274: The method of any of clauses 249-273, wherein the first temporary protective sheet and/or the second temporary protective sheet is configured to be removed from the protected substrate, wherein removal of the first temporary protective sheet and/or the second temporary protective sheet from the protected substrate does not peel a majority of the temporary protective layer from the surface.

Clause 275: The method of any of clauses 249-274, wherein the material comprises a melting point of at least 60° C.

Clause 276: The method of any of clauses 249-275, wherein the material comprises a hydrophobic material.

Clause 277: The method of any of clauses 249-276, wherein the temporary protective layer is water impermeable.

Clause 278: The method of any of clauses 249-277, wherein the temporary protective layer provides increased corrosion protection to the substrate, compared to the same substrate not including the temporary protective layer.

Clause 279: The method of any of clauses 249-278, wherein the temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 280: The method of any of clauses 249-279, wherein the temporary protective layer comprises a thermoset resin system.

Clause 281: The method of any of clauses 249-280, wherein the temporary protective layer is UV curable.

Clause 282: A method for protecting a substrate, comprising: providing a planar substrate comprising a surface; applying a material to form a temporary protective layer over at least a first portion of the surface; adhering a first temporary protective sheet over a second portion of the surface, wherein a portion of the first temporary protective sheet overlaps a first portion of the temporary protective layer; and adhering a second temporary protective sheet over a second portion of the temporary protective layer and over a third portion of the surface, wherein an overlap is formed between the first temporary protective sheet and the second temporary protective sheet, and wherein a gap is defined by the overlap between the second temporary protective sheet and the surface.

Clause 283: A method of removing a temporary protective layer from a coated substrate comprising: providing a protected substrate, comprising: a planar substrate comprising a surface; a temporary protective layer positioned over at least a portion of the surface; a first temporary protective sheet positioned over at least a first portion of the surface; and a second temporary protective sheet positioned over at least a second portion the surface, wherein an overlapping portion of the second temporary protective sheet overlaps an overlapping portion of the first temporary protective sheet at an overlap; wherein a gap is defined by the overlap between the second temporary protective sheet and a portion of the surface, wherein a portion of the temporary protective layer is positioned between the second temporary protective sheet and the portion of the surface; removing the first temporary protective sheet and/or the temporary protective sheet by peeling; and removing the temporary protective layer from the surface by burning, vaporizing, removing using a solvent, or peeling the temporary protective layer to form an unprotected substrate.

Clause 284: The method of clause 283, wherein the protected substrate is heated to a temperature of up to 1000° C. to remove the temporary protective layer from the surface.

Clause 285: The protected substrate of any of clauses 219-284, wherein the temporary protective layer comprises a polyurethane layer formed from a coating composition comprising an aqueous polyurethane, a polyurethane formed from a two component system, or a combination thereof.

Clause 286: The method of clause 285, wherein the temporary protective layer comprises a polyurethane layer formed from a coating composition comprising a polyurethane polymer.

Clause 287: The method of clause 286, wherein the polyurethane polymer comprises an oil-modified polyurethane polymer.

Clause 288: The method of any of clauses 285-287, wherein the polyurethane layer is formed from a coating composition comprising a polyurethane polymer formed from a mixture of reactants comprising at least one polyol; and a polyisocyanate.

Clause 289: The method of clause 288, wherein the at least one polyol comprises an oil polyol.

Clause 290: The method of clause 289, wherein the oil polyol is formed from a mixture of reactants comprising at least one unsaturated oil and/or fatty acid; and at least one polyol.

Clause 291: The method of clause 290, wherein the at least one unsaturated oil and/or fatty acid used to form the oil polyol comprises palm oil, soybean oil, sunflower seed oil, peanut oil, cottonseed oil, rapeseed oil, coconut oil, palm kernel oil, olive oil, corn oil, grape seed oil, hazelnut oil, linseed oil, sesame oil, avocado oil, hemp seed oil, tung oil, canola oil, safflower oil, tall oil, sunflower oil, poppyseed oil, perilla oil, walnut oil, castor oil, sardine oil, ricinoleic acid, eleostearic acid, linolenic acid, linoleic acid, palmitoleic acid, arachidonic acid, or a combination thereof.

Clause 292: The method of any of clauses 290-291, wherein the unsaturated oil and/or fatty acid has an iodine value in the range of from 70 to 250, such as in the range of from 80 to 225, such as in the range of from 90 to 210, such as in the range of from 100 to 200.

Clause 293: The method of any of clauses 289-292, wherein the mixture of reactants used to form the oil polyol comprises the unsaturated oil and/or fatty acid in an amount in the range of from 80 weight % to 97 weight %, such as in the range of from 85 weight % to 96 weight %, such as in the range of from 90 weight % to 95 weight %, based on the total solids weight of the mixture of reactants used to form the oil polyol.

Clause 294: The method of any of clauses 289-293, wherein the at least one polyol used to form the oil polyol comprises cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, ethylene glycol, or combinations thereof.

Clause 295: The method of any of clauses 289-294, wherein the at least one polyol used to form the oil polyol comprises at least two polyols, such as at least three polyols, such as at least four polyols.

Clause 296: The method of any of clauses 289-295, wherein the mixture of reactants used to form the oil polyol comprises the at least one polyol in an amount in the range of from 1 weight % to 25 weight %, such as in the range of from 2 weight % to 20 weight %, such as in the range of from 3 weight % to 15 weight %, such as in the range of from 5 weight % to 10 weight %, based on the total solids weight of the mixture of reactants used to form the oil polyol.

Clause 297: The method of any of clauses 289-296, wherein the mixture of reactants used to form the oil polyol further comprises a catalyst.

Clause 298: The method of clause 297, wherein the catalyst used to form the oil polyol comprises 1,5,7-triazabicyclo [4.4.0]dec-5-ene, zinc acetate, calcium naphthenate, zinc naphthenate, barium naphthenate, iron naphthenate lithium neodecanoate, or a combination thereof.

Clause 299: The method of any of clauses 297-298, wherein the mixture of reactants used to form the oil polyol comprises the catalyst in an amount in the range of from greater than 0 weight % to 2 weight %, such as in the range of from greater than 0 weight % to 1 weight %, such as in the range of from 0.01 weight % to 2 weight %, such as in the range of from 0.01 weight % to 1 weight %, based on the total solids weight of the mixture of reactants used to form the oil polyol.

Clause 300: The method of any of clauses 289-299, wherein the oil polyol comprises at least 3 hydroxyl groups, such as at least 4 hydroxyl groups, such as at least 5 hydroxyl groups, such as at least 10 hydroxyl groups, such as at least 15 hydroxyl groups, such as at least 20 hydroxyl groups.

Clause 301: The method of any of clauses 289-300, wherein the oil polyol comprises at least one ethylenically unsaturated group, such as at least two ethylenically unsaturated groups, such as at least three ethylenically unsaturated groups, such as at least 5 ethylenically unsaturated groups.

Clause 302: The method of any of clauses 289-301, wherein the oil polyol comprises no additional functional groups.

Clause 303: The method of any of clauses 289-302, wherein the oil polyol comprises a hydroxyl value in the range of from 70 KOH/mg to 250 KOH/mg, such as from 80 KOH/mg to 200 KOH/mg, such as from 90 KOH/mg to 180 KOH/mg, such as from 100 KOH/mg to 150 KOH/mg.

Clause 304: The method of any of clauses 289-303, wherein the mixture of reactants used to form the polyurethane polymer comprises the oil polyol in an amount in the range of from 30 weight % to 65 weight %, such as in the range of from 35 weight % to 60 weight %, such as in the range of from 40 weight % to 55 weight %, such as in the range of from 45 weight % to 50 weight %, based on the total solids weight of the mixture of reactants used to form the polyurethane polymer.

Clause 305: The method of any of clauses 288-304 wherein the at least one polyol used to form the polyurethane polymer comprises a polyester polyol.

Clause 306: The method of clause 305, wherein the polyester polyol is formed from a mixture of reactants comprising at least one polyol; and at least one polyacid.

Clause 307: The method of clause 306, wherein the at least one polyol used to form the polyester polyol comprises dimethyl carbonate, caprolactone, cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, and ethylene glycol, or a combinations thereof.

Clause 308: The method of any of clauses 306-307, wherein the at least one polyol used to form the polyester polyol comprises at least two polyols, such as at least three polyols, such as at least four polyols.

Clause 309: The method of any of clauses 306-308, wherein the mixture of reactants used to form the polyester polyol comprises the at least one polyol in an amount in the range of from 50 weight % to 80 weight %, or in the range of from 55 weight % to 80 weight %, or in the range of from 60 weight % to 78 weight %, or in the range of from 65 weight % to 75 weight %, based on the total solids weight of the mixture of reactants used to form the polyester polyol.

Clause 310: The method of any of clauses 306-309, wherein the at least one polyacid used to form the polyester polyol comprises oxalic acid, malonic acid, succinic acid, glutaric acid, adipic acid, maleic acid, fumaric acid, isophthalic acid, phthalic acid, trimellitic acid, maleic anhydride, phthalic anhydride, trimellitic anhydride, or a combinations thereof.

Clause 311: The method of any of clauses 306-310 wherein the mixture of reactants used to form the polyester polyol comprises the at least one polyacid in an amount in the range of from 20 weight % to 50 weight %, or in the range of from 20 weight % to 45 weight %, or in the range of from 23 weight % to 40 weight %, or in the range of from 25 weight % to 35 weight %, based on the total solids weight of the mixture of reactants used to form the polyester polyol.

Clause 312: The method of any of clauses 305-311, wherein the polyester polyol comprises an aliphatic polyester polyol.

Clause 313: The method of any of clauses 305-312, wherein the polyester polyol comprises a C₂-C₂₅ carbon chain, such as a C₅-C₂₀ carbon chain, such as a C₈-C₁₈ carbon chain, such as a C₁₀-C₁₄ carbon chain.

Clause 314: The method of any of clauses 305-313, wherein the polyester polyol comprises at least one ester linkage, such as at least two ester linkages, such as at least three ester linkages, such as at least four ester linkages, such as at least five ester linkages.

Clause 315: The method of any of clauses 305-314, wherein the polyester polyol comprises at least two hydroxyl groups, such as at least three hydroxyl groups, such as at least four hydroxyl groups, such as at least five hydroxyl groups, such as at least 10 hydroxyl groups, such as at least 15 hydroxyl groups, such as at least 20 hydroxyl groups.

Clause 316: The method of any of clauses 305-315, wherein the polyester polyol comprises no additional functional groups.

Clause 317: The method of any of clauses 305-316, wherein the polyester polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 318: The method of any of clauses 305-317, wherein the mixture of reactants used to form the polyurethane polymer comprises the polyester polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 319: The method of any of clauses 288-318, wherein the at least one polyol used to form the polyurethane polymer comprises a polyether polyol.

Clause 320: The method of clause 319, wherein the polyether polyol comprises an aliphatic polyether polyol.

Clause 321: The method of any of clauses 319-320, wherein the polyether polyol comprises an ethylene-based or propylene-based polyether polyol.

Clause 322: The method of any of clauses 319-321, wherein the polyether polyol comprises ethylene oxide, propylene oxide, tetrahydrofuran, neopentyl glycol, 1,6-hexanediol, 1,4-butane diol, 1,3-butylene glycol, 1,3-propane diol, dipropylene glycol, propylene glycol, diethylene glycol, ethylene glycol, or a combinations thereof.

Clause 323: The method of any of clauses 319-322, wherein the polyether polyol comprises at least one ether linkage, such as at least two ether linkages, such as at least two ether linkages, such as at least three ether linkages, such as at least four ether linkages, such as at least five ether linkages.

Clause 324: The method of any of clauses 319-323, wherein the polyether polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 325: The method of any of clauses 319-324, wherein the polyether polyol comprise no additional functional groups.

Clause 326: The method of any of clauses 319-325, wherein the polyether polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 327: The method of any of clauses 319-326, wherein the mixture of reactants used to form the polyurethane polyol comprise the polyether polyol in an amount in the range of from greater than 0 weight % to 15 weight %, such as in the range of from 0.1 weight % to 10 weight %, such as in the range of from 0.5 weight % to 8 weight %, such as in the range of from 1 weight % to 5 weight %, based on the total solids weight of the mixture of reactants used to form the polyurethane polymer.

Clause 328: The method of any of clauses 288-328, wherein the at least one polyol used to form the polyurethane polymer comprises an acid functional polyol.

Clause 329: The method of clause 328, wherein the acid functional polyol comprises an aliphatic acid functional polyol.

Clause 330: The method of any of clauses 328-329, wherein the acid functional polyol comprises 2,2-bis(hydroxymethyl)propionic acid, 2,2-bis(hydroxymethyl)butanoic acid, 2,3-dihydroxypropanoic acid, 2,2-dihydroxypropanedioic acid, 2,3-dihydroxylbutanedioic acid, or a combination thereof.

Clause 331: The method of any of clauses 328-330, wherein the acid functional polyol comprises at least one carboxylic acid group, such as at least two carboxylic acid groups, such as at least three carboxylic acid groups, such as at least four carboxylic acid groups, such as at least 5 carboxylic acid group.

Clause 332: The method of any of clauses 328-331, wherein the acid functional polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 333: The method of any of clauses 328-332, wherein the acid functional polyol comprises no additional functional groups.

Clause 334: The method of any of clauses 328-333 wherein the mixture of reactants used to form the polyurethane polymer comprises the acid functional polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 335: The method of any of clauses 288-334, wherein the polyisocyanate comprises an aliphatic polyisocyanate.

Clause 336: The method of any of clauses 288-335, wherein the polyisocyanate comprises a cycloaliphatic polyisocyanate.

Clause 337: The method of any of clauses 288-336, wherein the polyisocyanate comprises an aromatic polyisocyanate.

Clause 338: The method of any of clauses 288-337, wherein the polyisocyanate comprises meta-phenylene diisocyanate, para-phenylene diisocyanate, 2,6-toluene diisocyanate, 2,4-toluene diisocyanate, xylene diisocyanate, 4,4-biphenylene diisocyanate, 4,4-methylene diphenylisocyanate, 1,5-naphthylene diisocyanate, 1,4-tetramethylene diisocyanate, 11,6-hexamethylene diisocyanate, 2,2,4-trimethyl-1,6-diisocyanatohexane, 1,10-decamethylene diisocyanate, 1,4-cyclohexylene diisocyanate, 4,4-methylenebis(isocyanatocyclohexane), 1-isocyanato-3-isocyanatomethyl-3,5,5-trimethyl cyclohexane, or a combination thereof.

Clause 339: The method of any of clauses 288-338, wherein the polyisocyanate comprises a blocked polyisocyanate.

Clause 340: The method of clause 339, wherein the blocked polyisocyanate comprises a blocking agent; wherein the blocking agent comprises an amide, a phenol, a caprolactam, a uretdione, or a combination thereof.

Clause 341: The method of any of clauses 288-340, wherein the polyisocyanate comprises at least two isocyanate functional groups, such as at least three isocyanate functional groups, such as at least four isocyanate groups, such as at least 5 isocyanate groups.

Clause 342: The method of any of clauses 288-341, wherein the polyisocyanate comprises no additional functional groups.

Clause 343: The method of any of clauses 288-342 wherein the polyisocyanate has an isocyanate equivalent weight in the range of from 80 g/eq to 225 g/eq, such as in the range of from 90 g/eq to 200 g/eq, such as in the range of from 100 g/eq to 190 g/eq, such as in the range of from 110 g/eq to 175 g/eq.

Clause 344: The method of any of clauses 288-343, wherein the mixture of reactants used to form the polyurethane polymer comprises the polyisocyanate in an amount in the range of from 15 weight % to 55 weight %, such as in the range of from 20 weight % to 50 weight %, such as in the range of from 25 weight % to 45 weight %, such as in the range of from 30 weight % to 40 weight %, based on the total solids weight of the mixture of reactants used to form the polyurethane polymer.

Clause 345: The method of any of clauses 319-344, wherein the mixture of reactants used to form the polyurethane polymer comprises a ratio of the polyester polyol to the polyether polyol in the range of from 10:1 to 1:1, such as in the range of from 8:1 to 2:1, such as in the range of from 7:1 to 3:1, such as in the range of from 6:1 to 4:1.

Clause 346: The method of any of clauses 328-345, wherein the mixture of reactants used to form the polyurethane polymer comprises a ratio of the polyester polyol to the acid functional polyol in the range of from 2:1 to 1:2, such as in the range of from 1.75:1 to 1:1.5, such as in the range of from 1.5:1 to 1:1, such as in the range of from 1.4:1 to 1.2:1.

Clause 347: The method of any of clauses 289-346, wherein the mixture of reactants used to form the polyurethane polymer comprises a ratio of the oil polyol to the polyisocyanate in the range of from 2:1 to 1:1.25, such as in the range of from 1.75:1 to 1:1, such as in the range of from 1.5:1 to 1:1, such as in the range of from 1.3:1 to 1.2:1.

Clause 348: The method of any of clauses 286-347, wherein the polyurethane polymer comprises at least one urethane linkage, such as at least two urethane linkages, such as at least three urethane linkages, such as at least 5 urethane linkages, such as at least 10 urethane linkages, such as at least 20 urethane linkages.

Clause 349: The method of any of clauses 286-348, wherein the polyurethane polymer comprises at least one ester linkage, such as at least two ester linkages, such as at least three ester linkages, such as at least 5 ester linkages.

Clause 350: The method of any of clauses 286-349, wherein the polyurethane polymer comprises at least one ether linkage, such as at least two ether linkages, such as at least three ether linkages, such as at least 5 ether linkages.

Clause 351: The method of any of clauses 286-350, wherein the polyurethane polymer comprises at least one urea linkage, such as at least two urea linkages, such as at least three urea linkages, such as at least 5 urea linkages.

Clause 352: The method of any of clauses 286-351, wherein the polyurethane polymer comprises at least one ethylenically unsaturated group, such as at least two ethylenically unsaturated groups, such as at least three ethylenically unsaturated groups, such as at least 5 ethylenically unsaturated groups.

Clause 353: The method of clause 352, wherein the ethylenically unsaturated group is pendant from the backbone of the polyurethane polymer.

Clause 354: The method of any of clauses 352-353, wherein the ethylenically unsaturated group is provided on a C₅-C₃₀ carbon chain, such as on a C₈-C₂₅ carbon chain, such as on a C₁₀-C₂₀ carbon chain.

Clause 355: The method of any of clauses 286-354, wherein the polyurethane polymer comprises at least one carboxylic acid group, such as at least two carboxylic acid groups, such as at least three carboxylic acid groups, such as at least 5 carboxylic acid groups

Clause 356: The method of clause 355, wherein the carboxylic acid group is pendant from the backbone of the polyurethane polymer.

Clause 357: The method of any of clauses 355-356, wherein the carboxylic acid functional group is provided on a C₂-C₁₀ carbon chain, such as a C₂-C₈ carbon chain, such as a C₂-C₅ carbon chain, such as a C₂-C₃ carbon chain.

Clause 358: The method of any of clauses 286-357, wherein the polyurethane polymer has a weight average molecular weight in the range of from 5,000 g/mol to 60,000 g/mol, such as in the range of from 10,000 g/mol to 50,000 g/mol, such as in the range of from 15,000 g/mol to 45,000 g/mol, such as in the range of from 20,000 g/mol to 40,000 g/mol.

Clause 360: The method of any of clauses 286-358, wherein the polyurethane polymer has a glass transition temperature in the range of from −30° C. to 20° C., such as in the range of from −20° C. to 10° C., such as in the range of from −10° C. to 0° C.

Clause 361: The method of any of clauses 286-360, wherein the polyurethane polymer has a viscosity in the range of from 15 cps to 225 cps, such as in the range of from 20 cps to 200 cps, such as in the range of from 25 cps to 175 cps.

Clause 362: The method of any of clauses 286-361, wherein the polyurethane polymer has an acid value in the range of from greater than 0 KOH/mg to 45 KOH/mg, such as in the range of from 1 KOH/mg to 40 KOH/mg, such as in the range of from 3 KOH/mg to 35 KOH/mg, such as in the range of from 5 KOH/mg to 30 KOH/mg.

Clause 363: The method of any of clauses 286-362, wherein the polyurethane polymer comprises at least 3, such as at least 4, such as at least 5, such as at least 6, such as at least 7, such as at least 8 different hydrocarbon chains in the backbone of the polyurethane polymer.

Clause 364: The method of any of clauses 286-363, wherein the polyurethane polymer comprise a C₅ or greater, such as a C₈ or greater, such as a C₁₀ or greater, such as a C₁₅ or greater, such as a C₂₀ or greater hydrocarbon chain.

Clause 365: The method of any of clauses 286-364, wherein the polyurethane polymer is a copolymer.

Clause 366: The method of any of clauses 286-365, wherein the polyurethane polymer is formed via step-growth polymerization.

Clause 367: The method of any of clauses 286-366, wherein the polyurethane polymer is formed via condensation polymerization.

Clause 368: The method of any of clauses 286-367, wherein the coating composition comprises a polyurethane dispersion comprising the polyurethane polymer.

Clause 369: The method of clause 368, wherein the polyurethane dispersion comprises the polyurethane polymer in an amount in the range of from 15 weight % to 50 weight %, such as in the range of from 25 weight % to 45 weight %, such as in the range of from 30 weight % to 40 weight %, such as in the range of from 30 weight % to 35 weight %, based on the total weight of the polyurethane dispersion.

Clause 370: The method of any of clauses 368-369, wherein the polyurethane dispersion further comprises a neutralizing amine.

Clause 371: The method of clause 370, wherein the neutralizing amine comprises ammonium hydroxide, dimethylamine, trimethylamine, triethyleamine, monoethanolamine, diisopropanolamine, diethanolamine, dimethylethanolamine, or a combination thereof.

Clause 372: The method of any of clauses 370-371, wherein the polyurethane dispersion comprises the neutralizing amine in an amount in the range of from greater than 0 weight % to 10 weight %, such as in the range of from 0.1 weight % to 8 weight %, such as in the range of from 0.5 weight % to 5 weight %, such as in the range of from 1 weight % to 2 weight %, based on the total weight of the polyurethane dispersion.

Clause 373: The method of any of clauses 368-372, wherein the polyurethane dispersion further comprises a chain extender.

Clause 374: The method of clause 373, wherein the chain extender comprises an amine chain extender.

Clause 375: The method of clause 374, wherein the amine chain extender comprises an aliphatic amine chain extender.

Clause 376: The method of any of clauses 374-375, wherein the amine chain extender comprises 4,4-diaminodicyclohexylmethane, 4,4-diamino-3,3-dimethyldicyclohexylmethane, 1,4-bis((2-amino-2-yl)-cyclohexane, 3,3-dimethyl-4,4-diaminodicyclohexylmethane, 1,3-diaminohexane, 1,4-diaminohexane, diethylene triamine, dipropylene triamine, hydrazine, ethylene diamine, 1-2-diamino propane, 1,3-diaminopropane, 1,6-diaminopropane, 1,3-diamino-2,2-dimethylpropane, isophorone diamine, triethylene tetramine, tripropylene tetramine, tetraethylene pentamine, or a combination thereof.

Clause 377: The method of any of clauses 375-376, wherein the amine chain extender comprises an amine value in the range of from 1,000 KOH/mg to 2,500 KOH/mg, such as in the range of from 1,100 KOH/mg to 2,300 KOH/mg, such as in the range of from 1,200 KOH/mg to 2,100 KOH/mg, such as in the range of from 1,300 KOH/mg to 1,900 KOH/mg.

Clause 378: The method of any of clauses 375-377, wherein the amine chain extender comprises at least two amine groups, such as at least three amine groups, such as at least four amine groups, such as at least 5 amine groups.

Clause 379: The method of any of clauses 375-378, wherein the amine chain extender comprises up to 10 amine groups, such as up to 8 amine groups, such as up to 6 amine groups.

Clause 380: The method of any of clauses 375-379, wherein the polyurethane dispersion comprises the amine chain extender in an amount in the range of from greater than 0 weight % to 3 weight %, such as in the range of from greater than 0 weight % to 2 weight %, such as in the range of from greater than 0 weight % to 1 weight %, based on the total weight of the polyurethane dispersion.

Clause 381: The method of any of clauses 368-380, wherein the polyurethane dispersion further comprises water.

Clause 382: The method of clause 381, wherein the polyurethane dispersion comprises water in an amount in the range of from 53 weight % to 75 weight %, such as in the range of from 55 weight % to 70 weight %, such as in the range of from 60 weight % to 65 weight %, based on the total weight of the polyurethane dispersion.

Clause 383: The method of any of clauses 285-382, wherein the coating composition further comprises an epoxide.

Clause 384: The method of any of clauses 285-383, wherein the coating composition further comprises a wax, an organic oil, a polyolefin, a poly(meth)acrylate, a polyester, an alkene, a polyethylene, a polypropylene, an emulsion thereof, or some combination thereof.

Clause 385: The method of any of clauses 285-384, wherein the coating composition further comprises polylactic acid (PLA), polyethylene carbonate (PEC), polypropylene carbonate (PPC), polycaprolactone, polyoxymethylene, polyethylene, polypropylene, or some combination thereof. The wax may include stearic acid, paraffin, carnauba, microcrystalline wax, polyethylene wax, or some combination thereof.

Clause 386: The method of any of clauses 285-385, wherein the coating composition is dispersed in an aqueous medium.

Clause 387: The method of clause 386, wherein the aqueous medium comprises water in an amount in the range of from 50 weight % to 80 weight %, such as in the range of from 50 weight % to 75 weight %, such as in the range of from 50 weight % to 70 weight %, such as in the range of from 55 weight % to 70 weight %, such as in the range of from 60 weight % to 70 weight %, such as in the range of from 60 weight % to 65 weight %, based on the total liquid weight of said medium.

Clause 388: The method of any of clauses 386-387, wherein the aqueous medium comprises a solvent in an amount of from greater than 0 weight % to 50 weight %, such as in the range of from 0.5 weight % to 25 weight %, such as in the range of from 0.5 weight % to 15 weight %, such as in the range of from 1 weight % to 10 weight %, such as in the range of from 1 weight % to 5 weight %, based on the total liquid weight of said medium.

Clause 389: The method of clause 388, wherein the solvent comprises a glycol, an alcohol, a glycol ether alcohol, a volatile ketone, a glycol di ether, an ester, an amine, a diester, an aromatic hydrocarbon, an aliphatic hydrocarbon, a pyrrolidone, or a combination thereof.

Clause 390: The method of any of clauses 285-389, wherein the coating composition comprises a one-component coating composition.

Clause 391: The method of any of clauses 285-390, wherein the coating composition comprises a two-component coating composition.

Clause 392: The method of any of clauses 285-391, wherein the coating composition further comprises a plasticizer.

Clause 393: The method of clause 392, wherein the plasticizer comprises an oil, a wax, a glycol, or a combination thereof.

Clause 394: The method of any of clauses 392-393, wherein the plasticizer comprises cotton seed oil, epoxidized soybean oil, canola oil, carnauba wax, paraffin wax, microcrystalline wax, polyethylene glycol, and polypropylene glycol, and combination thereof.

Clause 395: The method of any of clauses 392-394, wherein the coating composition comprises the plasticizer in an amount in the range of from 1 weight % to 50 weight %, such as in the range of from 4 weight % to 40 weight %, such as in the range of from 110 weight % to 30 weight %, based on the total components of the coating composition.

Clause 396: The method of any of clauses 285-395, wherein the coating composition further comprises a viscosity modifier.

Clause 397: The method of clause 396, wherein the coating composition comprises the viscosity modifier in an amount in the range of from 0.05 weight % to 20 weight %, or 0.1 weight % to 15 weight %, or 0.1 weight % to 10 weight %, based on the total components of the coating composition.

Clause 398: The method of any of clauses 285-397, wherein the coating composition further comprises a hydrophobic agent.

Clause 399: The method of clause 398, wherein the coating composition comprise the hydrophobic agent in an amount in the range of from 0.5 weight % to 70 weight %, such as in the range of from 1 weight % to 65 weight %, such as in the range of from 1 weight % to 60 weight %, a based on the total components of the coating composition.

Clause 400: The method of any of clauses 285-399, wherein the coating composition further comprises a crosslinker.

Clause 401: The method of clause 400, wherein the crosslinker comprises a polyaziridine, a polycarbodiimide, an epoxy silane, a melamine, a polyisocyanate, or a combination thereof.

Clause 402: The method of any of clauses 400-401, wherein the crosslinker comprises a polyaziridine.

Clause 403: The method of any of clauses 400-402, wherein the crosslinker comprises trimethylolpropane tris(2-methyl-1-aziridinepropionate).

Clause 404: The method of any of clauses 400-403, wherein the coating composition comprises the crosslinker in an amount in the range of from 0.05 weight % to 30 weight %, such as 0.1 weight % to 20 weight %, such as 0.1 weight % to 10 weight %, based on the total components of the coating composition.

Clause 405: The method of any of clauses 285-404, wherein the coating composition comprises a dual cure coating composition.

Clause 406: A protected substrate, comprising: a planar substrate comprising a surface; and a burn-off temporary protective layer positioned over at least a portion of the surface, wherein the burn-off temporary protective layer comprises a polyurethane layer, an epoxide layer, or some combination thereof, wherein the burn-off temporary protective layer is removable by a heat treatment process that does not substantially damage the surface.

Clause 407: The protected substrate of clause 406, wherein the burn-off temporary protective layer comprises a polyurethane layer comprising an aqueous polyurethane and/or a polyurethane formed from a two component system, an epoxide layer comprising an epoxy functional polymeric material, or a combination thereof.

Clause 408: The protected substrate of clause 406 or 407, wherein the burn-off temporary protective layer comprises a thickness of at least 10 nm and at most 5,000 μm.

Clause 409: The protected substrate of any of clauses 406-408, wherein the planar substrate comprises glass.

Clause 410: The protected substrate of any of clauses 406-409, wherein the protected substrate does not include a temporary protective sheet positioned over the surface.

Clause 411: The protected substrate of any of clauses 406-410, wherein the burn-off temporary protective layer is an outermost layer of the planar substrate.

Clause 412: The protected substrate of any of clauses 406-411, wherein the burn-off temporary protective layer is positioned over the entire surface and at least a portion of an edge of the substrate.

Clause 413: The protected substrate of any of clauses 406-412, wherein the burn-off temporary protective layer is removable by burning at a temperature of at most 1000° C.

Clause 414: The protected substrate of any of clauses 406-413, wherein the heat treatment process burning comprises burning the burn-off temporary protective layer without substantial damage of the surface.

Clause 415: The protected substrate of any of clauses 406-414, wherein the heat treatment process does not cause the surface to have a color change (DECMC) of more than 3 units compared to a color of an identical substrate without the burn-off temporary protective layer after the heat treatment process.

Clause 416: The protected substrate of any of clauses 406-415, further comprising a functional coating positioned between the surface and the burn-off temporary protective layer.

Clause 417: The protected substrate of clause 416, wherein the functional coating comprises a low-E coating layer.

Clause 418: The protected substrate of any of clauses 406-417, wherein the burn-off temporary protective layer comprises a material having a melting point of at least 60° C. and at most 600° C.

Clause 419: The protected substrate of any of clauses 406-418, wherein the polyurethane layer comprises an aqueous polyurethane, a polyurethane formed from a two component system, or a combination thereof.

Clause 420: The protected substrate of any of clauses 406-419, wherein the epoxide layer comprises an epoxy functional polymeric material.

Clause 421: The protected substrate of any of clauses 406-420, wherein the burn-off temporary protective layer further comprises additional components including plasticizers, crosslinkers, viscosity modifiers, corrosion inhibitors, infrared (IR) absorbers, adhesion modifiers, UV absorbers, pigments, surfactants, hydrophobic agents, or a combination thereof.

Clause 422: The protected substrate of any of clauses 406-421, wherein the burn-off temporary protective layer comprises a thermoset resin system.

Clause 423: The protected substrate of any of clauses 406-422, wherein the burn-off temporary protective layer is UV curable.

Clause 424: A protected substrate, comprising: a planar substrate comprising a surface; and a burn-off temporary protective layer positioned over at least a portion of the surface, wherein the burn-off temporary protective layer comprises a polyurethane layer, an epoxide layer, or a combination thereof, wherein the burn-off temporary protective layer is removable by a heat treatment process that does not substantially damage the surface.

Clause 425: The protected substrate of clause 424, wherein the polyurethane layer comprises an aqueous polyurethane, a polyurethane formed from a two component system, or a combination thereof.

Clause 426: The protected substrate of any of clauses 424-425, wherein the epoxide layer comprises an epoxy functional polymeric material.

Clause 427: The protected substrate of any of clauses 424-426, wherein the burn-off temporary protective layer comprises a protective film.

Clause 428: The protected substrate of any one of clauses 406-427, wherein the burn-off temporary protective layer comprises a polyurethane layer formed from a coating composition comprising an aqueous polyurethane, a polyurethane formed from a two component system, or a combination thereof.

Clause 429: The protected substrate of any of clauses 406-428, wherein the burn-off temporary protective layer comprises a polyurethane layer formed from a coating composition comprising a polyurethane polymer.

Clause 430: The protected substrate of clause 429, wherein the polyurethane polymer comprises an oil-modified polyurethane polymer.

Clause 431: The protected substrate of any of clauses 428-430, wherein the polyurethane layer is formed from a coating composition comprising a polyurethane polymer formed from a mixture of reactants comprising at least one polyol; and a polyisocyanate.

Clause 432: The protected substrate of clause 431, wherein the at least one polyol comprises an oil polyol.

Clause 433: The protected substrate of clause 432, wherein the oil polyol is formed from a mixture of reactants comprising at least one unsaturated oil and/or fatty acid; and at least one polyol.

Clause 434: The protected substrate of clause 433, wherein the at least one unsaturated oil and/or fatty acid used to form the oil polyol comprises palm oil, soybean oil, sunflower seed oil, peanut oil, cottonseed oil, rapeseed oil, coconut oil, palm kernel oil, olive oil, corn oil, grape seed oil, hazelnut oil, linseed oil, sesame oil, avocado oil, hemp seed oil, tung oil, canola oil, safflower oil, tall oil, sunflower oil, poppyseed oil, perilla oil, walnut oil, castor oil, sardine oil, ricinoleic acid, eleostearic acid, linolenic acid, linoleic acid, palmitoleic acid, arachidonic acid, or a combination thereof.

Clause 435: The protected substrate of any of clauses 433-434, wherein the unsaturated oil and/or fatty acid has an iodine value in the range of from 70 to 250, such as in the range of from 80 to 225, such as in the range of from 90 to 210, such as in the range of from 100 to 200.

Clause 436: The protected substrate of any of clauses 433-435, wherein the mixture of reactants used to form the oil polyol comprises the unsaturated oil and/or fatty acid in an amount in the range of from 80 weight % to 97 weight %, such as in the range of from 85 weight % to 96 weight %, such as in the range of from 90 weight % to 95 weight %, based on the total solids weight of the mixture of reactants used to form the oil polyol.

Clause 437: The protected substrate of any of clauses 433-436, wherein the at least one polyol used to form the oil polyol comprises cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, ethylene glycol, or combinations thereof.

Clause 438: The protected substrate of any of clauses 433-437, wherein the at least one polyol used to form the oil polyol comprises at least two polyols, such as at least three polyols, such as at least four polyols.

Clause 439: The protected substrate of any of clauses 433-438, wherein the mixture of reactants used to form the oil polyol comprises the at least one polyol in an amount in the range of from 1 weight % to 25 weight %, such as in the range of from 2 weight % to 20 weight %, such as in the range of from 3 weight % to 15 weight %, such as in the range of from 5 weight % to 10 weight %, based on the total solids weight of the mixture of reactants used to form the oil polyol.

Clause 440: The protected substrate of any of clauses 433-439, wherein the mixture of reactants used to form the oil polyol further comprises a catalyst.

Clause 441: The protected substrate of clause 440, wherein the catalyst used to form the oil polyol comprises 1,5,7-triazabicyclo [4.4.0]dec-5-ene, zinc acetate, calcium naphthenate, zinc naphthenate, barium naphthenate, iron naphthenate lithium neodecanoate, or a combination thereof.

Clause 442: The protected substrate of any of clauses 440-441, wherein the mixture of reactants used to form the oil polyol comprises the catalyst in an amount in the range of from greater than 0 weight % to 2 weight %, such as in the range of from greater than 0 weight % to 1 weight %, such as in the range of from 0.01 weight % to 2 weight %, such as in the range of from 0.01 weight % to 1 weight %, based on the total solids weight of the mixture of reactants used to form the oil polyol.

Clause 443: The protected substrate of any of clauses 432-442, wherein the oil polyol comprises at least 3 hydroxyl groups, such as at least 4 hydroxyl groups, such as at least 5 hydroxyl groups, such as at least 10 hydroxyl groups, such as at least 15 hydroxyl groups, such as at least 20 hydroxyl groups.

Clause 444: The protected substrate of any of clauses 432-443, wherein the oil polyol comprises at least one ethylenically unsaturated group, such as at least two ethylenically unsaturated groups, such as at least three ethylenically unsaturated groups, such as at least 5 ethylenically unsaturated groups.

Clause 445: The protected substrate of any of clauses 432-444, wherein the oil polyol comprises no additional functional groups.

Clause 446: The protected substrate of any of clauses 432-445, wherein the oil polyol comprises a hydroxyl value in the range of from 70 KOH/mg to 250 KOH/mg, such as from 80 KOH/mg to 200 KOH/mg, such as from 90 KOH/mg to 180 KOH/mg, such as from 100 KOH/mg to 150 KOH/mg.

Clause 447: The protected substrate of any of clauses 432-446, wherein the mixture of reactants used to form the polyurethane polymer comprises the oil polyol in an amount in the range of from 30 weight % to 65 weight %, such as in the range of from 35 weight % to 60 weight %, such as in the range of from 40 weight % to 55 weight %, such as in the range of from 45 weight % to 50 weight %, based on the total solids weight of the mixture of reactants used to form the polyurethane polymer.

Clause 448: The protected substrate of any of clauses 431-447 wherein the at least one polyol used to form the polyurethane polymer comprises a polyester polyol.

Clause 449: The protected substrate of clause 448, wherein the polyester polyol is formed from a mixture of reactants comprising at least one polyol; and at least one polyacid.

Clause 450: The protected substrate of clause 449, wherein the at least one polyol used to form the polyester polyol comprises dimethyl carbonate, caprolactone, cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, and ethylene glycol, or a combinations thereof.

Clause 451: The protected substrate of any of clauses 449-450, wherein the at least one polyol used to form the polyester polyol comprises at least two polyols, such as at least three polyols, such as at least four polyols.

Clause 452: The protected substrate of any of clauses 449-451, wherein the mixture of reactants used to form the polyester polyol comprises the at least one polyol in an amount in the range of from 50 weight % to 80 weight %, or in the range of from 55 weight % to 80 weight %, or in the range of from 60 weight % to 78 weight %, or in the range of from 65 weight % to 75 weight %, based on the total solids weight of the mixture of reactants used to form the polyester polyol.

Clause 453: The protected substrate of any of clauses 449-452, wherein the at least one polyacid used to form the polyester polyol comprises oxalic acid, malonic acid, succinic acid, glutaric acid, adipic acid, maleic acid, fumaric acid, isophthalic acid, phthalic acid, trimellitic acid, maleic anhydride, phthalic anhydride, trimellitic anhydride, or a combinations thereof.

Clause 454: The protected substrate of any of clauses 449-453 wherein the mixture of reactants used to form the polyester polyol comprises the at least one polyacid in an amount in the range of from 20 weight % to 50 weight %, or in the range of from 20 weight % to 45 weight %, or in the range of from 23 weight % to 40 weight %, or in the range of from 25 weight % to 35 weight %, based on the total solids weight of the mixture of reactants used to form the polyester polyol.

Clause 455: The protected substrate of any of clauses 449-454, wherein the polyester polyol comprises an aliphatic polyester polyol.

Clause 456: The protected substrate of any of clauses 449-455, wherein the polyester polyol comprises a C₂-C₂₅ carbon chain, such as a C₅-C₂₀ carbon chain, such as a C₈-C₁₈ carbon chain, such as a C₁₀-C₁₄ carbon chain.

Clause 457: The protected substrate of any of clauses 449-456, wherein the polyester polyol comprises at least one ester linkage, such as at least two ester linkages, such as at least three ester linkages, such as at least four ester linkages, such as at least five ester linkages.

Clause 458: The protected substrate of any of clauses 449-457, wherein the polyester polyol comprises at least two hydroxyl groups, such as at least three hydroxyl groups, such as at least four hydroxyl groups, such as at least five hydroxyl groups, such as at least 10 hydroxyl groups, such as at least 15 hydroxyl groups, such as at least 20 hydroxyl groups.

Clause 459: The protected substrate of any of clauses 449-458, wherein the polyester polyol comprises no additional functional groups.

Clause 460: The protected substrate of any of clauses 449-459, wherein the polyester polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 461: The protected substrate of any of clauses 449-460, wherein the mixture of reactants used to form the polyurethane polymer comprises the polyester polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 462: The protected substrate of any of clauses 431-461, wherein the at least one polyol used to form the polyurethane polymer comprises a polyether polyol.

Clause 463: The protected substrate of clause 462, wherein the polyether polyol comprises an aliphatic polyether polyol.

Clause 464: The protected substrate of any of clauses 462-463, wherein the polyether polyol comprises an ethylene-based or propylene-based polyether polyol.

Clause 465: The protected substrate of any of clauses 462-464, wherein the polyether polyol comprises ethylene oxide, propylene oxide, tetrahydrofuran, neopentyl glycol, 1,6-hexanediol, 1,4-butane diol, 1,3-butylene glycol, 1,3-propane diol, dipropylene glycol, propylene glycol, diethylene glycol, ethylene glycol, or a combinations thereof.

Clause 466: The protected substrate of any of clauses 462-465, wherein the polyether polyol comprises at least one ether linkage, such as at least two ether linkages, such as at least two ether linkages, such as at least three ether linkages, such as at least four ether linkages, such as at least five ether linkages.

Clause 467: The protected substrate of any of clauses 462-466, wherein the polyether polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 468: The protected substrate of any of clauses 462-467, wherein the polyether polyol comprise no additional functional groups.

Clause 469: The protected substrate of any of clauses 462-468, wherein the polyether polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 470: The protected substrate of any of clauses 462-469, wherein the mixture of reactants used to form the polyurethane polyol comprise the polyether polyol in an amount in the range of from greater than 0 weight % to 15 weight %, such as in the range of from 0.1 weight % to 10 weight %, such as in the range of from 0.5 weight % to 8 weight %, such as in the range of from 1 weight % to 5 weight %, based on the total solids weight of the mixture of reactants used to form the polyurethane polymer.

Clause 471: The protected substrate of any of clauses 431-470, wherein the at least one polyol used to form the polyurethane polymer comprises an acid functional polyol.

Clause 472: The protected substrate of clause 471, wherein the acid functional polyol comprises an aliphatic acid functional polyol.

Clause 473: The protected substrate of any of clauses 471-472, wherein the acid functional polyol comprises 2,2-bis(hydroxymethyl)propionic acid, 2,2-bis(hydroxymethyl)butanoic acid, 2,3-dihydroxypropanoic acid, 2,2-dihydroxypropanedioic acid, 2,3-dihydroxylbutanedioic acid, or a combination thereof.

Clause 474: The protected substrate of any of clauses 471-473, wherein the acid functional polyol comprises at least one carboxylic acid group, such as at least two carboxylic acid groups, such as at least three carboxylic acid groups, such as at least four carboxylic acid groups, such as at least 5 carboxylic acid group.

Clause 475: The protected substrate of any of clauses 471-474, wherein the acid functional polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 476: The protected substrate of any of clauses 471-475, wherein the acid functional polyol comprises no additional functional groups.

Clause 477: The protected substrate of any of clauses 471-476, wherein the mixture of reactants used to form the polyurethane polymer comprises the acid functional polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 478: The protected substrate of any of clauses 431-477, wherein the polyisocyanate comprises an aliphatic polyisocyanate.

Clause 479: The protected substrate of any of clauses 431-478, wherein the polyisocyanate comprises a cycloaliphatic polyisocyanate.

Clause 480: The protected substrate of any of clauses 431-479, wherein the polyisocyanate comprises an aromatic polyisocyanate.

Clause 481: The protected substrate of any of clauses 431-480, wherein the polyisocyanate comprises meta-phenylene diisocyanate, para-phenylene diisocyanate, 2,6-toluene diisocyanate, 2,4-toluene diisocyanate, xylene diisocyanate, 4,4-biphenylene diisocyanate, 4,4-methylene diphenylisocyanate, 1,5-naphthylene diisocyanate, 1,4-tetramethylene diisocyanate, 11,6-hexamethylene diisocyanate, 2,2,4-trimethyl-1,6-diisocyanatohexane, 1,10-decamethylene diisocyanate, 1,4-cyclohexylene diisocyanate, 4,4-methylenebis(isocyanatocyclohexane), 1-isocyanato-3-isocyanatomethyl-3,5,5-trimethyl cyclohexane, or a combination thereof.

Clause 482: The protected substrate of any of clauses 431-481, wherein the polyisocyanate comprises a blocked polyisocyanate.

Clause 483: The protected substrate of clause 482, wherein the blocked polyisocyanate comprises an blocking agent; wherein the blocking agent comprises an amide, a phenol, a caprolactam, a uretdione, or a combination thereof.

Clause 484: The protected substrate of any of clauses 431-483, wherein the polyisocyanate comprises at least two isocyanate functional groups, such as at least three isocyanate functional groups, such as at least four isocyanate groups, such as at least 5 isocyanate groups.

Clause 485: The protected substrate of any of clauses 431-484, wherein the polyisocyanate comprises no additional functional groups.

Clause 486: The protected substrate of any of clauses 431-485, wherein the polyisocyanate has an isocyanate equivalent weight in the range of from 80 g/eq to 225 g/eq, such as in the range of from 90 g/eq to 200 g/eq, such as in the range of from 100 g/eq to 190 g/eq, such as in the range of from 110 g/eq to 175 g/eq.

Clause 487: The protected substrate of any of clauses 431-486, wherein the mixture of reactants used to form the polyurethane polymer comprises the polyisocyanate in an amount in the range of from 15 weight % to 55 weight %, such as in the range of from 20 weight % to 50 weight %, such as in the range of from 25 weight % to 45 weight %, such as in the range of from 30 weight % to 40 weight %, based on the total solids weight of the mixture of reactants used to form the polyurethane polymer.

Clause 488: The protected substrate of any of clauses 462-487, wherein the mixture of reactants used to form the polyurethane polymer comprises a ratio of the polyester polyol to the polyether polyol in the range of from 10:1 to 1:1, such as in the range of from 8:1 to 2:1, such as in the range of from 7:1 to 3:1, such as in the range of from 6:1 to 4:1.

Clause 489: The protected substrate of any of clauses 471-488, wherein the mixture of reactants used to form the polyurethane polymer comprises a ratio of the polyester polyol to the acid functional polyol in the range of from 2:1 to 1:2, such as in the range of from 1.75:1 to 1:1.5, such as in the range of from 1.5:1 to 1:1, such as in the range of from 1.4:1 to 1.2:1.

Clause 490: The protected substrate of any of clauses 432-489, wherein the mixture of reactants used to form the polyurethane polymer comprises a ratio of the oil polyol to the polyisocyanate in the range of from 2:1 to 1:1.25, such as in the range of from 1.75:1 to 1:1, such as in the range of from 1.5:1 to 1:1, such as in the range of from 1.3:1 to 1.2:1.

Clause 491: The protected substrate of any of clauses 429-490, wherein the polyurethane polymer comprises at least one urethane linkage, such as at least two urethane linkages, such as at least three urethane linkages, such as at least 5 urethane linkages, such as at least 10 urethane linkages, such as at least 20 urethane linkages.

Clause 492: The protected substrate of any of clauses 429-491, wherein the polyurethane polymer comprises at least one ester linkage, such as at least two ester linkages, such as at least three ester linkages, such as at least 5 ester linkages.

Clause 493: The protected substrate of any of clauses 429-492, wherein the polyurethane polymer comprises at least one ether linkage, such as at least two ether linkages, such as at least three ether linkages, such as at least 5 ether linkages.

Clause 494: The protected substrate of any of clauses 429-493, wherein the polyurethane polymer comprises at least one urea linkage, such as at least two urea linkages, such as at least three urea linkages, such as at least 5 urea linkages.

Clause 495: The protected substrate of any of clauses 429-494, wherein the polyurethane polymer comprises at least one ethylenically unsaturated group, such as at least two ethylenically unsaturated groups, such as at least three ethylenically unsaturated groups, such as at least 5 ethylenically unsaturated groups.

Clause 496: The protected substrate of clause 495, wherein the ethylenically unsaturated group is pendant from the backbone of the polyurethane polymer.

Clause 497: The protected substrate of any of clauses 495-496, wherein the ethylenically unsaturated group is provided on a C₅-C₃₀ carbon chain, such as on a C₈-C₂₅ carbon chain, such as on a C₁₀-C₂₀ carbon chain.

Clause 498: The protected substrate of any of clauses 429-497, wherein the polyurethane polymer comprises at least one carboxylic acid group, such as at least two carboxylic acid groups, such as at least three carboxylic acid groups, such as at least 5 carboxylic acid groups

Clause 499: The protected substrate of clause 498, wherein the carboxylic acid group is pendant from the backbone of the polyurethane polymer.

Clause 500: The protected substrate of any of clauses 498-499, wherein the carboxylic acid functional group is provided on a C₂-C₁₀ carbon chain, such as a C₂-C₈ carbon chain, such as a C₂-C₅ carbon chain, such as a C₂-C₃ carbon chain.

Clause 501: The protected substrate of any of clauses 429-500, wherein the polyurethane polymer has a weight average molecular weight in the range of from 5,000 g/mol to 60,000 g/mol, such as in the range of from 10,000 g/mol to 50,000 g/mol, such as in the range of from 15,000 g/mol to 45,000 g/mol, such as in the range of from 20,000 g/mol to 40,000 g/mol.

Clause 502: The protected substrate of any of clauses 429-501, wherein the polyurethane polymer has a glass transition temperature in the range of from −30° C. to 20° C., such as in the range of from −20° C. to 10° C., such as in the range of from −10° C. to 0° C.

Clause 503: The protected substrate of any of clauses 429-502, wherein the polyurethane polymer has a viscosity in the range of from 15 cps to 225 cps, such as in the range of from 20 cps to 200 cps, such as in the range of from 25 cps to 175 cps.

Clause 504: The protected substrate of any of clauses 429-503, wherein the polyurethane polymer has an acid value in the range of from greater than 0 KOH/mg to 45 KOH/mg, such as in the range of from 1 KOH/mg to 40 KOH/mg, such as in the range of from 3 KOH/mg to 35 KOH/mg, such as in the range of from 5 KOH/mg to 30 KOH/mg.

Clause 505: The protected substrate of any of clauses 429-504, wherein the polyurethane polymer comprises at least 3, such as at least 4, such as at least 5, such as at least 6, such as at least 7, such as at least 8 different hydrocarbon chains in the backbone of the polyurethane polymer.

Clause 506: The protected substrate of any of clauses 429-505, wherein the polyurethane polymer comprise a C₅ or greater, such as a C₈ or greater, such as a C₁₀ or greater, such as a C₁₅ or greater, such as a C₂₀ or greater hydrocarbon chain.

Clause 507: The protected substrate of any of clauses 429-506, wherein the polyurethane polymer is a copolymer.

Clause 508: The protected substrate of any of clauses 429-507, wherein the polyurethane polymer is formed via step-growth polymerization.

Clause 509: The protected substrate of any of clauses 429-508, wherein the polyurethane polymer is formed via condensation polymerization.

Clause 510: The protected substrate of any of clauses 429-509, wherein the coating composition comprises a polyurethane dispersion comprising the polyurethane polymer.

Clause 511: The protected substrate of clause 510, wherein the polyurethane dispersion comprises the polyurethane polymer in an amount in the range of from 15 weight % to 50 weight %, such as in the range of from 25 weight % to 45 weight %, such as in the range of from 30 weight % to 40 weight %, such as in the range of from 30 weight % to 35 weight %, based on the total weight of the polyurethane dispersion.

Clause 512: The protected substrate of any of clauses 510-511, wherein the polyurethane dispersion further comprises a neutralizing amine.

Clause 513: The protected substrate of clause 512, wherein the neutralizing amine comprises ammonium hydroxide, dimethylamine, trimethylamine, triethyleamine, monoethanolamine, diisopropanolamine, diethanolamine, dimethylethanolamine, or a combination thereof.

Clause 514: The protected substrate of any of clauses 512-513, wherein the polyurethane dispersion comprises the neutralizing amine in an amount in the range of from greater than 0 weight % to 10 weight %, such as in the range of from 0.1 weight % to 8 weight %, such as in the range of from 0.5 weight % to 5 weight %, such as in the range of from 1 weight % to 2 weight %, based on the total weight of the polyurethane dispersion.

Clause 515: The protected substrate of any of clauses 510-514, wherein the polyurethane dispersion further comprises a chain extender.

Clause 516: The protected substrate of clause 515, wherein the chain extender comprises an amine chain extender.

Clause 517: The protected substrate of clause 516, wherein the amine chain extender comprises an aliphatic amine chain extender.

Clause 518: The protected substrate of any of clauses 516-517, wherein the amine chain extender comprises 4,4-diaminodicyclohexylmethane, 4,4-diamino-3,3-dimethyldicyclohexylmethane, 1,4-bis((2-amino-2-yl)-cyclohexane, 3,3-dimethyl-4,4-diaminodicyclohexylmethane, 1,3-diaminohexane, 1,4-diaminohexane, diethylene triamine, dipropylene triamine, hydrazine, ethylene diamine, 1-2-diamino propane, 1,3-diaminopropane, 1,6-diaminopropane, 1,3-diamino-2,2-dimethylpropane, isophorone diamine, triethylene tetramine, tripropylene tetramine, tetraethylene pentamine, or a combination thereof.

Clause 519: The protected substrate of any of clauses 516-518, wherein the amine chain extender comprises an amine value in the range of from 1,000 KOH/mg to 2,500 KOH/mg, such as in the range of from 1,100 KOH/mg to 2,300 KOH/mg, such as in the range of from 1,200 KOH/mg to 2,100 KOH/mg, such as in the range of from 1,300 KOH/mg to 1,900 KOH/mg.

Clause 520: The protected substrate of any of clauses 516-519, wherein the amine chain extender comprises at least two amine groups, such as at least three amine groups, such as at least four amine groups, such as at least 5 amine groups.

Clause 521: The protected substrate of any of clauses 516-520, wherein the amine chain extender comprises up to 10 amine groups, such as up to 8 amine groups, such as up to 6 amine groups.

Clause 522: The protected substrate of any of clauses 516-521, wherein the polyurethane dispersion comprises the amine chain extender in an amount in the range of from greater than 0 weight % to 3 weight %, such as in the range of from greater than 0 weight % to 2 weight %, such as in the range of from greater than 0 weight % to 1 weight %, based on the total weight of the polyurethane dispersion.

Clause 523: The protected substrate of any of clauses 510-522, wherein the polyurethane dispersion further comprises water.

Clause 524: The protected substrate of clause 523, wherein the polyurethane dispersion comprises water in an amount in the range of from 53 weight % to 75 weight %, such as in the range of from 55 weight % to 70 weight %, such as in the range of from 60 weight % to 65 weight %, based on the total weight of the polyurethane dispersion.

Clause 525: The protected substrate of any of clauses 428-524, wherein the coating composition further comprises an epoxide.

Clause 526: The protected substrate of any of clauses 428-525, wherein the coating composition further comprises a wax, an organic oil, a polyolefin, a poly(meth)acrylate, a polyester, an alkene, a polyethylene, a polypropylene, an emulsion thereof, or some combination thereof.

Clause 527: The protected substrate of any of clauses 428-526, wherein the coating composition further comprises polylactic acid (PLA), polyethylene carbonate (PEC), polypropylene carbonate (PPC), polycaprolactone, polyoxymethylene, polyethylene, polypropylene, or some combination thereof. The wax may include stearic acid, paraffin, carnauba, microcrystalline wax, polyethylene wax, or some combination thereof.

Clause 528: The protected substrate of any of clauses 428-527, wherein the coating composition is dispersed in an aqueous medium.

Clause 529: The protected substrate of clause 528, wherein the aqueous medium comprises water in an amount in the range of from 50 weight % to 80 weight %, such as in the range of from 50 weight % to 75 weight %, such as in the range of from 50 weight % to 70 weight %, such as in the range of from 55 weight % to 70 weight %, such as in the range of from 60 weight % to 70 weight %, such as in the range of from 60 weight % to 65 weight %, based on the total liquid weight of said medium.

Clause 530: The protected substrate of any of clauses 528-529, wherein the aqueous medium comprises a solvent in an amount of from greater than 0 weight % to 50 weight %, such as in the range of from 0.5 weight % to 25 weight %, such as in the range of from 0.5 weight % to 15 weight %, such as in the range of from 1 weight % to 10 weight %, such as in the range of from 1 weight % to 5 weight %, based on the total liquid weight of said medium.

Clause 531: The protected substrate of clause 530, wherein the solvent comprises a glycol, an alcohol, a glycol ether alcohol, a volatile ketone, a glycol di ether, an ester, an amine, a diester, an aromatic hydrocarbon, an aliphatic hydrocarbon, a pyrrolidone, or a combination thereof.

Clause 532: The protected substrate of any of clauses 428-531, wherein the coating composition comprises a one-component coating composition.

Clause 533: The protected substrate of any of clauses 428-532, wherein the coating composition comprises a two-component coating composition.

Clause 534: The protected substrate of any of clauses 428-533, wherein the coating composition further comprises a plasticizer.

Clause 535: The protected substrate of clause 534, wherein the plasticizer comprises an oil, a wax, a glycol, or a combination thereof.

Clause 536: The protected substrate of ant of clauses 534-535, wherein the plasticizer comprises cotton seed oil, epoxidized soybean oil, canola oil, carnauba wax, paraffin wax, microcrystalline wax, polyethylene glycol, and polypropylene glycol, and combination thereof.

Clause 537: The protected substrate of any of clauses 534-536, wherein the coating composition comprises the plasticizer in an amount in the range of from 1 weight % to 50 weight %, such as in the range of from 4 weight % to 40 weight %, such as in the range of from 110 weight % to 30 weight %, based on the total components of the coating composition.

Clause 538: The protected substrate of any of clauses 428-537, wherein the coating composition further comprises a viscosity modifier.

Clause 539: The protected substrate of clause 538, wherein the coating composition comprises the viscosity modifier in an amount in the range of from 0.05 weight % to 20 weight %, or 0.1 weight % to 15 weight %, or 0.1 weight % to 10 weight %, based on the total components of the coating composition.

Clause 540: The protected substrate of any of clauses 428-539, wherein the coating composition further comprises a hydrophobic agent.

Clause 541: The protected substrate of clause 540, wherein the coating composition comprise the hydrophobic agent in an amount in the range of from 0.5 weight % to 70 weight %, such as in the range of from 1 weight % to 65 weight %, such as in the range of from 1 weight % to 60 weight %, a based on the total components of the coating composition.

Clause 542: The protected substrate of any of clauses 428-541, wherein the coating composition further comprises a crosslinker.

Clause 543: The protected substrate of clause 542, wherein the crosslinker comprises a polyaziridine, a polycarbodiimide, an epoxy silane, a melamine, a polyisocyanate, or a combination thereof.

Clause 544: The protected substrate of any of clauses 542-543, wherein the crosslinker comprises a polyaziridine.

Clause 545: The protected substrate of any of clauses 542-544, wherein the crosslinker comprises trimethylolpropane tris(2-methyl-1-aziridinepropionate).

Clause 546: The protected substrate of any of clauses 542-545, wherein the coating composition comprises the crosslinker in an amount in the range of from 0.05 weight % to 30 weight %, such as 0.1 weight % to 20 weight %, such as 0.1 weight % to 10 weight %, based on the total components of the coating composition.

Clause 547: The protected substrate of any of clauses 428-546, wherein the coating composition comprises a dual cure coating composition.

Clause 548: A method for protecting a substrate, comprising: providing a planar substrate comprising a surface; and applying a material to form a burn-off temporary protective layer over at least a first portion of the surface, wherein the burn-off temporary protective layer comprises a polyurethane layer, an epoxide layer, or a combination thereof, wherein the burn-off temporary protective layer is removable by a heat treatment process that does not substantially damage the surface.

Clause 549: The method of clause 548, wherein the polyurethane layer comprises an aqueous polyurethane, a polyurethane formed from a two component system, or a combination thereof.

Clause 550: The method of any of clauses 548-549, wherein the epoxide layer comprises an epoxy functional polymeric material.

Clause 551: The method of any of clauses 548-550, wherein the planar substrate comprises glass.

Clause 552: The method of clause 548-551, further comprising: preparing the material via emulsion, wherein the material is dispersed in water or an aqueous medium.

Clause 553: A method of removing a burn-off temporary protective layer from a coated substrate, comprising: providing a coated substrate comprising a surface over a portion of which a burn-off temporary protective layer is applied, wherein the burn-off temporary protective layer comprises a polyurethane layer, an epoxide layer, or a combination thereof; and removing the burn-off temporary protective layer from the surface by burning the burn-off temporary protective layer to form an unprotected substrate without substantially damaging the surface.

Clause 554: The method of clause 553, wherein the polyurethane layer comprises an aqueous polyurethane, a polyurethane formed from a two component system, or a combination thereof.

Clause 555: The method of any of clauses 553-554, wherein the epoxide layer comprises an epoxy functional polymeric material.

Clause 556: The method of any of clauses 553-555, wherein the coated substrate comprises coated glass.

Clause 557: The method of any of clauses 553-556, wherein the coated substrate is heated to a temperature of up to 1000° C. to remove the burn-off temporary protective layer from the surface.

Clause 558: The method of any of clauses 548-557, wherein the burn-off temporary protective layer comprises a polyurethane layer formed from a coating composition comprising an aqueous polyurethane, a polyurethane formed from a two component system, or a combination thereof.

Clause 559: The method of any of clauses 548-558, wherein the burn-off temporary protective layer comprises a polyurethane layer formed from a coating composition comprising a polyurethane polymer.

Clause 560: The method of clause 559, wherein the polyurethane polymer comprises an oil-modified polyurethane polymer.

Clause 561: The method of any of clauses 558-560, wherein the polyurethane layer is formed from a coating composition comprising a polyurethane polymer formed from a mixture of reactants comprising at least one polyol; and a polyisocyanate.

Clause 562: The method of clause 561, wherein the at least one polyol comprises an oil polyol.

Clause 563: The method of clause 562, wherein the oil polyol is formed from a mixture of reactants comprising at least one unsaturated oil and/or fatty acid; and at least one polyol.

Clause 564: The method of clause 563, wherein the at least one unsaturated oil and/or fatty acid used to form the oil polyol comprises palm oil, soybean oil, sunflower seed oil, peanut oil, cottonseed oil, rapeseed oil, coconut oil, palm kernel oil, olive oil, corn oil, grape seed oil, hazelnut oil, linseed oil, sesame oil, avocado oil, hemp seed oil, tung oil, canola oil, safflower oil, tall oil, sunflower oil, poppyseed oil, perilla oil, walnut oil, castor oil, sardine oil, ricinoleic acid, eleostearic acid, linolenic acid, linoleic acid, palmitoleic acid, arachidonic acid, or a combination thereof.

Clause 565: The method of any of clauses 563-564, wherein the unsaturated oil and/or fatty acid has an iodine value in the range of from 70 to 250, such as in the range of from 80 to 225, such as in the range of from 90 to 210, such as in the range of from 100 to 200.

Clause 566: The method of any of clauses 563-565, wherein the mixture of reactants used to form the oil polyol comprises the unsaturated oil and/or fatty acid in an amount in the range of from 80 weight % to 97 weight %, such as in the range of from 85 weight % to 96 weight %, such as in the range of from 90 weight % to 95 weight %, based on the total solids weight of the mixture of reactants used to form the oil polyol.

Clause 567: The method of any of clauses 563-566, wherein the at least one polyol used to form the oil polyol comprises cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, ethylene glycol, or combinations thereof.

Clause 568: The method of any of clauses 563-567, wherein the at least one polyol used to form the oil polyol comprises at least two polyols, such as at least three polyols, such as at least four polyols.

Clause 569: The method of any of clauses 563-568, wherein the mixture of reactants used to form the oil polyol comprises the at least one polyol in an amount in the range of from 1 weight % to 25 weight %, such as in the range of from 2 weight % to 20 weight %, such as in the range of from 3 weight % to 15 weight %, such as in the range of from 5 weight % to 10 weight %, based on the total solids weight of the mixture of reactants used to form the oil polyol.

Clause 570: The method of any of clauses 563-569, wherein the mixture of reactants used to form the oil polyol further comprises a catalyst.

Clause 571: The method of clause 570, wherein the catalyst used to form the oil polyol comprises 1,5,7-triazabicyclo [4.4.0]dec-5-ene, zinc acetate, calcium naphthenate, zinc naphthenate, barium naphthenate, iron naphthenate lithium neodecanoate, or a combination thereof.

Clause 572: The method of any of clauses 570-571, wherein the mixture of reactants used to form the oil polyol comprises the catalyst in an amount in the range of from greater than 0 weight % to 2 weight %, such as in the range of from greater than 0 weight % to 1 weight %, such as in the range of from 0.01 weight % to 2 weight %, such as in the range of from 0.01 weight % to 1 weight %, based on the total solids weight of the mixture of reactants used to form the oil polyol.

Clause 573: The method of any of clauses 562-572, wherein the oil polyol comprises at least 3 hydroxyl groups, such as at least 4 hydroxyl groups, such as at least 5 hydroxyl groups, such as at least 10 hydroxyl groups, such as at least 15 hydroxyl groups, such as at least 20 hydroxyl groups.

Clause 574: The method of any of clauses 562-573, wherein the oil polyol comprises at least one ethylenically unsaturated group, such as at least two ethylenically unsaturated groups, such as at least three ethylenically unsaturated groups, such as at least 5 ethylenically unsaturated groups.

Clause 575: The method of any of clauses 562-574, wherein the oil polyol comprises no additional functional groups.

Clause 576: The method of any of clauses 562-575, wherein the oil polyol comprises a hydroxyl value in the range of from 70 KOH/mg to 250 KOH/mg, such as from 80 KOH/mg to 200 KOH/mg, such as from 90 KOH/mg to 180 KOH/mg, such as from 100 KOH/mg to 150 KOH/mg.

Clause 577: The method of any of clauses 562-576, wherein the mixture of reactants used to form the polyurethane polymer comprises the oil polyol in an amount in the range of from 30 weight % to 65 weight %, such as in the range of from 35 weight % to 60 weight %, such as in the range of from 40 weight % to 55 weight %, such as in the range of from 45 weight % to 50 weight %, based on the total solids weight of the mixture of reactants used to form the polyurethane polymer.

Clause 578: The method of any of clauses 561-577 wherein the at least one polyol used to form the polyurethane polymer comprises a polyester polyol.

Clause 579: The method of clause 578, wherein the polyester polyol is formed from a mixture of reactants comprising at least one polyol; and at least one polyacid.

Clause 580: The method of clause 579, wherein the at least one polyol used to form the polyester polyol comprises dimethyl carbonate, caprolactone, cyclohexane dimethanol, bisphenol A, glycerin, trimethylol propane, trimethylol ethane, pentaerythritol, sorbitol, neopentyl glycol, 1,6-hexanediol, 1,4-butane diol, 1,3-butylene glycol, 1,3-propane diol, dipropylene glycol, propylene glycol, diethylene glycol, and ethylene glycol, or a combinations thereof.

Clause 581: The method of any of clauses 579-580, wherein the at least one polyol used to form the polyester polyol comprises at least two polyols, such as at least three polyols, such as at least four polyols.

Clause 582: The method of any of clauses 579-581, wherein the mixture of reactants used to form the polyester polyol comprises the at least one polyol in an amount in the range of from 50 weight % to 80 weight %, or in the range of from 55 weight % to 80 weight %, or in the range of from 60 weight % to 78 weight %, or in the range of from 65 weight % to 75 weight %, based on the total solids weight of the mixture of reactants used to form the polyester polyol.

Clause 583: The method of any of clauses 579-582, wherein the at least one polyacid used to form the polyester polyol comprises oxalic acid, malonic acid, succinic acid, glutaric acid, adipic acid, maleic acid, fumaric acid, isophthalic acid, phthalic acid, trimellitic acid, maleic anhydride, phthalic anhydride, trimellitic anhydride, or a combinations thereof.

Clause 584: The method of any of clauses 579-583 wherein the mixture of reactants used to form the polyester polyol comprises the at least one polyacid in an amount in the range of from 20 weight % to 50 weight %, or in the range of from 20 weight % to 45 weight %, or in the range of from 23 weight % to 40 weight %, or in the range of from 25 weight % to 35 weight %, based on the total solids weight of the mixture of reactants used to form the polyester polyol.

Clause 585: The method of any of clauses 578-584, wherein the polyester polyol comprises an aliphatic polyester polyol.

Clause 586: The method of any of clauses 578-585, wherein the polyester polyol comprises a C₂-C₂₅ carbon chain, such as a C₅-C₂₀ carbon chain, such as a C₈-C₁₈ carbon chain, such as a C₁₀-C₁₄ carbon chain.

Clause 587: The method of any of clauses 578-586, wherein the polyester polyol comprises at least one ester linkage, such as at least two ester linkages, such as at least three ester linkages, such as at least four ester linkages, such as at least five ester linkages.

Clause 588: The method of any of clauses 578-587, wherein the polyester polyol comprises at least two hydroxyl groups, such as at least three hydroxyl groups, such as at least four hydroxyl groups, such as at least five hydroxyl groups, such as at least 10 hydroxyl groups, such as at least 15 hydroxyl groups, such as at least 20 hydroxyl groups.

Clause 589: The method of any of clauses 578-588, wherein the polyester polyol comprises no additional functional groups.

Clause 590: The method of any of clauses 578-589, wherein the polyester polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 591: The method of any of clauses 578-590, wherein the mixture of reactants used to form the polyurethane polymer comprises the polyester polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 592: The method of any of clauses 561-591, wherein the at least one polyol used to form the polyurethane polymer comprises a polyether polyol.

Clause 593: The method of clause 592, wherein the polyether polyol comprises an aliphatic polyether polyol.

Clause 594: The method of any of clauses 592-593, wherein the polyether polyol comprises an ethylene-based or propylene-based polyether polyol.

Clause 595: The method of any of clauses 592-594, wherein the polyether polyol comprises ethylene oxide, propylene oxide, tetrahydrofuran, neopentyl glycol, 1,6-hexanediol, 1,4-butane diol, 1,3-butylene glycol, 1,3-propane diol, dipropylene glycol, propylene glycol, diethylene glycol, ethylene glycol, or a combinations thereof.

Clause 596: The method of any of clauses 592-595, wherein the polyether polyol comprises at least one ether linkage, such as at least two ether linkages, such as at least two ether linkages, such as at least three ether linkages, such as at least four ether linkages, such as at least five ether linkages.

Clause 597: The method of any of clauses 592-596, wherein the polyether polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 598: The method of any of clauses 592-597, wherein the polyether polyol comprise no additional functional groups.

Clause 599: The method of any of clauses 592-598, wherein the polyether polyol has a hydroxyl value in the range of from 70 KOH/mg to 250 KOH/mg, such as in the range of from 80 KOH/mg to 200 KOH/mg, such as in the range of from 90 KOH/mg to 180 KOH/mg, such as in the range of from 100 KOH/mg to 150 KOH/mg.

Clause 600: The method of any of clauses 592-599, wherein the mixture of reactants used to form the polyurethane polyol comprise the polyether polyol in an amount in the range of from greater than 0 weight % to 15 weight %, such as in the range of from 0.1 weight % to 10 weight %, such as in the range of from 0.5 weight % to 8 weight %, such as in the range of from 1 weight % to 5 weight %, based on the total solids weight of the mixture of reactants used to form the polyurethane polymer.

Clause 601: The method of any of clauses 561-600, wherein the at least one polyol used to form the polyurethane polymer comprises an acid functional polyol.

Clause 602: The method of clause 601, wherein the acid functional polyol comprises an aliphatic acid functional polyol.

Clause 603: The method of any of clauses 601-602, wherein the acid functional polyol comprises 2,2-bis(hydroxymethyl)propionic acid, 2,2-bis(hydroxymethyl)butanoic acid, 2,3-dihydroxypropanoic acid, 2,2-dihydroxypropanedioic acid, 2,3-dihydroxylbutanedioic acid, or a combination thereof.

Clause 604: The method of any of clauses 601-603, wherein the acid functional polyol comprises at least one carboxylic acid group, such as at least two carboxylic acid groups, such as at least three carboxylic acid groups, such as at least four carboxylic acid groups, such as at least 5 carboxylic acid group.

Clause 605: The method of any of clauses 601-604, wherein the acid functional polyol comprises at least two hydroxyl groups, such as at least three hydroxyl groups, such as at least four hydroxyl groups, such as at least 5 hydroxyl groups, such as at least 10 hydroxyl groups, such as at least 15 hydroxyl groups, such as at least 20 hydroxyl groups.

Clause 606: The method of any of clauses 601-605, wherein the acid functional polyol comprises no additional functional groups.

Clause 607: The method of any of clauses 601-606, wherein the mixture of reactants used to form the polyurethane polymer comprises the acid functional polyol in an amount in the range of from greater than 0 weight % to 20 weight %, such as in the range of from 1 weight % to 15 weight %, such as in the range of from 3 weight % to 12 weight %, such as in the range of from 5 weight % to 10 weight %, based on the total solids weight of the mixture of reactants used to form the polyurethane polymer.

Clause 608: The method of any of clauses 561-607, wherein the polyisocyanate comprises an aliphatic polyisocyanate.

Clause 609: The method of any of clauses 561-608, wherein the polyisocyanate comprises a cycloaliphatic polyisocyanate.

Clause 610: The method of any of clauses 561-609, wherein the polyisocyanate comprises an aromatic polyisocyanate.

Clause 611: The method of any of clauses 561-610, wherein the polyisocyanate comprises meta-phenylene diisocyanate, para-phenylene diisocyanate, 2,6-toluene diisocyanate, 2,4-toluene diisocyanate, xylene diisocyanate, 4,4-biphenylene diisocyanate, 4,4-methylene diphenylisocyanate, 1,5-naphthylene diisocyanate, 1,4-tetramethylene diisocyanate, 11,6-hexamethylene diisocyanate, 2,2,4-trimethyl-1,6-diisocyanatohexane, 1,10-decamethylene diisocyanate, 1,4-cyclohexylene diisocyanate, 4,4-methylenebis(isocyanatocyclohexane), 1-isocyanato-3-isocyanatomethyl-3,5,5-trimethyl cyclohexane, or a combination thereof.

Clause 612: The method of any of clauses 561-611, wherein the polyisocyanate comprises a blocked polyisocyanate.

Clause 613: The method of clause 612, wherein the blocked polyisocyanate comprises an blocking agent; wherein the blocking agent comprises an amide, a phenol, a caprolactam, a uretdione, or a combination thereof.

Clause 614: The method of any of clauses 561-613, wherein the polyisocyanate comprises at least two isocyanate functional groups, such as at least three isocyanate functional groups, such as at least four isocyanate groups, such as at least 5 isocyanate groups.

Clause 615: The method of any of clauses 561-614, wherein the polyisocyanate comprises no additional functional groups.

Clause 616: The method of any of clauses 561-615, wherein the polyisocyanate has an isocyanate equivalent weight in the range of from 80 g/eq to 225 g/eq, such as in the range of from 90 g/eq to 200 g/eq, such as in the range of from 100 g/eq to 190 g/eq, such as in the range of from 110 g/eq to 175 g/eq.

Clause 617: The method of any of clauses 561-616, wherein the mixture of reactants used to form the polyurethane polymer comprises the polyisocyanate in an amount in the range of from 15 weight % to 55 weight %, such as in the range of from 20 weight % to 50 weight %, such as in the range of from 25 weight % to 45 weight %, such as in the range of from 30 weight % to 40 weight %, based on the total solids weight of the mixture of reactants used to form the polyurethane polymer.

Clause 618: The method of any of clauses 592-617, wherein the mixture of reactants used to form the polyurethane polymer comprises a ratio of the polyester polyol to the polyether polyol in the range of from 10:1 to 1:1, such as in the range of from 8:1 to 2:1, such as in the range of from 7:1 to 3:1, such as in the range of from 6:1 to 4:1.

Clause 619: The method of any of clauses 601-618, wherein the mixture of reactants used to form the polyurethane polymer comprises a ratio of the polyester polyol to the acid functional polyol in the range of from 2:1 to 1:2, such as in the range of from 1.75:1 to 1:1.5, such as in the range of from 1.5:1 to 1:1, such as in the range of from 1.4:1 to 1.2:1.

Clause 620: The method of any of clauses 562-619, wherein the mixture of reactants used to form the polyurethane polymer comprises a ratio of the oil polyol to the polyisocyanate in the range of from 2:1 to 1:1.25, such as in the range of from 1.75:1 to 1:1, such as in the range of from 1.5:1 to 1:1, such as in the range of from 1.3:1 to 1.2:1.

Clause 621: The method of any of clauses 559-620, wherein the polyurethane polymer comprises at least one urethane linkage, such as at least two urethane linkages, such as at least three urethane linkages, such as at least 5 urethane linkages, such as at least 10 urethane linkages, such as at least 20 urethane linkages.

Clause 622: The method of any of clauses 559-621, wherein the polyurethane polymer comprises at least one ester linkage, such as at least two ester linkages, such as at least three ester linkages, such as at least 5 ester linkages.

Clause 623: The method of any of clauses 559-622, wherein the polyurethane polymer comprises at least one ether linkage, such as at least two ether linkages, such as at least three ether linkages, such as at least 5 ether linkages.

Clause 624: The method of any of clauses 559-623, wherein the polyurethane polymer comprises at least one urea linkage, such as at least two urea linkages, such as at least three urea linkages, such as at least 5 urea linkages.

Clause 625: The method of any of clauses 559-624, wherein the polyurethane polymer comprises at least one ethylenically unsaturated group, such as at least two ethylenically unsaturated groups, such as at least three ethylenically unsaturated groups, such as at least 5 ethylenically unsaturated groups.

Clause 626: The method of clause 625, wherein the ethylenically unsaturated group is pendant from the backbone of the polyurethane polymer.

Clause 627: The method of any of clauses 625-626, wherein the ethylenically unsaturated group is provided on a C₅-C₃₀ carbon chain, such as on a C₈-C₂₅ carbon chain, such as on a C₁₀-C₂₀ carbon chain.

Clause 628: The method of any of clauses 559-627, wherein the polyurethane polymer comprises at least one carboxylic acid group, such as at least two carboxylic acid groups, such as at least three carboxylic acid groups, such as at least 5 carboxylic acid groups

Clause 629: The method of clause 628, wherein the carboxylic acid group is pendant from the backbone of the polyurethane polymer.

Clause 630: The method of any of clauses 628-629, wherein the carboxylic acid functional group is provided on a C₂-C₁₀ carbon chain, such as a C₂-C₈ carbon chain, such as a C₂-C₅ carbon chain, such as a C₂-C₃ carbon chain.

Clause 631: The method of any of clauses 559-630, wherein the polyurethane polymer has a weight average molecular weight in the range of from 5,000 g/mol to 60,000 g/mol, such as in the range of from 10,000 g/mol to 50,000 g/mol, such as in the range of from 15,000 g/mol to 45,000 g/mol, such as in the range of from 20,000 g/mol to 40,000 g/mol.

Clause 632: The method of any of clauses 559-631, wherein the polyurethane polymer has a glass transition temperature in the range of from −30° C. to 20° C., such as in the range of from −20° C. to 10° C., such as in the range of from −10° C. to 0° C.

Clause 633: The method of any of clauses 559-632, wherein the polyurethane polymer has a viscosity in the range of from 15 cps to 225 cps, such as in the range of from 20 cps to 200 cps, such as in the range of from 25 cps to 175 cps.

Clause 634: The method of any of clauses 559-633, wherein the polyurethane polymer has an acid value in the range of from greater than 0 KOH/mg to 45 KOH/mg, such as in the range of from 1 KOH/mg to 40 KOH/mg, such as in the range of from 3 KOH/mg to 35 KOH/mg, such as in the range of from 5 KOH/mg to 30 KOH/mg.

Clause 635: The method of any of clauses 559-634, wherein the polyurethane polymer comprises at least 3, such as at least 4, such as at least 5, such as at least 6, such as at least 7, such as at least 8 different hydrocarbon chains in the backbone of the polyurethane polymer.

Clause 636: The method of any of clauses 559-635, wherein the polyurethane polymer comprise a C₅ or greater, such as a C₈ or greater, such as a C₁₀ or greater, such as a C₁₅ or greater, such as a C₂₀ or greater hydrocarbon chain.

Clause 637: The method of any of clauses 559-636, wherein the polyurethane polymer is a copolymer.

Clause 638: The method of any of clauses 559-637, wherein the polyurethane polymer is formed via step-growth polymerization.

Clause 639: The method of any of clauses 559-638, wherein the polyurethane polymer is formed via condensation polymerization.

Clause 640: The method of any of clauses 559-639, wherein the coating composition comprises a polyurethane dispersion comprising the polyurethane polymer.

Clause 641: The method of clause 640, wherein the polyurethane dispersion comprises the polyurethane polymer in an amount in the range of from 15 weight % to 50 weight %, such as in the range of from 25 weight % to 45 weight %, such as in the range of from 30 weight % to 40 weight %, such as in the range of from 30 weight % to 35 weight %, based on the total weight of the polyurethane dispersion.

Clause 642: The method of any of clauses 640-641, wherein the polyurethane dispersion further comprises a neutralizing amine.

Clause 643: The method of clause 642, wherein the neutralizing amine comprises ammonium hydroxide, dimethylamine, trimethylamine, triethyleamine, monoethanolamine, diisopropanolamine, diethanolamine, dimethylethanolamine, or a combination thereof.

Clause 644: The method of any of clauses 642-643, wherein the polyurethane dispersion comprises the neutralizing amine in an amount in the range of from greater than 0 weight % to 10 weight %, such as in the range of from 0.1 weight % to 8 weight %, such as in the range of from 0.5 weight % to 5 weight %, such as in the range of from 1 weight % to 2 weight %, based on the total weight of the polyurethane dispersion.

Clause 645: The method of any of clauses 640-644, wherein the polyurethane dispersion further comprises a chain extender.

Clause 646: The method of clause 645, wherein the chain extender comprises an amine chain extender.

Clause 647: The method of clause 646, wherein the amine chain extender comprises an aliphatic amine chain extender.

Clause 648: The method of any of clauses 646-647, wherein the amine chain extender comprises 4,4-diaminodicyclohexylmethane, 4,4-diamino-3,3-dimethyldicyclohexylmethane, 1,4-bis((2-amino-2-yl)-cyclohexane, 3,3-dimethyl-4,4-diaminodicyclohexylmethane, 1,3-diaminohexane, 1,4-diaminohexane, diethylene triamine, dipropylene triamine, hydrazine, ethylene diamine, 1-2-diamino propane, 1,3-diaminopropane, 1,6-diaminopropane, 1,3-diamino-2,2-dimethylpropane, isophorone diamine, triethylene tetramine, tripropylene tetramine, tetraethylene pentamine, or a combination thereof.

Clause 649: The method of any of clauses 646-648, wherein the amine chain extender comprises an amine value in the range of from 1,000 KOH/mg to 2,500 KOH/mg, such as in the range of from 1,100 KOH/mg to 2,300 KOH/mg, such as in the range of from 1,200 KOH/mg to 2,100 KOH/mg, such as in the range of from 1,300 KOH/mg to 1,900 KOH/mg.

Clause 650: The method of any of clauses 646-649, wherein the amine chain extender comprises at least two amine groups, such as at least three amine groups, such as at least four amine groups, such as at least 5 amine groups.

Clause 651: The method of any of clauses 646-650, wherein the amine chain extender comprises up to 10 amine groups, such as up to 8 amine groups, such as up to 6 amine groups.

Clause 652: The method of any of clauses 646-651, wherein the polyurethane dispersion comprises the amine chain extender in an amount in the range of from greater than 0 weight % to 3 weight %, such as in the range of from greater than 0 weight % to 2 weight %, such as in the range of from greater than 0 weight % to 1 weight %, based on the total weight of the polyurethane dispersion.

Clause 653: The method of any of clauses 646-652, wherein the polyurethane dispersion further comprises water.

Clause 654: The method of clause 653, wherein the polyurethane dispersion comprises water in an amount in the range of from 53 weight % to 75 weight %, such as in the range of from 55 weight % to 70 weight %, such as in the range of from 60 weight % to 65 weight %, based on the total weight of the polyurethane dispersion.

Clause 655: The method of any of clauses 558-654, wherein the coating composition further comprises an epoxide.

Clause 656: The method of any of clauses 558-655, wherein the coating composition further comprises a wax, an organic oil, a polyolefin, a poly(meth)acrylate, a polyester, an alkene, a polyethylene, a polypropylene, an emulsion thereof, or some combination thereof.

Clause 657: The method of any of clauses 558-656, wherein the coating composition further comprises polylactic acid (PLA), polyethylene carbonate (PEC), polypropylene carbonate (PPC), polycaprolactone, polyoxymethylene, polyethylene, polypropylene, or some combination thereof. The wax may include stearic acid, paraffin, carnauba, microcrystalline wax, polyethylene wax, or some combination thereof.

Clause 658: The method of any of clauses 558-657, wherein the coating composition is dispersed in an aqueous medium.

Clause 659: The method of clause 658, wherein the aqueous medium comprises water in an amount in the range of from 50 weight % to 80 weight %, such as in the range of from 50 weight % to 75 weight %, such as in the range of from 50 weight % to 70 weight %, such as in the range of from 55 weight % to 70 weight %, such as in the range of from 60 weight % to 70 weight %, such as in the range of from 60 weight % to 65 weight %, based on the total liquid weight of said medium.

Clause 660: The method of any of clauses 658-659, wherein the aqueous medium comprises a solvent in an amount of from greater than 0 weight % to 50 weight %, such as in the range of from 0.5 weight % to 25 weight %, such as in the range of from 0.5 weight % to 15 weight %, such as in the range of from 1 weight % to 10 weight %, such as in the range of from 1 weight % to 5 weight %, based on the total liquid weight of said medium.

Clause 661: The method of clause 660, wherein the solvent comprises a glycol, an alcohol, a glycol ether alcohol, a volatile ketone, a glycol di ether, an ester, an amine, a diester, an aromatic hydrocarbon, an aliphatic hydrocarbon, a pyrrolidone, or a combination thereof.

Clause 662: The method of any of clauses 558-661, wherein the coating composition comprises a one-component coating composition.

Clause 663: The method of any of clauses 558-662, wherein the coating composition comprises a two-component coating composition.

Clause 664: The method of any of clauses 558-663, wherein the coating composition further comprises a plasticizer.

Clause 665: The method of clause 664, wherein the plasticizer comprises an oil, a wax, a glycol, or a combination thereof.

Clause 666: The method of clause 665, wherein the plasticizer comprises cotton seed oil, epoxidized soybean oil, canola oil, carnauba wax, paraffin wax, microcrystalline wax, polyethylene glycol, and polypropylene glycol, and combination thereof.

Clause 667: The method of any of clauses 664-666, wherein the coating composition comprises the plasticizer in an amount in the range of from 1 weight % to 50 weight %, such as in the range of from 4 weight % to 40 weight %, such as in the range of from 110 weight % to 30 weight %, based on the total components of the coating composition.

Clause 668: The method of any of clauses 558-667, wherein the coating composition further comprises a viscosity modifier.

Clause 669: The method of clause 668, wherein the coating composition comprises the viscosity modifier in an amount in the range of from 0.05 weight % to 20 weight %, or 0.1 weight % to 15 weight %, or 0.1 weight % to 10 weight %, based on the total components of the coating composition.

Clause 670: The method of any of clauses 558-669, wherein the coating composition further comprises a hydrophobic agent.

Clause 671: The method of clause 670, wherein the coating composition comprise the hydrophobic agent in an amount in the range of from 0.5 weight % to 70 weight %, such as in the range of from 1 weight % to 65 weight %, such as in the range of from 1 weight % to 60 weight %, a based on the total components of the coating composition.

Clause 672: The method of any of clauses 558-671, wherein the coating composition further comprises a crosslinker.

Clause 673: The method of clause 672, wherein the crosslinker comprises a polyaziridine, a polycarbodiimide, an epoxy silane, a melamine, a polyisocyanate, or a combination thereof.

Clause 674: The method of any of clauses 672-673, wherein the crosslinker comprises a polyaziridine.

Clause 675: The method of any of clauses 672-674, wherein the crosslinker comprises trimethylolpropane tris(2-methyl-1-aziridinepropionate).

Clause 676: The method of any of clauses 672-675, wherein the coating composition comprises the crosslinker in an amount in the range of from 0.05 weight % to 30 weight %, such as 0.1 weight % to 20 weight %, such as 0.1 weight % to 10 weight %, based on the total components of the coating composition.

Clause 677: The method of any of clauses 558-676, wherein the coating composition comprises a dual cure coating composition.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A protected substrate, comprising:
a planar substrate comprising a surface; and
a burn-off temporary protective layer positioned over at least a portion of the surface,
wherein the burn-off temporary protective layer comprises a polyurethane layer, an epoxide layer, or a combination thereof.

2. The protected substrate of claim 1, wherein the burn-off temporary protective layer is removable by a heat treatment process that does not substantially damage the surface.

3. The protected substrate of claim 1, wherein the burn-off temporary protective layer comprises a thickness of at least 10 nm and at most 5,000 μm.

4. The protected substrate of claim 1, wherein the protected substrate does not include a temporary protective sheet positioned over the surface.

5. The protected substrate of claim 1, wherein the burn-off temporary protective layer is removable by burning at a temperature of at most 1000° C.

6. The protected substrate of claim 2, wherein the heat treatment process does not cause the surface to have a color change (DECMC) of more than 3 units compared to a color of a surface of an identical planar substrate without the burn-off temporary protective layer after the heat treatment process.

7. The protected substrate of claim 1, wherein the planar substrate comprises glass.

8. The protected substrate of claim 1, wherein the burn-off temporary protective layer is an outermost layer of the planar substrate.

9. The protected substrate of claim 1, wherein the burn-off temporary protective layer is positioned over the entire surface and at least a portion of an edge of the substrate.

10. The protected substrate of claim 1, further comprising a functional coating positioned between the surface and the burn-off temporary protective layer.

11. The protected substrate of claim 10, wherein the functional coating comprises a low-E coating layer.

12. The protected substrate of claim 1, wherein the heat treatment process comprises burning the burn-off temporary protective layer without substantial damage of the surface.

13. The protected substrate of claim 1, wherein the burn-off temporary protective layer comprises a material having a melting point within a range of from 60° C. to 600° C.

14. The protected substrate of claim 1, wherein the burn-off temporary protective layer comprises a protective film.

15. The protected substrate of claim 1, wherein the burn-off temporary protective layer is UV curable.

16. A method for protecting a substrate, comprising:
providing a planar substrate comprising a surface; and
applying a material to form a burn-off temporary protective layer over at least a first portion of the surface,
wherein the burn-off temporary protective layer comprises a polyurethane layer, an epoxide layer, or a combination thereof.

17. The method of claim 16, wherein the burn-off temporary protective layer is removable by a heat treatment process that does not substantially damage the surface.

18. The method of claim 16, wherein the planar substrate comprises glass.

19. The method of claim 16, further comprising applying a functional coating over at least a portion of the substrate and applying the burn-off protective layer over at least a portion of the functional coating.

20. A method of removing a burn-off temporary protective layer from a coated substrate, comprising:
providing a coated substrate comprising a surface over a portion of which a burn-off temporary protective layer is applied, wherein the burn-off temporary protective layer comprises a polyurethane layer, an epoxide layer, or a combination thereof; and
removing the burn-off temporary protective layer from the surface by burning the burn-off temporary protective layer to form an unprotected substrate without substantially damaging the surface.
